(19) United States
(12) Patent Application Publication
(10) Pub. No.: US 2026/0063854 A1
(43) Pub. Date: Mar. 5, 2026

(54) Systems and Associated Methods for Through-Backside Optical Fiber Coupling with Photonic Integrated Circuit Die/Chip

(71) Applicant: Ayar Labs, Inc., San Jose, CA (US)

(72) Inventors: Dries Vercruysse, Millbrae, CA (US); Neil V. Sapra, Berkeley, CA (US); Albert Zettler Greely, JR., Santa Clara, CA (US); Chong Zhang, San Jose, CA (US)

(21) Appl. No.: 19/310,915

(22) Filed: Aug. 26, 2025

Related U.S. Application Data
(60) Provisional application No. 63/687,716, filed on Aug. 27, 2024.

(51) Int. Cl. G02B 6/42

(52) U.S. Cl. CPC G02B 6/4214

(57) ABSTRACT

A photonic system includes an optical coupling interface for an optical fiber disposed on a first surface of a support material and a PIC die/chip disposed on a second surface of the support material that is opposite from the first surface of the support material. The PIC die/chip includes an oxide stack, where a portion of the oxide stack is configured as an optical reflector structure that includes a reflecting surface configured to direct a light beam conveyed from an optical waveguide within the PIC die/chip from a first direction of travel to a second direction of travel directed toward the second surface of the support material and toward the optical coupling interface for the optical fiber disposed on the first surface of the support material. The light beam travels through the optical reflector structure and through the support material to reach the optical coupling interface for the optical fiber.

### CROSS-REFERENCE TO RELATED APPLICATIONS

This application claims priority under 35 U.S.C. 119 (e) to U.S. Provisional Patent Application No. 63/687,716, filed on Aug. 27, 2024, the disclosure of which is incorporated herein by reference in its entirety for all purposes.

### BACKGROUND OF THE INVENTION

### 1. Field of the Invention

The disclosed embodiments relate to optical data communication.

### 2. Description of the Related Art

Optical data communication systems operate by modulating laser light to encode digital data patterns within optical signals. In some embodiments, a ring modulator is used to modulate continuous wave laser light to generate the modulated laser light that conveys the encoding of digital data patterns. In some embodiments, the ring modulator is positioned within an evanescent optical coupling distance from a bus optical waveguide and operates to modulate light that is propagating through the bus optical waveguide. The ring modulator and associated optical waveguides are fabricated within an electro-optic chip and/or photonic integrated circuit (PIC) chip. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits within electro-optic chips and/or PIC chips. Implementation and operation of optical data communication systems is dependent upon having reliable and efficient techniques for conveyance of optical signals and/or continuous wave laser light between optical fibers and various photonic devices, such as between optical fibers and electro-optic chips and/or PIC chips. It is within this context that the present invention arises.

### SUMMARY OF THE INVENTION

In an example embodiment, a photonic system is disclosed. The photonic system includes a support material. The photonic system also includes an optical coupling interface for an optical fiber is disposed on a first surface of the support material. The photonic system also includes a PIC die/chip is disposed on a second surface of the support material. The second surface of the support material is opposite from the first surface of the support material relative to an overall thickness of the support material. The photonic system also includes an optical reflector structure is disposed within the PIC die/chip. The optical reflector structure is configured to receive a light beam from an optical waveguide within the PIC die/chip and turn the light beam toward the second surface of the support material and toward the optical coupling interface for the optical fiber disposed on the first surface of the support material. The light beam travels from the optical waveguide within the PIC die/chip through the optical reflector structure in a first direction, and then through the optical reflector structure in a second direction, and then through the overall thickness of the support material to reach the optical coupling interface for the optical fiber.

In another example embodiment, a photonic system is disclosed. The photonic system includes a support material. The photonic system also includes an optical coupling interface for an optical fiber disposed on a first surface of the support material. The photonic system also includes a PIC die/chip disposed on a second surface of the support material. The second surface of the support material is opposite from the first surface of the support material relative to an overall thickness of the support material. The PIC die/chip includes an oxide stack that extends vertically through the PIC die/chip to the second surface of the support material. A portion of the oxide stack is configured as an optical reflector structure that includes a reflecting surface configured to direct a light beam conveyed from an optical waveguide within the PIC die/chip from a first direction of travel to a second direction of travel directed toward the second surface of the support material and toward the optical coupling interface for the optical fiber disposed on the first surface of the support material. The light beam travels from the optical waveguide within the PIC die/chip through the optical reflector structure and through the overall thickness of the support material to reach the optical coupling interface for the optical fiber.

In another example embodiment, a photonic system is disclosed. The photonic system includes a PIC die/chip that includes an optical waveguide that is optically connected to an optical port at a side of the PIC die/chip. The photonic system also includes a support material. The PIC die/chip is disposed on a first surface of the support material. The support material is configured to wrap around a side of the PIC die/chip where the optical port is located. A portion of the support material is configured as an optical reflector structure that includes a reflecting surface configured to direct a light beam conveyed from the optical port of the PIC die/chip from a first direction of travel to a second direction of travel through the support material toward a second surface of the support material. The photonic system also includes an optical coupling interface for an optical fiber disposed on the second surface of the support material. The optical coupling interface is configured to receive the light beam traveling in the second direction through the support material.

In another example embodiment, a photonic system is disclosed. The photonic system includes a support material. The photonic system also includes an optical coupling interface for an optical fiber disposed on a first surface of the support material. The photonic system also includes a PIC die/chip disposed on a second surface of the support material. The second surface of the support material is opposite from the first surface of the support material relative to an overall thickness of the support material. The photonic system also includes an opening formed through the PIC die/chip. The photonic system also includes an optical reflector structure disposed within the opening. The optical reflector structure is configured to receive a light beam traveling in a first direction from an optical waveguide within the PIC die/chip and turn the light beam into a second direction toward the optical coupling interface for the optical fiber disposed on the first surface of the support material. The light beam travels in the first direction from the optical waveguide within the PIC die/chip to the optical reflector structure, and then in the second direction from the optical reflector structure through the overall thickness of the support material to the optical coupling interface for the optical fiber.

In another example embodiment, a photonic system is disclosed. The photonic system includes a support material. The photonic system also includes an optical coupling interface for an optical fiber disposed on a first surface of the support material. The photonic system also includes a PIC die/chip disposed on a second surface of the support material. The second surface of the support material is opposite from the first surface of the support material relative to an overall thickness of the support material. The photonic system also includes an opening formed through both the support material and the PIC die/chip. The optical coupling interface for the optical fiber is disposed over the opening on the first surface of the support material. The photonic system also includes an optical reflector structure disposed within the opening. The optical reflector structure is configured to receive a light beam traveling in a first direction from an optical waveguide within the PIC die/chip and turn the light beam into a second direction toward the optical coupling interface for the optical fiber disposed on the first surface of the support material. The light beam travels through the opening to reach the optical coupling interface for the optical fiber.

### BRIEF DESCRIPTION OF THE DRAWINGS

FIG. 1A shows an example of a monolithically integrated photonic system, in accordance with some embodiments.

FIG. 1B shows the monolithically integrated photonic system of FIG. 1A with the various components depicted at respective sizes that are closer to actual scale with respect to each other, in accordance with some embodiments.

FIG. 2A shows an example of a heterogeneously integrated photonic system, in accordance with some embodiments.

FIG. 2B shows the heterogeneously integrated photonic system of FIG. 2A with the various components depicted at respective sizes that are closer to actual scale with respect to each other, in accordance with some embodiments.

FIG. 3 shows the example heterogeneously integrated photonic system of FIG. 2A with the PIC die/chip retaining a silicon handle and/or bottom oxide layer, in accordance with some embodiments.

FIG. 4 shows an example of a heterogeneously integrated photonic system, in accordance with some embodiments.

FIG. 5A shows a vertical cross-section of a monolithically integrated photonic system, in accordance with some embodiments.

FIG. 5B shows a vertical cross-section of a monolithically integrated photonic system, in accordance with some embodiments.

FIG. 5C shows a vertical cross-section of a monolithically integrated photonic system, in accordance with some embodiments.

FIG. 6 shows a vertical cross-section through a monolithically integrated photonic system, in accordance with some embodiments.

FIG. 7A shows the vertical cross-section through the monolithically integrated photonic system in which a diverging light beam propagates through the optical path region within the support material from the optical coupling interface for the PIC die/chip to the optical coupling interface for the optical fiber(s) at the surface of the support material opposite from the surface of the support material on which the PIC die/chip is attached, in accordance with some embodiments.

FIG. 7B shows the vertical cross-section through the monolithically integrated photonic system in which a converging (focusing) light beam propagates through the optical path region within the support material from the optical coupling interface for the PIC die/chip to the optical coupling interface for the optical fiber(s) at the surface of the support material opposite from the surface of the support material on which the PIC die/chip is attached, in accordance with some embodiments.

FIG. 7C shows the vertical cross-section through the monolithically integrated photonic system in which a collimated light beam propagates through the optical path region within the support material from the optical coupling interface for the PIC die/chip to the optical coupling interface for the optical fiber(s) at the surface of the support material opposite from the surface of the support material on which the PIC die/chip is attached, in accordance with some embodiments.

FIG. 8 shows the vertical cross-section through the monolithically integrated photonic system in which a multiple-pass light beam propagates through the optical path region within the support material, in accordance with some embodiments.

FIG. 9 shows a vertical cross-section through a heterogeneously integrated photonic system, in accordance with some embodiments.

FIG. 10A shows a vertical cross-section through a photonic system, in accordance with some embodiments.

FIG. 10B shows a vertical cross-section through a photonic system, in accordance with some embodiments.

FIG. 10C shows a vertical cross-section through a photonic system, in accordance with some embodiments.

FIG. 10D shows a vertical cross-section through a photonic system, in accordance with some embodiments.

FIG. 10E shows an example thin film stack configuration that can be used to form the mirror structure, in accordance with some embodiments.

FIG. 10F shows a vertical cross-section through a photonic system, in accordance with some embodiments.

FIG. 11 shows a vertical cross-section through a photonic system, in accordance with some embodiments.

FIG. 12A shows a vertical cross-section through a photonic system, in accordance with some embodiments.

FIG. 12B shows a vertical cross-section through a photonic system, in accordance with some embodiments.

FIG. 12C shows a vertical cross-section through a photonic system, in accordance with some embodiments.

FIG. 12D shows a vertical cross-section through a photonic system, in accordance with some embodiments.

FIG. 13A shows a vertical cross-section through a photonic system, in accordance with some embodiments.

FIG. 13B shows a vertical cross-section through a photonic system, in accordance with some embodiments.

FIG. 13C shows a vertical cross-section through a photonic system, in accordance with some embodiments.

FIG. 14 shows a vertical cross-section through a photonic system, in accordance with some embodiments.

FIG. 15 shows a vertical cross-section through a photonic system, in accordance with some embodiments.

FIG. 16A shows a vertical cross-section through a photonic system, in accordance with some embodiments.

FIG. 16B shows a vertical cross-section through a photonic system, in accordance with some embodiments.

FIG. 16C shows a vertical cross-section through a photonic system, in accordance with some embodiments.

FIG. 16D shows a vertical cross-section through a photonic system, in accordance with some embodiments.

FIG. 16E shows a vertical cross-section through a photonic system, in accordance with some embodiments.

FIG. 16F shows a vertical cross-section through a photonic system, in accordance with some embodiments.

FIG. 17 shows a vertical cross-section through a photonic system, in accordance with some embodiments.

FIG. 18A shows a vertical cross-section through a photonic system, in accordance with some embodiments.

FIG. 18B shows a vertical cross-section through a photonic system, in accordance with some embodiments.

FIG. 19 shows a vertical cross-section through a photonic system, in accordance with some embodiments.

FIG. 20A shows a bottom view of the PIC die/chip to demonstrate formation of separate openings through the PIC die/chip for separate waveguide channels or associated optical ports/facets within the PIC die/chip, respectively, in accordance with some embodiments.

FIG. 20B shows a bottom view of the PIC die/chip to demonstrate formation of a larger opening through the PIC die/chip for multiple waveguide channels or associated optical ports/facets within the PIC die/chip, respectively, in accordance with some embodiments.

FIG. 21A shows a vertical cross-section through a photonic system, in accordance with some embodiments.

FIG. 21B shows a vertical cross-section through a photonic system, in accordance with some embodiments.

FIG. 22 shows a vertical cross-section through a photonic system, in accordance with some embodiments.

FIG. 23 shows a vertical cross-section through a photonic system, in accordance with some embodiments.

FIG. 24A shows a vertical cross-section through a photonic system, in accordance with some embodiments.

FIG. 24B shows a top view of the photonic system, in accordance with some embodiments.

FIG. 25A shows the vertical cross-section through the photonic system, with the light beam having a diverging shape as it enters the optical coupling interface for the optical fiber, in accordance with some embodiments.

FIG. 25B shows a vertical cross-section of a plug that can be implemented as the plug of FIG. 25A, in accordance with some embodiments.

FIG. 25C shows a vertical cross-section of a plug that can be implemented as the plug of FIG. 25A, in accordance with some embodiments.

FIG. 25D shows a vertical cross-section of a plug that can be implemented as the plug of FIG. 25A, in accordance with some embodiments.

FIG. 26A shows the vertical cross-section through the photonic system, with the light beam having a collimated shape as it enters the optical coupling interface for the optical fiber, in accordance with some embodiments.

FIG. 26B shows a vertical cross-section of a plug that can be implemented as the plug of FIG. 26A to work with the light beam having the collimated shape as it enters the optical coupling interface for the optical fiber, in accordance with some embodiments.

FIG. 26C shows a vertical cross-section of a plug that can be implemented as the plug of FIG. 26A to work with the light beam having the collimated shape as it enters the optical coupling interface for the optical fiber, in accordance with some embodiments.

FIG. 27A shows the vertical cross-section through the photonic system, with the light beam making multiple passes between the optical coupling interface for the PIC die/chip and the optical coupling interface for the optical fiber, in accordance with some embodiments.

FIG. 27B shows a vertical cross-section of a plug that can be implemented as the plug of FIG. 27A to direct the multiple passes of the light beam between the optical coupling interface for the PIC die/chip and the optical coupling interface for the optical fiber, in accordance with some embodiments.

FIG. 27C shows the light beam traveling in the opposite direction through the plug, i.e., from the optical fiber to the PIC die/chip, in accordance with some embodiments.

FIG. 28A shows the vertical cross-section through the photonic system, with the plug configured to have the optical fiber attached to a top surface of the plug, such that a centerline of a core of the optical fiber is oriented toward the surface of the support material underlying the plug, in accordance with some embodiments.

FIG. 28B shows a vertical cross-section of a plug that can be implemented as the plug of FIG. 28A, in accordance with some embodiments.

FIG. 28C shows a vertical cross-section of a plug that can be implemented as the plug of FIG. 28A, in accordance with some embodiments.

FIG. 28D shows a vertical cross-section of a plug that can be implemented as the plug of FIG. 28A, in accordance with some embodiments.

FIG. 28E shows a vertical cross-section of a plug that can be implemented as the plug of FIG. 28A, in accordance with some embodiments.

### DETAILED DESCRIPTION

A photonic integrated circuit (PIC) functions by manipulating and routing light on a die/chip using optical waveguides (“waveguides” hereafter) and other photonic devices, which may be passive or active photonic devices. In some embodiments, optical signals are transmitted to and/or from a PIC die/chip through optical fibers. Various embodiments are disclosed herein for photonic systems implementing optical coupling configurations that provide for high optical coupling efficiency between an optical fiber and a waveguide or associated optical port/facet within a PIC die/chip.

A PIC die/chip implements electrical circuits to control the photonic elements and interface with other electronic systems. In a monolithically integrated photonic system, both photonic components and electrical components are implemented and operated on a same PIC die/chip. In some embodiments, in the monolithically integrated photonic system, the electrical signals are routed through a redistribution layer (RDL) by way of electrically conductive bumps connected to the PIC die/chip, e.g., by way of solder bumps in a controlled collapse chip connection (C4) process, which are referred to as C4 bumps.

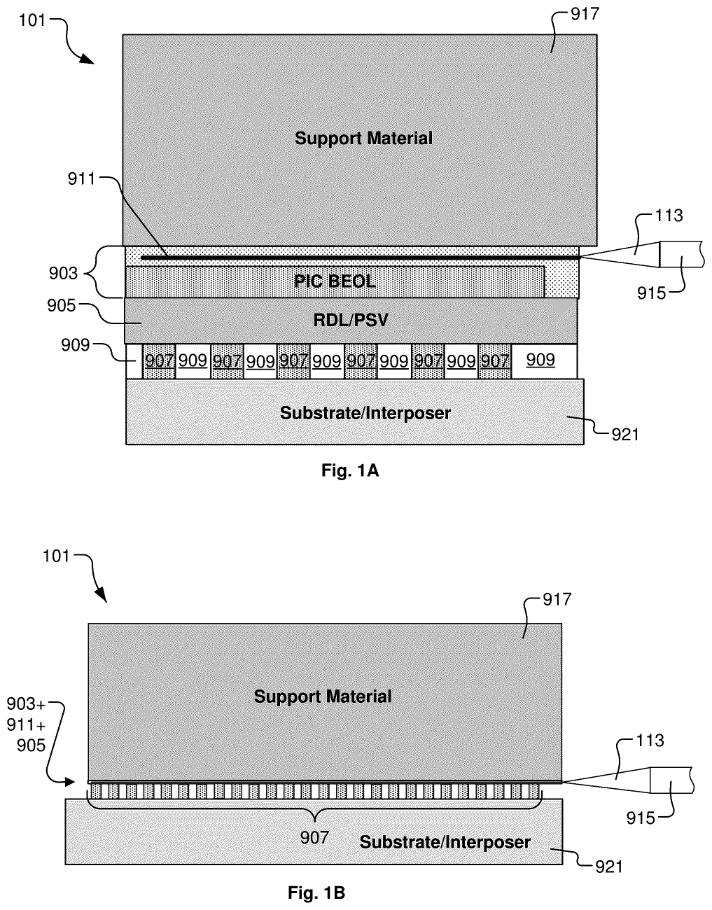

FIG. 1A shows an example of a monolithically integrated photonic system 101, in accordance with some embodiments. The monolithically integrated photonic system 101 includes a PIC die/chip 903 disposed on a support material layer 917, such as a substrate layer or a carrier wafer. In some embodiments, the support material 917 is silicon. In some embodiments, the support material 917 is substantially transparent to light. The PIC die/chip 903 includes photonic components, electronic components, and electro-optical components. An RDL 905 is disposed on a back-end-of-line (BEOL) portion of the PIC die/chip 903. The RDL 905 includes routings of electrically conductive traces/wires in one or more layers that are separated by intervening dielectric material layer(s), with a number of electrically conductive via structures disposed to electrically connect various electrically conductive traces/wires in different layers of the RDL 905 to establish electrical circuits as needed. The RDL 905 also includes a number of externally exposed electrical connections that are electrically connected to corresponding electrical connections within the PIC die/chip 903. The RDL 905 also includes a number of externally exposed electrical connections that are electrically and physically connected to corresponding C4 bumps 907 for electrical signal routing to/from the PIC die/chip 903 by way of the RDL 905. In some embodiments, a passivation (PSV) layer is implemented in conjunction with the RDL 905. In some embodiments, an underfill mold material 909 is disposed around the C4 bumps 907 between the RDL 905 and substrate/interposer 921 to which the C4 bumps 907 are connected. The PIC die/chip 903 includes at least one waveguide 911 that is connected to convey light (optical signals) to and/or from the PIC die/chip 903. In some embodiments, the waveguide 911 and various photonic devices and/or electro-optic devices are implemented within the front-end-of-line (FEOL) portion of the PIC die/chip 903. In the example monolithically integrated photonic system 101, the waveguide 911 is optically connected to an optical coupling mechanism 113 that is configured to facilitate conveyance of light (optical signals) from an optical fiber 915 into the waveguide 911 and/or from the waveguide 911 into the optical fiber 915.

It should be understood that the various components of FIG. 1A are shown schematically at sizes that are not to scale relative to one another in order to facilitate illustration of the various components. FIG. 1B shows the monolithically integrated photonic system 101 of FIG. 1A with the various components depicted at respective sizes that are closer to actual scale with respect to each other, in accordance with some embodiments.

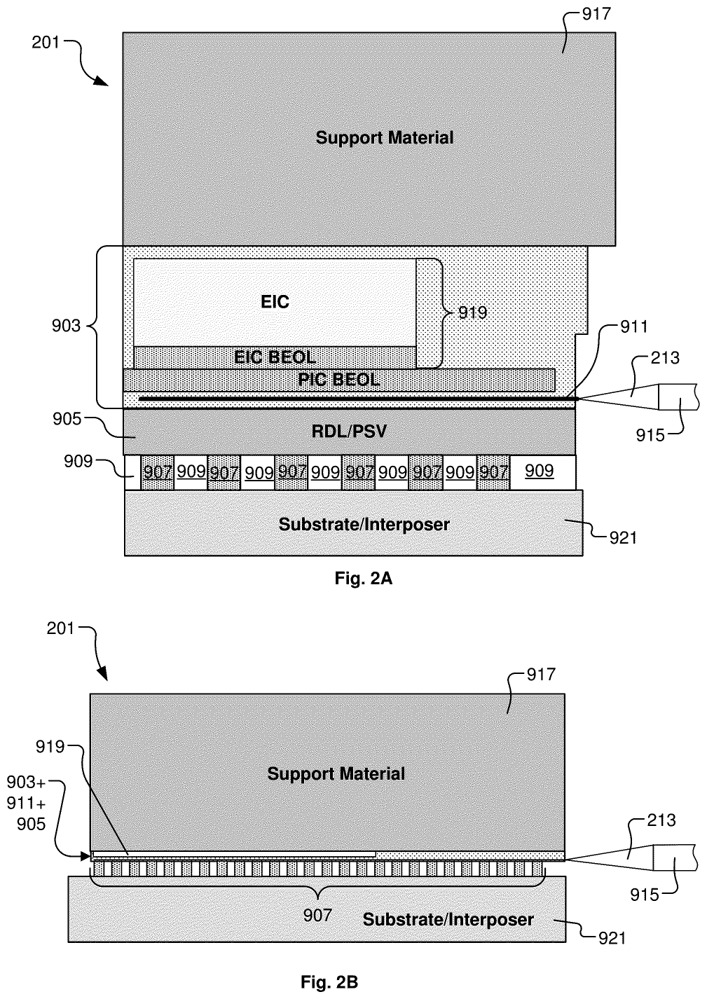

In a heterogeneously integrated photonic system, a dedicated electronic integrated circuit (EIC) die/chip 919 is flip-chip connected to the PIC die/chip 903. FIG. 2A shows an example of a heterogeneously integrated photonic system 201, in accordance with some embodiments. The heterogeneously integrated photonic system 201 includes the PIC die/chip 903 that includes photonic components, electronic components, and electro-optical components. The EIC die/chip 919 is flip-chip connected to the PIC die/chip 903. In some embodiments, the EIC die/chip 919 is disposed on a top surface of the PIC die/chip 903. In some of these embodiments, the EIC die/chip 919 is turned upside down and is flip-chip connected to the PIC die/chip 903, such that exposed electrical connections of a BEOL portion of the PIC die/chip 903 are electrically connected to exposed electrical connections of a BEOL portion of the EIC die-chip 919. In some embodiments, C4 bumps are used to flip-chip connect the EIC die/chip 919 to the PIC die/chip 903. In some embodiments, with the EIC die/chip 919 flip-chip connected to the PIC die/chip 903, and with a silicon handle of the PIC die/chip 903 thinned or removed, the PIC die/chip 903 is disposed on the RDL 905. In some embodiments, electrical connections are routed between the RDL 905 located below the PIC die/chip 903 and the EIC die/chip 919 located above the PIC die/chip 903. In various embodiments, routing of electrical connections between the RDL 905 and the EIC die/chip 919 is accomplished using electrically conductive via structures (vias) that extend through the PIC die/chip 903, including through the a bottom oxide layer or silicon handle of the PIC die/chip 903. Via structures that extend through the bottom oxide layer or silicon handle of the PIC die/chip 903 are referred to as through-silicon-vias (TSVs). Electrical signals are routed through the RDL 905 by way of the electrically conductive C4 solder bumps 907.

The PIC die/chip 903 includes at least one waveguide 911 that is connected to convey light (optical signals) to and/or from the PIC die/chip 903. In some embodiments, the waveguide 911 and various photonic devices and/or electro-optic devices are implemented within the FEOL portion of the PIC die/chip 903. The waveguide 911 is optically connected to an optical coupling mechanism 213 that is configured to facilitate conveyance of light (optical signals) from the optical fiber 915 into the waveguide 911 and/or from the waveguide 911 into the optical fiber 915. In some embodiments, the heterogeneously integrated photonic system 201 includes the support material layer 917, such as a substrate layer or a carrier wafer, on which the EIC die/chip 919 and the PIC die/chip 903 are collectively disposed and supported.

It should be understood that the various components of FIG. 2A are shown schematically at sizes that are not to scale relative to one another in order to facilitate illustration of the various components. FIG. 2B shows the heterogeneously integrated photonic system 201 of FIG. 2A with the various components depicted at respective sizes that are closer to actual scale with respect to each other, in accordance with some embodiments.

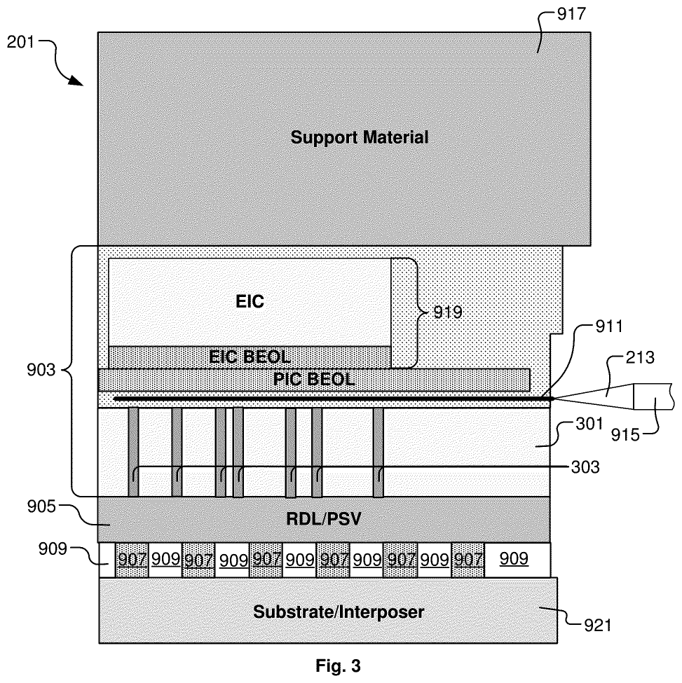

FIG. 3 shows the example heterogeneously integrated photonic system 201 of FIG. 2A with the PIC die/chip 903 retaining a silicon handle and/or bottom oxide layer 301, in accordance with some embodiments. The RDL 905 is disposed on the silicon handle and/or bottom oxide layer 301 of the PIC die/chip 903. A number of TSVs 303 extend through the silicon handle and/or bottom oxide layer 301 of the PIC die/chip 903 to electrically connect the RDL 905 to the PIC die/chip 903 and/or to the EIC die/chip 919. The C4 bumps 907 provide for electrical connection of the RDL 905 to the substrate/interposer 921 to enable conveyance of electrical signals to and from the RDL 905. It should be understood that the various components of FIG. 3 are shown schematically at sizes that are not to scale relative to one another in order to facilitate illustration of the various components.

In some embodiments, it is desirable to simultaneously connect the PIC die/chip 903 both optically to optical fibers 915 and electrically through C4 solder bumps 907 to another component. However, the processes for connecting the optical fibers 915 to the PIC die/chip 903 and for connecting the PIC die/chip 903 to another device by way of the C4 bumps 907 may not be compatible with each other. For example, the high temperature associated with a C4 bump 907 reflow process during flip-chip connection of the PIC die/chip 903 to another device may adversely affect the optical fibers 915 or the epoxy used to attach the optical fibers 915, especially when the optical fibers 915 and C4 bumps 907 are disposed on a same side of the PIC die/chip 903. In some embodiments, the overall package that includes the PIC die/chip 903 is configured to mitigate the adverse impacts on the optical fibers 915 caused by the high-temperature flip-chip attachment processes. However, in these embodiments, the resulting overall package configuration may be less than optimal. For example, the PIC die/chip 903 may be oversized to provide physical and/or thermal separation of the optical fibers 915 from the C4 bumps 907. Also, in some embodiments, the optical fibers 915 and C4 bumps 907 associated with the PIC die/chip 903 may compete for physical space and/or physical arrangement within the overall package. For example, in some embodiments the optical fibers 915 and the C4 bumps 907 are disposed on a same side of the PIC die/chip 903 and compete for physical space with each other. In some embodiments, the PIC die/chip 903 includes a keep-out-zone (KOZ) which defines a spatial region that cannot be occupied by a device, e.g., substrate/interposer 921, that is flip-chip connected to the C4 bumps 907 of the PIC die/chip 903. In some embodiments, the KOZ is defined to ensure that a spatial region is available for attachment of the optical fibers 915 to the PIC die/chip 903. The KOZ is sometimes needed when the optical fibers 915 are disposed on the same side of the PIC die/chip 903 as the C4 bumps 907.

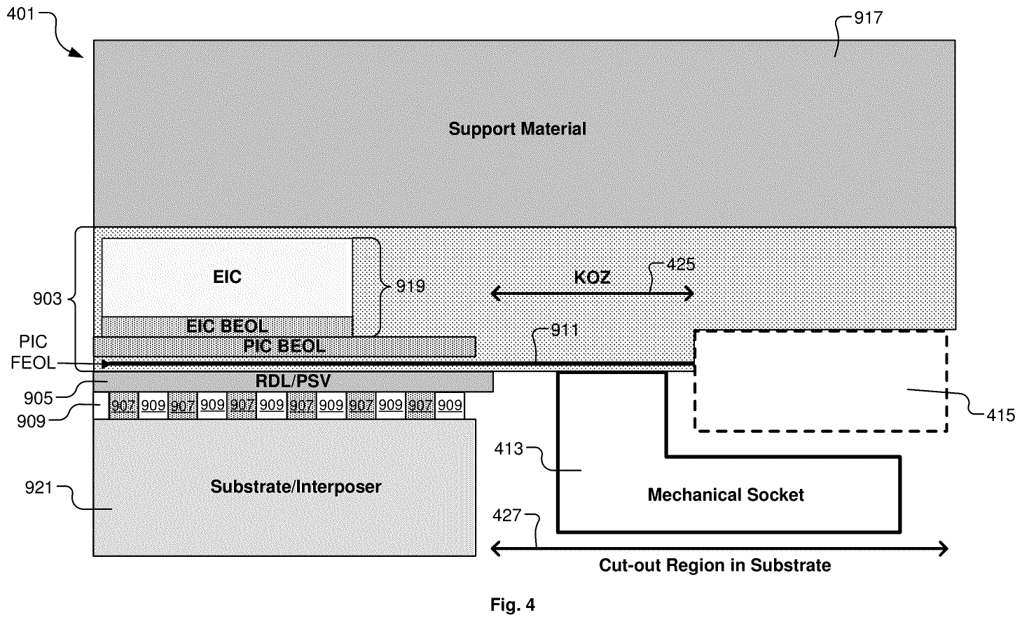

FIG. 4 shows an example of a heterogeneously integrated photonic system 401, in accordance with some embodiments. It should be understood that the various components of FIG. 4 are shown schematically at sizes that are not to scale relative to one another in order to facilitate illustration of the various components. The heterogeneously integrated photonic system 401 includes the PIC die/chip 903 that includes photonic components, electronic components, and electro-optical components. The EIC die/chip 919 is flip-chip connected to the PIC die/chip 903. In some embodiments, the EIC die/chip 919 is disposed on a top surface of the PIC die/chip 903. In some of these embodiments, the EIC die/chip 919 is turned upside down and is flip-chip connected to the PIC die/chip 903, such that exposed electrical connections of a BEOL portion of the PIC die/chip 903 are electrically connected to exposed electrical connections of a BEOL portion of the EIC die-chip 919. In some embodiments, with the EIC die/chip 919 flip-chip connected to the PIC die/chip 903, and with a silicon handle of the PIC die/chip 903 thinned or removed, the PIC die/chip 903 is disposed on the RDL 905.

In some embodiments, electrical connections are routed between the RDL 905 located below the PIC die/chip 903 and the EIC die/chip 919 located above the PIC die/chip 903. In various embodiments, routing of electrical connections between the RDL 905 and the EIC die/chip 919 is accomplished using electrically conductive via structures that extend through the PIC die/chip 903 and/or through the bottom oxide layer or silicon handle of the PIC die/chip 903, e.g., TSV's.

The PIC die/chip 903 includes at least one waveguide 911 that is connected to convey light (optical signals) to and/or from the PIC die/chip 903. In some embodiments, the waveguide 911 and various photonic devices and/or electro-optic devices are implemented within the FEOL portion of the PIC die/chip 903. The waveguide 911 is optically connected to an optical fiber 415. In this manner, light (optical signals) is conveyed from an optical fiber 415 into the waveguide 911 and/or from the waveguide 911 into the optical fiber 415. In some embodiments, the PIC die/chip 903 is equipped with a mechanical socket 413 to facilitate securing of the optical fiber 415 to the PIC die/chip 903. Also, in some embodiments, the heterogeneously integrated photonic system 401 includes the support material layer 917, such as a substrate layer or a carrier wafer, on which the EIC die/chip 919 and the PIC die/chip 903 are collectively disposed and supported.

The heterogeneously integrated photonic system 401 has the C4 bumps 907 of the RDL 905 and the optical fiber(s) 415 located on a same side of the PIC die/chip 903. The PIC die/chip 903 includes a KOZ 425 to provide physical and/or thermal separation between the C4 bumps 907 and the optical fiber(s) 415. Also, in some embodiments, the KOZ 425 is formed to accommodate attachment of the mechanical socket 413 to the PIC die/chip 903 on the side of the PIC die/chip 903 where the C4 bumps 907 are located. The substrate/interposer 921 correspondingly includes a cut-out region 427 configured to accommodate the KOZ 425, the mechanical socket 413, and the optical fiber(s) 415. In this manner, a portion of the substrate/interposer 921 is excluded (removed, cut-out) to spatially accommodate connection of the optical fiber(s) 415 to the PIC die/chip 903. In some embodiments, it is not optimal to have the KOZ 425 formed within the PIC die/chip 903, because it consumes valuable area within the PIC die/chip 903 and is non-standard in many packaging ecosystems. Therefore, in order to eliminate the KOZ 425, it is of interest to relocate the mechanical socket 413 and optical fiber(s) 415 to a location other than the side of PIC die/chip 903 where the C4 bumps 907 are located.

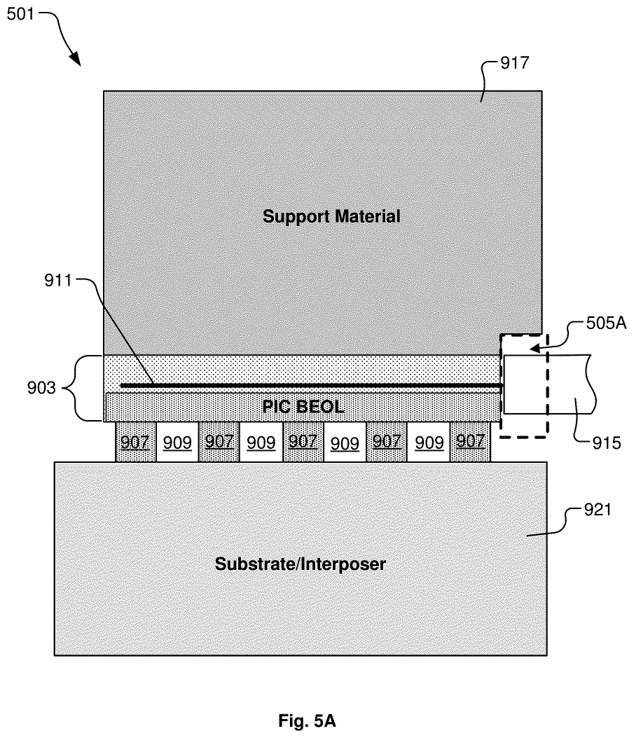

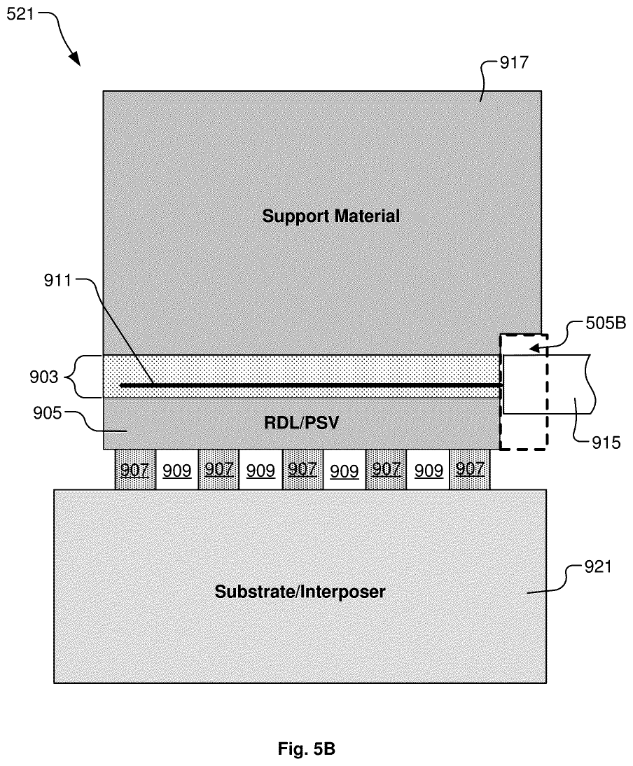

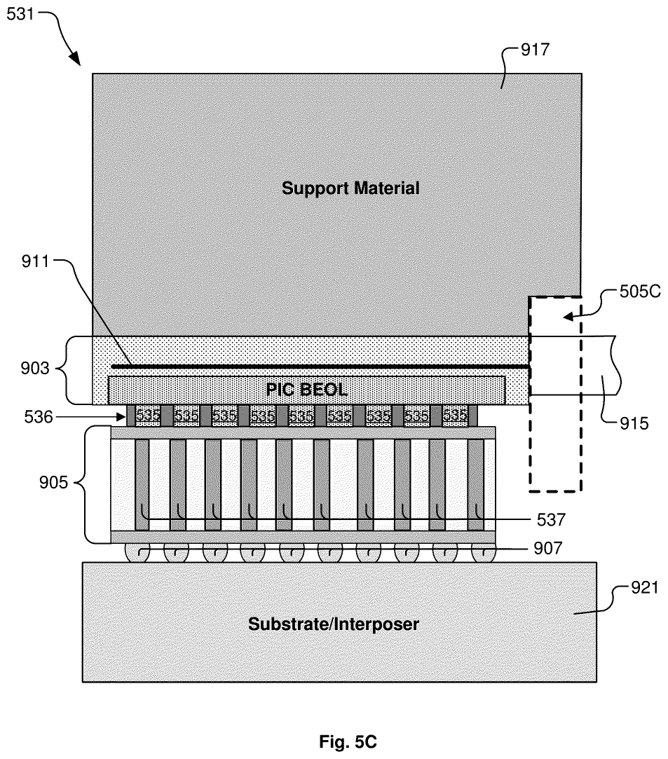

FIG. 5A shows a vertical cross-section of a monolithically integrated photonic system 501, in accordance with some embodiments. It should be understood that the various components of FIG. 5A are shown schematically at sizes that are not to scale relative to one another in order to facilitate illustration of the various components. The monolithically integrated photonic system 501 includes a PIC die/chip 903 disposed on a support material 917, such as a substrate layer or a carrier wafer. The PIC die/chip 903 and support material 917 are inverted in FIG. 5A. Specifically, the FEOL portion of the PIC die/chip 903 that includes the waveguide(s) 911 is above the BEOL region of the PIC die/chip 903 that includes exposed electrical connections to which the C4 bumps 907 are attached. The waveguide(s) 911 are connected to convey light (optical signals) to and/or from the PIC die/chip 903. In some embodiments, along with the waveguide(s) 911, various photonic devices and/or electro-optic devices are also implemented within the FEOL portion of the PIC die/chip 903. A substrate/interposer 921 is attached to the C4 bumps 907. In various embodiments, the substrate/interposer 921 can include essentially any type of electronic and photonic circuitry. In the example monolithically integrated photonic system 501, a portion of the PIC die/chip 903 and a portion of the support material 917 is removed to form an optical coupling interface region 505A. In some embodiments, the optical fiber(s) 915 are positioned within the optical coupling interface region 505A to optically couple with corresponding ones of the waveguide(s) 911 within the PIC die/chip 903. In some embodiments, a mechanical connector is disposed within the optical coupling interface region 505A to facilitate attachment and optical alignment of the optical fiber(s) 915 with the PIC die/chip 903.

FIG. 5B shows a vertical cross-section of a monolithically integrated photonic system 521, in accordance with some embodiments. It should be understood that the various components of FIG. 5B are shown schematically at sizes that are not to scale relative to one another in order to facilitate illustration of the various components. The monolithically integrated photonic system 521 of FIG. 5B is a modification of the monolithically integrated photonic system 501 of FIG. 5A. The monolithically integrated photonic system 521 includes the PIC die/chip 903 having the internal waveguide(s) 911 therein, the support material 917, and the substrate/interposer 921. In the monolithically integrated photonic system 521, the PIC die/chip 903 is electrically and physically connected to the RDL 905, which may include a passivation layer (PSV). The RDL 905 includes exposed electrical contacts that are electrically connected to corresponding exposed electrical contacts of the substrate/interposer 921, by way of respective C4 bumps 907. In the example monolithically integrated photonic system 521, a portion of the PIC die/chip 903, a portion of the support material 917, and a portion of the RDL 905 is removed to form an optical coupling interface region 505B. In some embodiments, the optical fiber(s) 915 are positioned within the optical coupling interface region 505B to optically couple with corresponding ones of the waveguide(s) 911 within the PIC die/chip 903. In some embodiments, a mechanical connector is disposed within the optical coupling interface region 505B to facilitate attachment and optical alignment of the optical fiber(s) 915 with the PIC die/chip 903.

FIG. 5C shows a vertical cross-section of a monolithically integrated photonic system 531, in accordance with some embodiments. It should be understood that the various components of FIG. 5C are shown schematically at sizes that are not to scale relative to one another in order to facilitate illustration of the various components. The monolithically integrated photonic system 531 of FIG. 5C is a modification of the monolithically integrated photonic system 501 of FIG. 5A. The monolithically integrated photonic system 531 includes the PIC die/chip 903 having the internal waveguide(s) 911 therein, the support material 917, and the substrate/interposer 921. In the monolithically integrated photonic system 531, the PIC die/chip 903 is electrically and physically connected to the RDL 905. The RDL 905 includes exposed electrical contacts that are electrically connected to corresponding exposed electrical contacts of the PIC die/chip 903, by way of respective C4 bumps 535. In some embodiments, a mold material 536 is disposed between the PIC die/chip 903 and the RDL 905, and between the C4 bumps 535. The RDL 905 also includes exposed electrical contacts that are electrically connected to corresponding exposed electrical contacts of the substrate/interposer 921 by way of respective C4 bumps 907. In some embodiments, the RDL 905 includes via structures 537, such as TSV's, to provide for direct electrical connection of the PIC die/chip 903 to the substrate/interposer 921. In the example monolithically integrated photonic system 531, a portion of the PIC die/chip 903, a portion of the support material 917, and a portion of the RDL 905 is removed to form an optical coupling interface region 505C. In some embodiments, optical fiber(s) 915 are positioned within the optical coupling interface region 505C to optically couple with corresponding ones of the waveguide(s) 911 within the PIC die/chip 903. In some embodiments, a mechanical connector is disposed within the optical coupling interface region 505C to facilitate attachment and optical alignment of the optical fiber(s) 915 with the PIC die/chip 903. The monolithically integrated photonic systems 501, 521, 531 of FIGS. 5A, 5B, 5C, respectively, show various ways of connecting the optical fiber(s) 915 to the side of the PIC die/chip 903 to accommodate various packaging ecosystems, connectivity configurations, and/or space constraints.

It is often necessary in packaging of integrated optical systems to make compromises to the PIC die/chip 903 and/or associated packaging configuration in order to accommodate the optical fibers 915, such as by forming KOZ's in the PIC die/chip 903 and/or by forming cut-outs in the substrate/interposer 921 to which the PIC die/chip 903 is attached. It is of interest to avoid making such compromises to the PIC die/chip 903 and/or associated packaging configuration in order to accommodate connection of the optical fibers 915 to the PIC die/chip 903. Various embodiments are disclosed herein for photonic systems that have the optical fiber coupling interface formed on the backside of the PIC die/chip 903, opposite from the side of the PIC die/chip 903 that has the electrical connectivity interface, e.g., the C4 bumps 907, in order to avoid having a KOZ within the PIC die/chip 903 and/or having a cut-out region in the substrate/interposer 921 to which the PIC die/chip 903 is attached.

In various embodiments disclosed herein, a PIC die/chip 903 optical coupling interface is provided that can be integrated into both monolithically integrated photonic systems and heterogeneously integrated photonic systems. In various embodiments disclosed herein, the PIC die/chip 903 optical coupling interface includes optical elements to direct light from the optical waveguide(s) 911 of the PIC die/chip 903 to the optical fiber coupling interface on the backside of the PIC die/chip 903. In various embodiments disclosed herein, the optics of the PIC die/chip 903 optical coupling interface are fabricated at the wafer-level. In various embodiments disclosed herein, optical components associated with the PIC die/chip 903 optical coupling interface are fabricated separately from the PIC die/chip 903 and are attached to the PIC die/chip 903. In various embodiments disclosed herein, the PIC die/chip 903 optical coupling interface has combined optical functionality, e.g., reflection, lensing, collimation, etc. In some embodiments, the PIC die/chip 903 optical coupling interface includes multiple photonic system elements to provide for efficient optically coupling between the PIC die/chip 903 and the optical fiber(s) 915.

Various embodiments are disclosed herein for photonics design solutions in which the optical path is taken through the backside of the PIC die/chip 903, so as to avoid the need for a KOZ within the PIC die/chip 903 and/or the need for a cut-out region within the substrate/interposer 921 to which the PIC die/chip 903 is attached by C4 bumps 907. In various embodiments disclosed herein, the optical path taken by optical signals entering and/or leaving the PIC die/chip 903 is either a single-pass optical path or a multi-pass optical path, and goes through the backside of the PIC die/chip 903. In various embodiments disclosed herein, the optical path taken by optical signals entering and/or leaving the PIC die/chip 903 passes directly through the support material 917 for the PIC die/chip 903. In various embodiments disclosed herein, the optical path taken by optical signals entering and/or leaving the PIC die/chip 903 passes through an opening/channel/hole that is formed, e.g., etched, cut, drilled, etc., through the support material 917 for the PIC die/chip 903. In various embodiments disclosed herein, a mechanical socket is disposed on the backside of the PIC die/chip 903 to enable pluggable optical fiber 915 connection to the PIC die/chip 903. It should be understood that the various embodiments for optical fiber 915 to PIC die/chip 903 optical coupling disclosed herein can be applied to both monolithic integrated optical systems and heterogeneous integrated optical systems. For ease of discussion, both monolithic integrated optical systems and heterogeneous integrated optical systems are generally referred to herein as a photonic system.

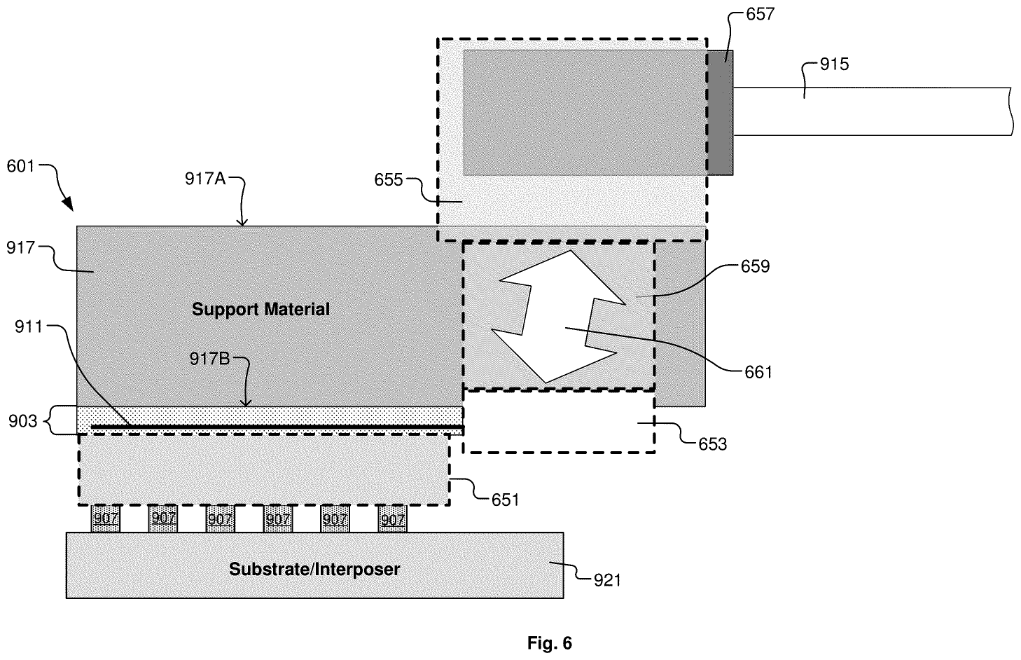

FIG. 6 shows a vertical cross-section through a monolithically integrated photonic system 601, in accordance with some embodiments. It should be understood that the various components of FIG. 6 are shown schematically at sizes that are not to scale relative to one another in order to facilitate illustration of the various components. The monolithically integrated photonic system 601 includes the PIC die/chip 903 disposed on the support material 917, such as a substrate layer or a carrier wafer. It should be understood that the PIC die/chip 903 is not inverted in FIG. 6. Specifically, the BEOL portion of the PIC die/chip 903 is positioned next to the support material 917. The FEOL portion of the PIC die/chip 903 that includes waveguide(s) 911 and photonic devices is located below the BEOL portion of the PIC die/chip 903. The FEOL portion of the PIC die/chip 903 is positioned on top of an electrical connectivity interface 651. In various embodiments, the electrical connectivity interface 651 is configured as the RDL 905, and/or an interposer, and/or a substrate, and/or an electrical fanout device, and/or other electrical device. In various embodiments, the electrical connectivity interface 651 includes vias, TSVs, and C4 bumps. In some embodiments, the PIC die/chip 903 includes exposed electrical connections to which the electrical connectivity interface 651 is electrically and physically connected. In some embodiments, the electrical connectivity interface 651 is electrically and physically connected to another device, e.g., substrate/interposer 921, etc., through C4 bumps 907 that are attached to a side of the electrical connectivity interface 651 located away from the PIC die/chip 903. In some embodiments, the electrical connectivity interface 651 includes the RDL configured to provide for electrical connectivity of the PIC die/chip 903 to one or more electronic device(s) and/or electro-optic device(s). The PIC die/chip 903 includes the waveguide(s) 911 configured to convey light (optical signals) out of and/or into the PIC die/chip 903. In some embodiments, along with the waveguide(s) 911, various photonic devices and/or electro-optic devices are also implemented within the FEOL portion of the PIC die/chip 903.

In the example monolithically integrated photonic system 601, an optical coupling interface 653 for the PIC die/chip 903 is provided at an edge of the PIC die/chip 903 where the one or more waveguide(s) 911 are located for optical connection. Also, an optical coupling interface 655 for one or more optical fiber(s) 915 is provided on a surface 917A of the support material 917 that is opposite from a surface 917B of the support material 917 onto which the PIC die/chip 903 is attached. In some embodiments, a mechanical connector 657, e.g., plug, is implemented in conjunction with the optical coupling interface 655 to facilitate attachment and optical alignment of the optical fiber(s) 915 within the optical coupling interface 655. In some embodiments, the optical fiber(s) 915 form an optical fiber array, such as a fiber array unit (FAU). In some embodiments, collimation optics are implemented within the optical fiber(s) 915.

Light (optical signals) that are conveyed through the waveguide(s) 911 and out from the PIC die/chip 903 is diverted upward by the optical coupling interface 653, through an optical path region 659 that extends through the support material 917. In some embodiments, the optical coupling interface 653 for the PIC die/chip 903 is implemented, at least in part, by optical elements disposed in the FEOL of the PIC die/chip 903. The upwardly diverted light beam follows an optical path that extends from the optical coupling interface 653 for the PIC die/chip 903 through the support material 917 (e.g., wafer handle, support silicon, carrier wafer, among other support configurations) to the optical coupling interface 655 for the optical fiber(s) 915. The optical coupling interface 655 for the optical fiber(s) 915 is configured to direct the light from the PIC die/chip 903 into the optical fiber(s) 915. In various embodiments, the optical coupling interface 655 includes optical components for turning/diverting, and/or focusing a light beam in order to facilitate optical coupling of the light from the PIC die/chip 903 into the optical fiber(s) 915. Also, it should be understood that light (optical signals) travel from the optical fiber(s) 915 to the waveguide(s) 911 within PIC die/chip 903 by way of the optical coupling interface 655 for the optical fiber(s) 915 and the optical coupling interface 653 for the PIC die/chip 903. In this manner, the light (optical signals) that travels from the optical fiber(s) 915 to the waveguide(s) 911 within PIC die/chip 903 travels through the optical path region 659 that extends through the support material 917. Therefore, it should be understood that the optical coupling interface 655 for the optical fiber(s) 915 and the optical coupling interface 653 for the PIC die/chip 903 provide for bi-directional conveyance of light (optical signals) through the optical path region 659 that extends through the support material 917, as indicated by arrow 661.

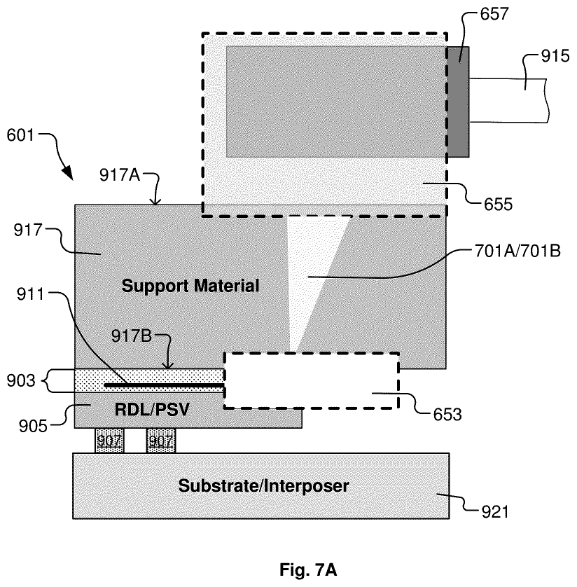

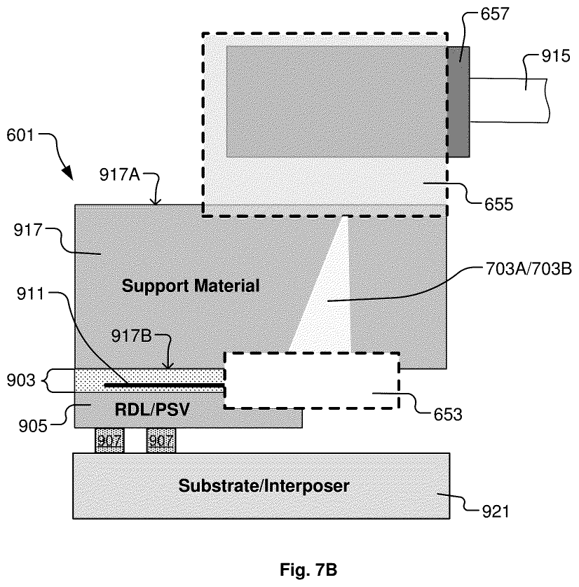

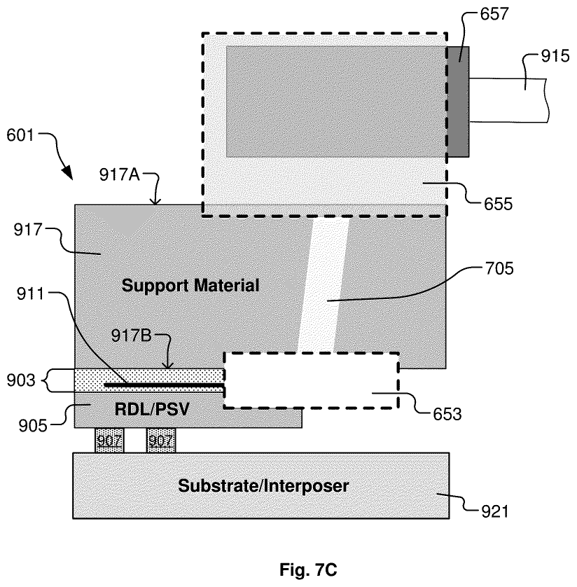

FIG. 7A shows the vertical cross-section through the monolithically integrated photonic system 601 in which a diverging light beam 701A propagates through the optical path region 659 within the support material 917 from the optical coupling interface 653 for the PIC die/chip 903 to the optical coupling interface 655 for the optical fiber(s) 915 at the surface 917A of the support material 917 opposite from the surface 917B of the support material 917 on which the PIC die/chip 903 is attached, in accordance with some embodiments. FIG. 7A also shows how a converging (focusing) light beam 701B propagates through the optical path region 659 within the support material 917 from the optical coupling interface 655 for the optical fiber(s) 915 to the optical coupling interface 653 for the PIC die/chip 903.

FIG. 7B shows the vertical cross-section through the monolithically integrated photonic system 601 in which a converging (focusing) light beam 703A propagates through the optical path region 659 within the support material 917 from the optical coupling interface 653 for the PIC die/chip 903 to the optical coupling interface 655 for the optical fiber(s) 915 at the surface 917A of the support material 917 opposite from the surface 917B of the support material 917 on which the PIC die/chip 903 is attached, in accordance with some embodiments. FIG. 7B also shows how a diverging light beam 703B propagates through the optical path region 659 within the support material 917 from the optical coupling interface 655 for the optical fiber(s) 915 to the optical coupling interface 653 for the PIC die/chip 903.

FIG. 7C shows the vertical cross-section through the monolithically integrated photonic system 601 in which a collimated light beam 705 propagates through the optical path region 659 within the support material 917 from the optical coupling interface 653 for the PIC die/chip 903 to the optical coupling interface 655 for the optical fiber(s) 915 at the surface 917A of the support material 917 opposite from the surface 917B of the support material 917 on which the PIC die/chip 903 is attached, in accordance with some embodiments. FIG. 7C also shows how the collimated light beam 705 propagates through the optical path region 659 within the support material 917 from the optical coupling interface 655 for the optical fiber(s) 915 to the optical coupling interface 653 for the PIC die/chip 903.

In various embodiments, as shown in FIGS. 7A, 7B, and 7C, the optical path region 659 that extends through the support material 917 will have either the diverging light beam 701A, 703B, the converging light beam 701B, 703A, or the collimated light beam 705, depending on the direction of light propagation through the optical path region 659. In various embodiments, photonics components, e.g., optical lenses, etc., within the optical coupling interface 653 for the PIC die/chip 903 and the photonics components, e.g., optical lenses, etc., within the optical coupling interface 655 for the optical fiber(s) 915 are collectively configured to implement either the diverging light beam 701A, 703B, the converging light beam 701B, 703A, or the collimated light beam 705, as needed.

In some embodiments, such as shown in FIGS. 7A, 7B, and 7C, the optical path through the optical path region 659 between the optical coupling interface 653 for the PIC die/chip 903 and the optical coupling interface 655 for the optical fiber(s) 915 is a single-pass optical path, such that light conveyed from the optical coupling interface 653 is received into the optical coupling interface 655 with one passage of the light through the optical path region 659 that extends through the support material 917, and such that light conveyed from the optical coupling interface 655 is received into the optical coupling interface 653 with one passage of the light through the optical path region 659 that extends through the support material 917. In some embodiments, the optical path through the optical path region 659 between the optical coupling interface 653 for the PIC die/chip 903 and the optical coupling interface 655 for the optical fiber(s) 915 is a multiple-pass optical path, such that light conveyed from the optical coupling interface 653 passes through the optical path region 659 within the support material 917 multiple times before being ultimately received into the optical coupling interface 655 and conveyed into the optical fiber(s) 915, and such that light conveyed from the optical coupling interface 655 passes through the optical path region 659 within the support material 917 multiple times before being ultimately received into the optical coupling interface 653 and conveyed into the waveguide(s) 911 or associated optical port(s)/facet(s) of the PIC die/chip 903.

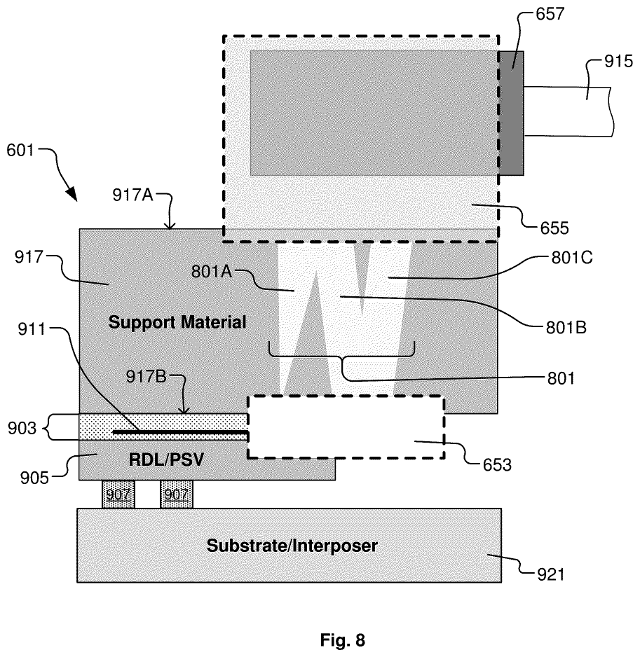

FIG. 8 shows the vertical cross-section through the monolithically integrated photonic system 601 in which a multiple-pass light beam 801 propagates through the optical path region 659 within the support material 917, in accordance with some embodiments. In some embodiments, a given pass of the multiple-pass light beam 801 through the optical path region 659 is either a converging light beam, a diverging light beam, or a collimated light beam. In some embodiments, different passes of the multiple-pass light beam 801 includes different ones of a converging light beam, a diverging light beam, and a collimated light beam, such that the multiple-pass light beam 801 is a combination of at least two of the converging light beam, the diverging light beam, and the collimated light beam. For example, the multiple-pass light beam 801 of FIG. 8 includes a diverging light beam 801A in the direction from the optical coupling interface 653 for the PIC die/chip 903 to the optical coupling interface 655 for the optical fiber(s) 915, a first collimated light beam 801B in the direction from the optical coupling interface 655 for the optical fiber(s) 915 to the optical coupling interface 653 for the PIC die/chip 903, and a second collimated light beam 801C in the direction from the optical coupling interface 653 for the PIC die/chip 903 to the optical coupling interface 655 for the optical fiber(s) 915, where the second collimated light beam 801C is received into the optical coupling interface 655 for conveyance into the optical fiber(s) 915. Specifically, the diverging light beam 801A is reflected by the optical coupling interface 655 for the optical fiber(s) 915 back toward the optical coupling interface 653 for the PIC die/chip 903 to form the first collimated light beam 801B. The first collimated light beam 801B is reflected by the optical coupling interface 653 for the PIC die/chip 903 back toward the optical coupling interface 655 for the optical fiber(s) 915 to form the second collimated light beam 801C. The second collimated light beam 801C is received into the optical coupling interface 655 for conveyance into the optical fiber(s) 915. In various embodiments, reflections of light beams between the optical coupling interface 655 for the optical fiber(s) 915 and the optical coupling interface 653 for the PIC die/chip 903 is implemented by mirrors, reflective coatings, reflective material layers, lenses, and/or other optical components.

Various embodiments are disclosed herein for photonic systems that direct light from the PIC die/chip 903 into another optical path to enable conveyance of the light into the optical fiber 915 (or FAU) located on the opposite side of the support material 917 relative to the side of the support material 917 on which the PIC die/chip 903 is disposed, in order for the optical fiber 915 (or FAU) to receive the light at a location physically and thermally separated from the C4 bumps 907 associated with attachment of the PIC die/chip 903 to the substrate/interposer 921. In some embodiments, the optical coupling interface 653 for the PIC die/chip 903 is integrated within the PIC die/chip 903. In some embodiments, the optical coupling interface 653 for the PIC die/chip 903 is attached to the PIC die/chip 903. In some embodiments, the optical coupling interface 653 for the PIC die/chip 903 is integrated within the support material 917. In some embodiments, the optical coupling interface 653 for the PIC die/chip 903 is attached to the support material 917.

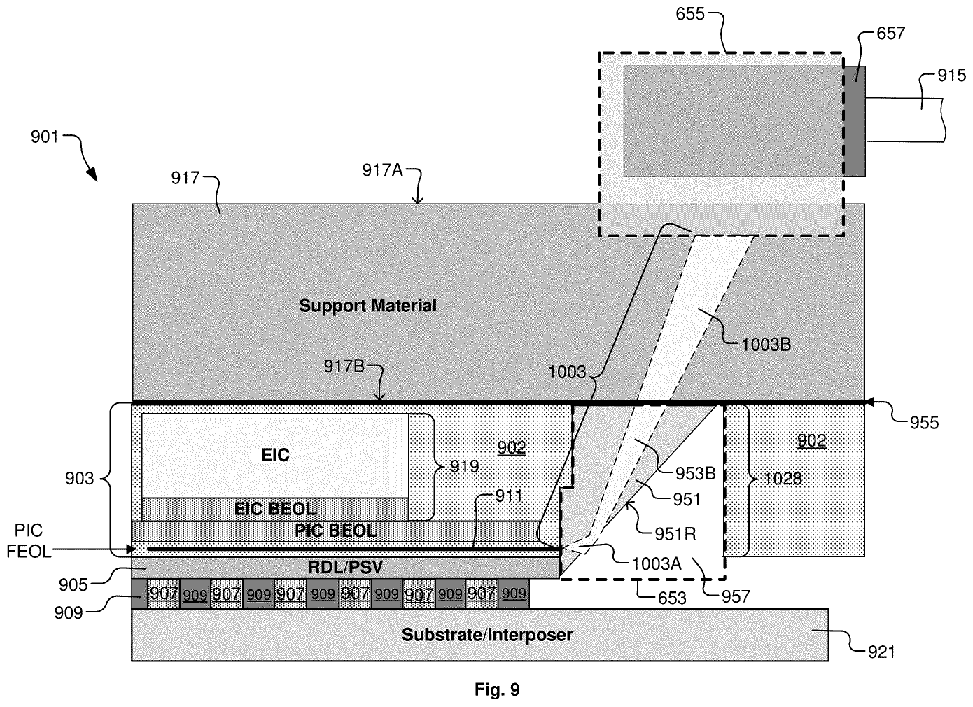

FIG. 9 shows a vertical cross-section through a heterogeneously integrated photonic system 901, in accordance with some embodiments. It should be understood that the various components of FIG. 9 are shown schematically at sizes that are not to scale relative to one another in order to facilitate illustration of the various components. The heterogeneously integrated photonic system 901 includes the PIC die/chip 903 that includes the optical coupling interface 653 configured to direct light from one or more waveguide(s) 911 within the PIC die/chip 903 through the support material 917 on which the PIC die/chip 903 is disposed to the optical coupling interface 655 for one or more optical fiber(s) 915, where the optical coupling interface 655 is disposed on the surface 917A of the support material 917 opposite from the surface 917B of the support material 917 on which the PIC die/chip 903 is disposed. In some embodiments, the support material layer 917 is a substrate layer or a carrier wafer on which the EIC die/chip 919 and the PIC die/chip 903 are collectively disposed and supported. In some embodiments, the support material layer 917 is formed of silicon. In various embodiments, the support material layer 917 is substantially transparent to a light beam 1003 that is transmitted from the PID die/chip 903 through the support material 917 to the optical fiber 915, vice-versa.

The PIC die/chip 903 includes photonic components, electronic components, and electro-optical components. The EIC die/chip 919 is flip-chip connected to the PIC die/chip 903. In some embodiments, the EIC die/chip 919 is disposed on a top surface of the PIC die/chip 903. In some of these embodiments, the EIC die/chip 919 is turned upside down and is flip-chip connected to the PIC die/chip 903, such that exposed electrical connections of a BEOL portion of the PIC die/chip 903 are electrically connected to exposed electrical connections of a BEOL portion of the EIC die-chip 919. In some embodiments, with the EIC die/chip 919 flip-chip connected to the PIC die/chip 903, and with a silicon handle of the PIC die/chip 903 thinned or removed, the PIC die/chip 903 is disposed on the RDL 905. In some embodiments, electrical connections are routed between the RDL 905 located below the PIC die/chip 903 and the EIC die/chip 919 located above the PIC die/chip 903. In various embodiments, routing of electrical connections between the RDL 905 and the EIC die/chip 919 is accomplished using electrically conductive via structures that extend through the PIC die/chip 903, including through the a bottom oxide layer or silicon handle of the PIC die/chip 903. In some embodiments, the RDL 905 is electrically and physically connected to the substrate/interposer 921 by the C4 bumps 907. In some embodiments, the underfill mold material 909 is disposed around the C4 bumps 907 between the RDL 905 and the substrate/interposer 921 to which the C4 bumps 907 are connected.

The PIC die/chip 903 includes at least one waveguide 911 that is configured and optically connected to convey light (optical signals) to and/or from the PIC die/chip 903. In some embodiments, the waveguide(s) 911 and various photonic devices and/or electro-optic devices are implemented within the FEOL portion of the PIC die/chip 903. The waveguide(s) 911 are optically connected to one or more optical fiber(s) 915 through the optical coupling interface 653 within the PIC die/chip 903 and the optical coupling interface 655 on the surface 917A of the support material 917. In this manner, light (optical signals) is conveyed from the waveguide(s) 911 into the optical fiber(s) 915 and/or from the optical fiber(s) 915 into the waveguide(s) 911. In some embodiments, the optical coupling interface 655 is equipped with a mechanical socket or v-groove or channel or other device to facilitate securing and alignment of the optical fiber(s) 915 to the optical coupling interface 655.

The optical coupling interface 653 within the PIC die/chip 903 includes an optical reflector structure 951 formed/disposed within a cavity 1028 formed within an oxide stack 902 (e.g., fill oxide) of the PIC die/chip 103. The optical coupling interface 653 within the PIC die/chip 903 includes an optical reflector structure 951 configured to direct a first portion 1003A of a light beam 1003 emanating from the waveguide(s) 911 into a second portion 1003B of the light beam 1003 that passes through a body of the optical reflector structure 951 and through the support material 917 to the optical coupling interface 655 for the optical fiber(s) 915 to enable conveyance of the light beam 1003 into to the optical fiber(s) 915. In some embodiments, an anti-reflective coating 955 is disposed between the support material 917 and optical reflector structure 951 within the PIC die/chip 903 to facilitate optical conveyance of the light beam 1003 from the optical reflector structure 951 into the support material 917. In the example of FIG. 9, the first portion 1003A of the light beam 1003 is projected from the optical waveguide 911 through the optical reflector structure 951 and onto an angular surface 951R of the optical reflector structure 951. The angular surface 951R of the optical reflector structure 951 functions as a mirror to reflect the first portion 1003A of the light beam 1003 back through the body of the optical reflector structure 951 as the second portion 1003B of the light beam 1003 that travels toward the support material 917 and through the support material 917 to the optical coupling interface 655. In some embodiments, the angular surface 951R is a boundary between the optical reflector structure 951 and an open space 957. In some embodiments, the first portion 1003A of the light beam 1003 has a divergent configuration as it travels from the waveguide 911 through the optical reflector structure 951 to the angular surface 951R, such as shown in FIG. 9. Also, in some embodiments, the second portion 1003B of the light beam 1003 has a divergent configuration as it travels from the angular surface 951R of the optical reflector structure 951 toward the support material 917 and onward toward the optical coupling interface 655 for the optical fiber(s) 915, such as shown in FIG. 9. It should be understood that the direction of travel of the light beam 1003 can also be reversed, such that the light beam 1003 travels from the optical fiber 915, through the optical coupling interface 655, through the support material 917, through the optical reflector structure 951, and reflects off of the angular surface 951R of the optical reflector structure 951 toward the optical waveguide 911 or associated optical port/facet of the PIC die/chip 903. It should be noted that the combination of the optical coupling interface 653 within the PIC die/chip 903 and the optical coupling interface 655 on the surface 917A of the support material 917 opposite from surface 917B of the support material 917 on which the PIC die/chip 903 is disposed provides for implementation of the heterogeneously integrated photonic system 901 without having a KOZ within the PIC die/chip 903 or a cut-out region within the substrate/interposer 921.

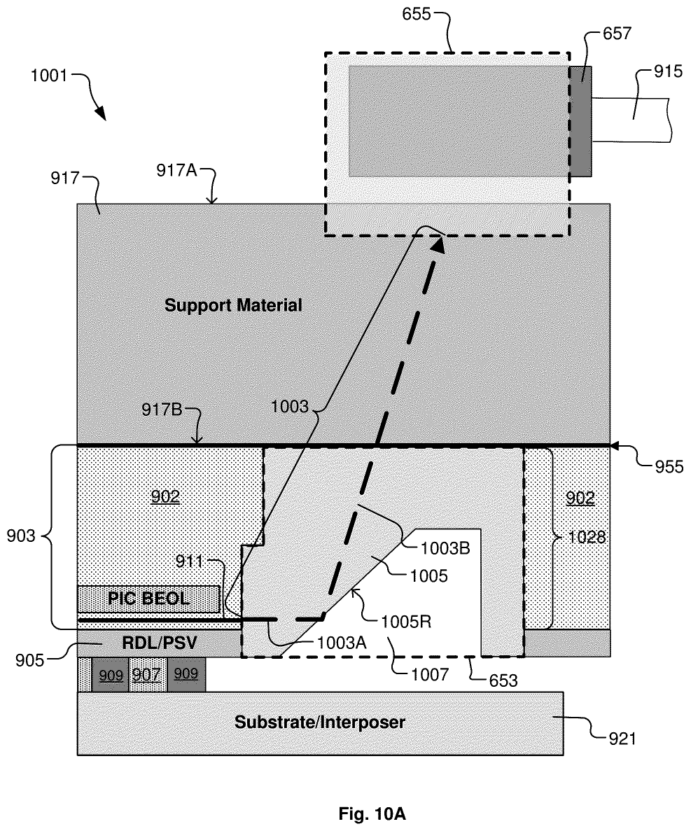

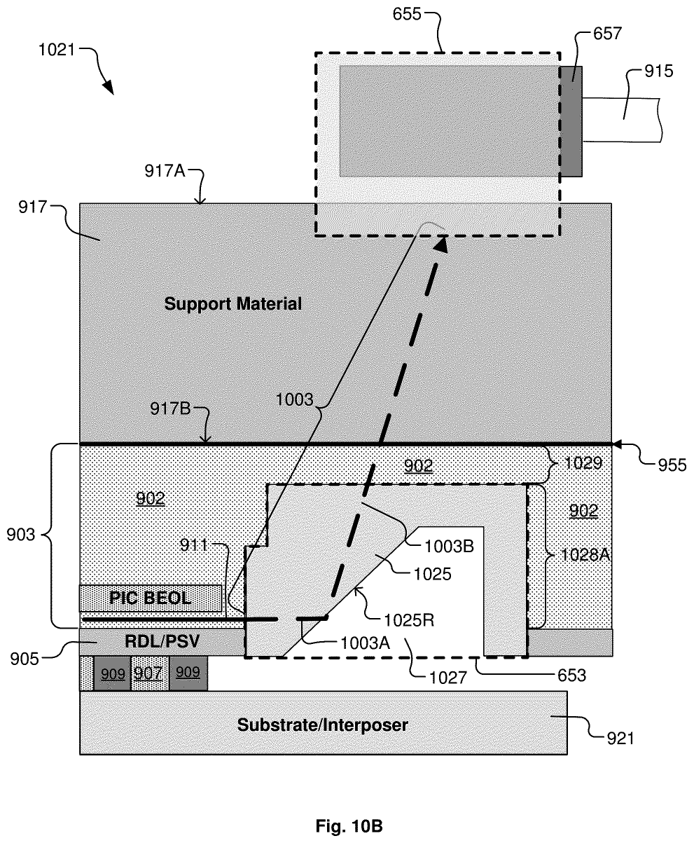

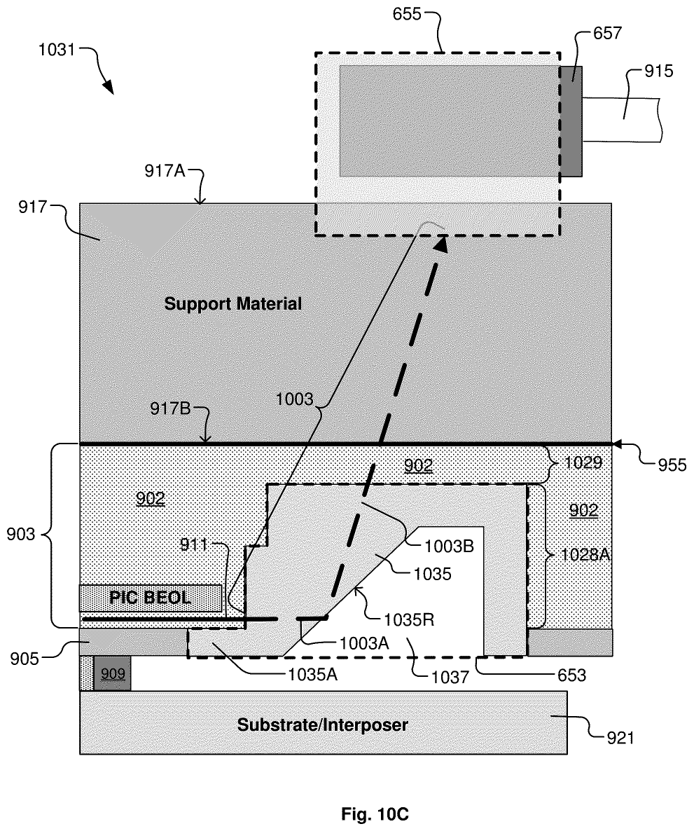

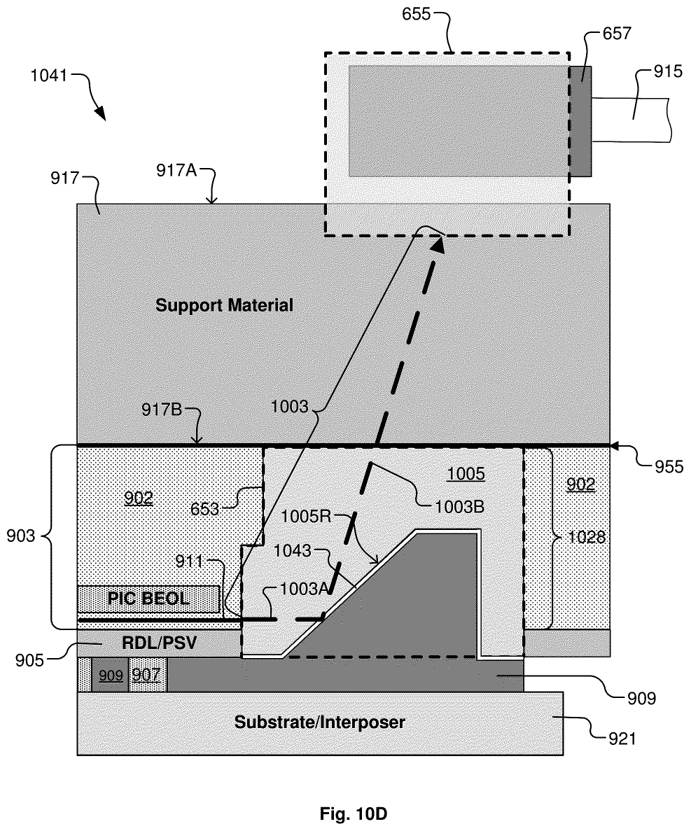

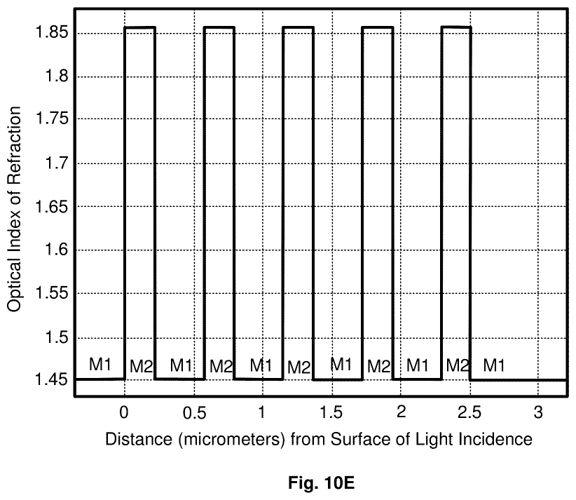

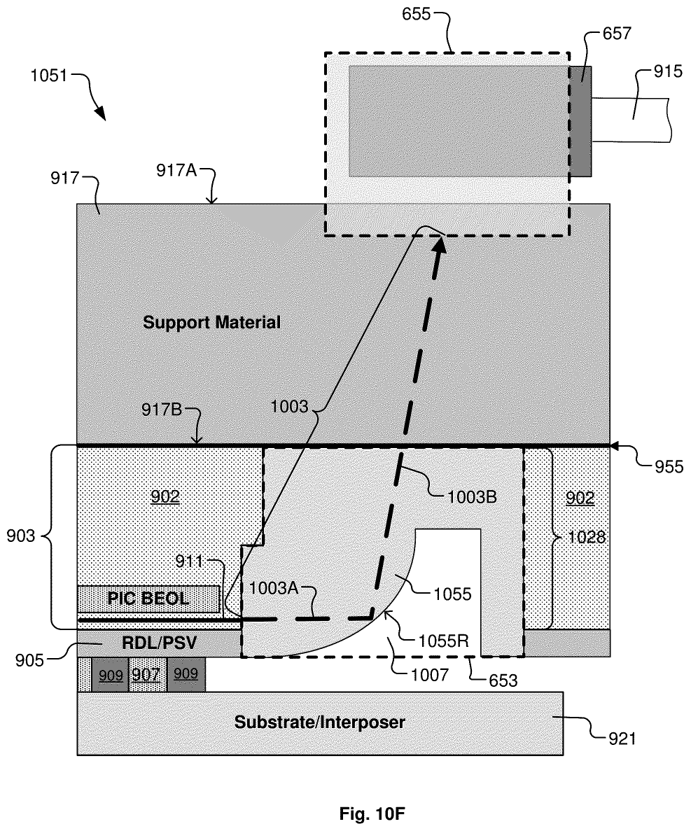

FIG. 10A shows a vertical cross-section through a photonic system 1001, in accordance with some embodiments. It should be understood that the various components of FIG. 10A are shown schematically at sizes that are not to scale relative to one another in order to facilitate illustration of the various components. The photonic system 1001 includes the PIC die/chip 903, the optical coupling interface 653 within the PIC die/chip 903, the support material 917, the optical coupling interface 655 for the optical fiber 915, the anti-reflective coating 955, the substrate/interposer 921, the C4 bumps 907, and the mold material 909, as described with regard to FIG. 9. The optical coupling interface 653 within the PIC die/chip 903 includes an optical reflector structure 1005 that is formed/disposed within the cavity 1028 formed within the oxide stack 902 of the PIC die/chip 903. The optical coupling interface 653 within the PIC die/chip 903 includes an optical reflector structure 1005 configured to direct the first portion 1003A of the light beam 1003 emanating from the waveguide(s) 911 into the second portion 1003B of the light beam 1003 that passes through the body of the optical reflector structure 1005 and through the support material 917 to the optical coupling interface 655 for the optical fiber(s) 915 to enable conveyance of the light beam 1003 into to the optical fiber(s) 915. In some embodiments, the anti-reflective coating 955 is disposed between the support material 917 and optical reflector structure 1005 within the PIC die/chip 903 to facilitate optical conveyance of the light beam 1003 from the optical reflector structure 1005 into the support material 917.

In the example of FIG. 10A, the first portion 1003A of the light beam 1003 is projected from the optical waveguide 911 through the optical reflector structure 1005 and onto an angular surface 1005R of the optical reflector structure 1005. The angular surface 1005R of the optical reflector structure 1005 functions to reflect the first portion 1003A of a light beam 1003 back through the body of the optical reflector structure 1005 as the second portion 1003B of the light beam 1003 that travels toward the support material 917 and through the support material 917 to the optical coupling interface 655. In some embodiments, the angular surface 1005R is a boundary between the optical reflector structure 1005 and an open space 1007. In some embodiments, the angular surface 1005R of the optical reflector structure 1005 is configured to function as a mirror to direct light from the PIC die/chip 903 into another optical path through the support material 917 to enable conveyance of the light to the optical fiber 915 located on the opposite side of the support material 917 from where the PIC die/chip 903 is located. In some embodiments, the optical reflector structure 1005 is formed by a transparent resin or epoxy disposed within an opening formed in the oxide stack 902 of the PIC die/chip 903. In some embodiments, the optical reflector structure 1005 is formed using imprint lithography, etching, and/or grayscale lithography, among others. In some embodiments, the transparent medium (material) of the optical reflector structure 1005 has an optical index substantially close to the optical index of the oxide stack 902 material of the PIC die/chip 903 so as to minimize reflections of the light beam 1003. It should be understood that the direction of travel of the light beam 1003 can also be reversed, such that the light beam 1003 travels from the optical fiber 915, through the optical coupling interface 655, through the support material 917, through the optical reflector structure 1005, and reflects off of the angular surface 1005R of the optical reflector structure 1005 toward the optical waveguide 911 or associated optical port/facet of the PIC die/chip 903.

FIG. 10B shows a vertical cross-section through a photonic system 1021, in accordance with some embodiments. It should be understood that the various components of FIG. 10B are shown schematically at sizes that are not to scale relative to one another in order to facilitate illustration of the various components. The photonic system 1021 of FIG. 10B is a variation of the photonic system 1001 of FIG. 10A. Specifically, in the photonic system 1021 of FIG. 10B, the optical reflector structure 1005 of the photonic system 1001 of FIG. 10A is replaced by an optical reflector structure 1025 that is formed/disposed within a cavity 1028A formed within the oxide stack 902 material of the PIC die/chip 903. The cavity 1028A is formed to extend vertically through less than a full thickness of the oxide stack 902 of the PIC die/chip 903, such that a portion 1029 of the oxide stack 902 of the PIC die/chip 903 exists between the optical reflector structure 1025 and the support material 917, when the optical reflector structure 1025 is formed/disposed within the cavity 1028A. Therefore, the portion 1029 of the oxide stack 902 material of the PIC die/chip 903 remains in the optical path between the optical reflector structure 1025 and the support material 917 for the PIC die/chip. In this manner, the optical reflector structure 1025 is configured to direct the first portion 1003A of the light beam 1003 emanating from the waveguide(s) 911 into the second portion 1003B of the light beam 1003 that passes through the body of the optical reflector structure 1025 and through the portion 1029 of the oxide stack 902 of the PIC die/chip 903 and through the support material 917 to the optical coupling interface 655 for the optical fiber(s) 915 to enable conveyance of the light beam 1003 into to the optical fiber(s) 915. The optical index of the optical reflector structure 1025 is sufficiently close to the optical index of the oxide stack 902 material of the PIC die/chip 903, so as to avoid adverse reflections of the light beam 1003 as the light beam 1003 traverses the interface between the optical reflector structure 1025 and the oxide stack 902 material of the PIC die/chip 903. In some embodiments, the anti-reflective coating 955 is disposed between the support material 917 and the portion 1029 of the oxide stack 902 material of the PIC die/chip 903 to facilitate optical conveyance of the light beam 1003 into the support material 917. Also, in some embodiments, the anti-reflective coating 955 is disposed between the portion 1029 of the oxide stack 902 material of the PIC die/chip 903 and the optical reflector structure 1025 to facilitate optical conveyance of the light beam 1003 into the oxide stack 902 material of the PIC die/chip 903.

In the example of FIG. 10B, the first portion 1003A of the light beam 1003 is projected from the optical waveguide 911 through the optical reflector structure 1025 and onto an angular surface 1025R of the optical reflector structure 1025. The angular surface 1025R of the optical reflector structure 1025 functions to reflect the first portion 1003A of a light beam 1003 back through the body of the optical reflector structure 1025 as the second portion 1003B of the light beam 1003 that travels toward the support material 917. In some embodiments, the angular surface 1025R is a boundary between the optical reflector structure 1025 and an open space 1027. In some embodiments, the angular surface 1025R of the optical reflector structure 1025 is configured to function as a mirror to direct light from the PIC die/chip 903 into another optical path through the portion 1029 of the oxide stack 902 material of the PIC die/chip 903 and through the support material 917 to enable conveyance of the light to the optical fiber 915 located on the opposite side of the support material 917 from where the PIC die/chip 903 is located. In some embodiments, the optical reflector structure 1025 is formed by a transparent resin or epoxy disposed within an opening formed in the oxide stack 902 of the PIC die/chip 903. In some embodiments, the optical reflector structure 1025 is formed using imprint lithography, etching, and/or grayscale lithography, among others. It should be understood that the direction of travel of the light beam 1003 can also be reversed, such that the light beam 1003 travels from the optical fiber 915, through the optical coupling interface 655, through the support material 917, through the portion 1029 of the oxide stack 902 material of the PIC die/chip 903, through the optical reflector structure 1025, and reflects off of the angular surface 1025R of the optical reflector structure 1025 toward the optical waveguide 911 or associated optical port/facet of the PIC die/chip 903.

FIG. 10C shows a vertical cross-section through a photonic system 1031, in accordance with some embodiments. It should be understood that the various components of FIG. 10C are shown schematically at sizes that are not to scale relative to one another in order to facilitate illustration of the various components. The photonic system 1031 of FIG. 10C is a variation of the photonic system 1021 of FIG. 10B. Specifically, in the photonic system 1031 of FIG. 10C, the optical reflector structure 1025 of the photonic system 1021 of FIG. 10B is replaced by an optical reflector structure 1035. The optical reflector structure 1035 is like the optical reflector structure 1025, with the optical reflector structure 1035 having an extension portion 1035A that extends under a portion of the PIC die/chip 903. In some embodiments, the extension portion 1035A of the optical reflector structure 1035 extends to a peripheral edge of the RDL 905. Also, the extension portion 1035A of the optical reflector structure 1035 is configured to extend along a portion of the PIC die/chip 903 through which the waveguide(s) 911 travels to reach their associated optical ports/facets at the vertical surface of the PIC die/chip 903 within the cavity 1028A in which the optical reflector structure 1035 is formed/disposed.

In some embodiments, a transparent medium (material) of the extension portion 1035A of the optical reflector structure 1035 functions to increase the mode field diameter (MFD) of the PIC die/chip 903. In the example of FIG. 10C, the first portion 1003A of the light beam 1003 is projected from the optical waveguide 911 through the optical reflector structure 1035 and onto an angular surface 1035R of the optical reflector structure 1035. The angular surface 1035R of the optical reflector structure 1035 functions to reflect the first portion 1003A of a light beam 1003 back through the body of the optical reflector structure 1035 as the second portion 1003B of the light beam 1003 that travels toward the support material 917. In some embodiments, an increase the MFD of the PIC die/chip 903 improves optical coupling between the waveguide(s) 911 within the PIC die/chip 903 and the optical reflector structure 1035. In some embodiments, an increase of the MFD of the PIC die/chip 903 improves a shape and/or size of the first portion 1003A of the light beam 1003 that is conveyed from the PIC die/chip 903 into the optical reflector structure 1035.

In some embodiments, the angular surface 1035R is a boundary between the optical reflector structure 1035 and an open space 1037. In some embodiments, the angular surface 1035R of the optical reflector structure 1035 is configured to function as a mirror to direct light from the PIC die/chip 903 into another optical path through the portion 1029 of the oxide stack 902 material of the PIC die/chip 903 and through the support material 917 to enable conveyance of the light to the optical fiber 915 located on the opposite side of the support material 917 from where the PIC die/chip 903 is located. In some embodiments, the optical reflector structure 1035 is formed by a transparent resin or epoxy disposed within the cavity 1028A formed in the oxide stack 902 of the PIC die/chip 903. In some embodiments, the optical reflector structure 1035 is formed using imprint lithography, etching, and/or grayscale lithography, among others. It should be understood that the direction of travel of the light beam 1003 can also be reversed, such that the light beam 1003 travels from the optical fiber 915, through the optical coupling interface 655, through the support material 917, through the portion 1029 of the oxide stack 902 material of the PIC die/chip 903, through the optical reflector structure 1035, and reflects off of the angular surface 1035R of the optical reflector structure 1035 toward the optical waveguide 911 or associated optical port/facet of the PIC die/chip 903.

FIG. 10D shows a vertical cross-section through a photonic system 1041, in accordance with some embodiments. It should be understood that the various components of FIG. 10D are shown schematically at sizes that are not to scale relative to one another in order to facilitate illustration of the various components. The photonic system 1041 of FIG. 10D is a variation of the photonic system 1001 of FIG. 10A. Specifically, in the photonic system 1041 of FIG. 10D, the optical reflector structure 1005 of the photonic system 1001 of FIG. 10A includes a mirror structure 1043 disposed on the angular surface 1005R of the optical reflector structure 1005. In some embodiments, the mirror structure 1043 is disposed on substantially all of an exposed surface of the optical reflector structure 1005 at the side of the PIC die/chip 903 that is located opposite from the support material 917. In some embodiments, the mirror structure 1043 is formed as a metal film. In some embodiments, the mirror structure 1043 is formed as a thin film stack. In some embodiments, the mirror structure 1043 is formed by coating one or more optically reflective materials onto the optical reflector structure 1005.

In various embodiments disclosed herein, the thin film stack that functions as a mirror is formed by stacking two or more layers of different materials in an alternating sequence, where each of the two of more layers of different materials has a different optical index of refraction. For example, FIG. 10E shows an example thin film stack configuration that can be used to form the mirror structure 1043, in accordance with some embodiments. The example thin film stack of FIG. 10E shows alternating layers of a first material M1 having an optical index of refraction of about 1.45 and a second material M2 having an optical index of refraction of about 1.86. It should be appreciated that the thin film stack configuration of FIG. 10E is shown by way of example. In the various embodiments disclosed herein, any referenced thin film stack can be formed by layering of essentially any combination of optically reflecting materials to achieve a desired optical reflectivity.

In some embodiments, the mirror structure 1043 is configured to decouple the reflection of the light beam 1003 from the particular angular orientation of the angular surface 1005R of the optical reflector structure 1005. More specifically, in some embodiments, the configuration and orientation of the mirror structure 1043 is controlled to achieve a particular angular reflection of the first portion 1003A of the light beam 1003 into the second portion 1003B of the light beam 1003, without strong dependence on the configuration and orientation of the underlying angular surface 1005R of the optical reflector structure 1005. In this manner, in some embodiments, the mirror structure 1043 creates an optical reflection of the light beam 1003 that is independent of an angled surface of the oxide stack 902 of the PIC die/chip 903 and/or the angled surface 1005R of the optical reflector structure 1005. Also, in some embodiments, the mirror structure 1043 functions to optically decouple reflection of the light beam 1003 from a material present outside of the optical reflector structure 1005, i.e., on a backside of the mirror structure 1043 that is opposite from a frontside of the mirror structure 1043 on which the first portion 1003A of the light beam 1003 is incident. Therefore, in some embodiments, the mold material 909 is disposed outside of the optical reflector structure 1005 on the backside of the mirror structure 1043. In some embodiments, the mold material 909 is disposed outside of the optical reflector structure 1005 on the backside of the mirror structure 1043 within a region between the optical reflector structure 1005 and a portion of the substrate/interposer 921 that extends under the optical reflector structure 1005. In some embodiments, disposal of the mold material 909 between the optical reflector structure 1005 and the substrate/interposer 921 serves to assist with mechanical stabilization of the PIC die/chip 903 on the substrate/interposer 921.

In some embodiments, the first portion 1003A of the light beam 1003 diverges as it propagates from the PIC die/chip 903 to the optical reflecting surface within the optical coupling interface 653. This divergence of the first portion 1003A of the light beam 1003 can be significant, particularly for small MFD's at the optical ports/facets of the PIC die/chip 903. In some embodiments, this divergence necessitates implementation of large micro-lenses in association with the waveguides 911 and/or associated optical ports/facets of the PIC die/chip 903, which in turn limits the pitch at which the micro-lenses can be placed. One solution to the issue of having small MFD's at the waveguides 911 and/or associated optical ports/facets of the PIC die/chip 903 is to thin down of the wafer on which the PIC die/chip 903 is fabricated. Alternatively, in some embodiments, the optical coupling interface 653 implements a curved reflective surface to provide combined optical reflection and optical collimation of the light beam 1003, which alleviates the need for disposing micro-lenses in association with the waveguides 911 and/or associated optical ports/facets of the PIC die/chip 903 in order to correct for optical divergence of the light beam 1003.

FIG. 10F shows a vertical cross-section through a photonic system 1051, in accordance with some embodiments. It should be understood that the various components of FIG. 10F are shown schematically at sizes that are not to scale relative to one another in order to facilitate illustration of the various components. The photonic system 1051 of FIG. 10F is a variation of the photonic system 1001 of FIG. 10A. Specifically, in the photonic system 1051 of FIG. 10F, the optical reflector structure 1005 of the photonic system 1001 of FIG. 10A is replaced by an optical reflector structure 1055 that implements a curved reflective surface 1055R.

The optical reflector structure 1055 is formed/disposed within the cavity 1028/1028A formed within the PIC die/chip 903. In some embodiments, such as shown in FIG. 10F, the cavity 1028 is formed to extend vertically through the full thickness of the oxide stack 902 of the PIC die/chip 903, such that the optical reflector structure 1055 interfaces with the support material 917. In some embodiments, the shallow cavity 1028A is formed to extend vertically through less than the full thickness of the oxide stack 902 of the PIC die/chip 903, such as shown in FIG. 10B, with the portion 1029 of the oxide stack 902 of the PIC die/chip 903 present between the optical reflector structure 1055 and the support material 917. The optical reflector structure 1055 is configured to direct the first portion 1003A of the light beam 1003 emanating from the waveguide(s) 911 into the second portion 1003B of the light beam 1003 that passes through the body of the optical reflector structure 1055 and through the support material 917 to the optical coupling interface 655 for the optical fiber(s) 915 to enable conveyance of the light beam 1003 into to the optical fiber(s) 915. In some embodiments, the anti-reflective coating 955 is disposed between the support material 917 and the optical reflector structure 1055 to facilitate optical conveyance of the light beam 1003 into the support material 917 from the optical reflector structure 1055.

In the example of FIG. 10F, the first portion 1003A of the light beam 1003 is projected from the optical waveguide 911 through the optical reflector structure 1055 and onto the curved reflecting surface 1055R of the optical reflector structure 1055. The curved reflecting surface 1055R of the optical reflector structure 1055 functions to reflect the first portion 1003A of the light beam 1003 back through the body of the optical reflector structure 1055 as the second portion 1003B of the light beam 1003 that travels toward the support material 917. Also, the curved reflecting surface 1055R of the optical reflector structure 1055 functions to collimate the second portion 1003B of the light beam 1003 as it is reflected back through the body of the optical reflector structure 1055 toward the support material 917. In this manner, the curved reflecting surface 1055R provides combined optical reflection and optical collimation of the light beam 1003, which alleviates the need for disposing micro-lenses in association with the waveguides 911 and/or associated optical ports/facets of the PIC die/chip 903 in order to correct for optical divergence of the light beam 1003.

In some embodiments, the curved reflecting surface 1055R is a boundary between the optical reflector structure 1055 and an open space 1027. In some embodiments, the curved reflecting surface 1055R of the optical reflector structure 1055 is configured to function as a mirror to direct light from the PIC die/chip 903 into another optical path through the support material 917 to enable conveyance of the light to the optical fiber 915 located on the opposite side of the support material 917 from where the PIC die/chip 903 is located. In some embodiments, the optical reflector structure 1055 is formed by a transparent resin or epoxy disposed within the cavity 1028/1028A formed in the oxide stack 902 of the PIC die/chip 903. In some embodiments, the optical reflector structure 1055 is formed using imprint lithography, etching, and/or grayscale lithography, among others. It should be understood that the direction of travel of the light beam 1003 can also be reversed, such that the light beam 1003 travels from the optical fiber 915, through the optical coupling interface 655, through the support material 917, through the optical reflector structure 1055, and reflects off of the curved reflecting surface 1055R of the optical reflector structure 1055 toward the optical waveguide 911 or associated optical port/facet of the PIC die/chip 903.

In some embodiments, the optical coupling interface 653 for the PIC die/chip 903 is configured to implement both optical reflection and optical lensing functionality. In some embodiments, a multi-pass optical path between the optical coupling interface 653 for the PIC die/chip 903 and the optical coupling interface 655 of the optical fiber 915 is used in conjunction with both an optical reflecting element and an optical lensing element of the optical coupling interface 653 to provide for conveyance of the light beam 1003 from the PIC die/chip 903 to the optical fiber 915, and vice-versa. In various embodiments, the optical coupling interface 653 for the PIC die/chip 903 includes two or more optical elements to provide the necessary optical reflection and lensing to ensure that the light beam 1003 is conveyed from the PIC die/chip 903 to the optical fiber 915, and vice-versa.

In some embodiments, a mirror structure is disposed on the curved reflecting surface 1055R of the optical reflector structure 1055. In some embodiments, the mirror structure is disposed on substantially all of an exposed surface of the optical reflector structure 1055 at the side of the PIC die/chip 903 that is located opposite from the support material 917. In some embodiments, the mirror structure is formed as a metal film. In some embodiments, the mirror structure is formed as a thin film stack. In some embodiments, the mirror structure is formed by coating one or more optically reflective materials onto the optical reflector structure 1055. In some embodiments, with the mirror structure disposed on the curved reflecting surface 1055R of the optical reflector structure 1055, the region between the optical reflector structure 1055 and the substrate/interposer 921 (or at least a portion thereof) is filled with the mold material 909, which serves to assist with mechanical stabilization of the PIC die/chip 903 on the substrate/interposer 921.

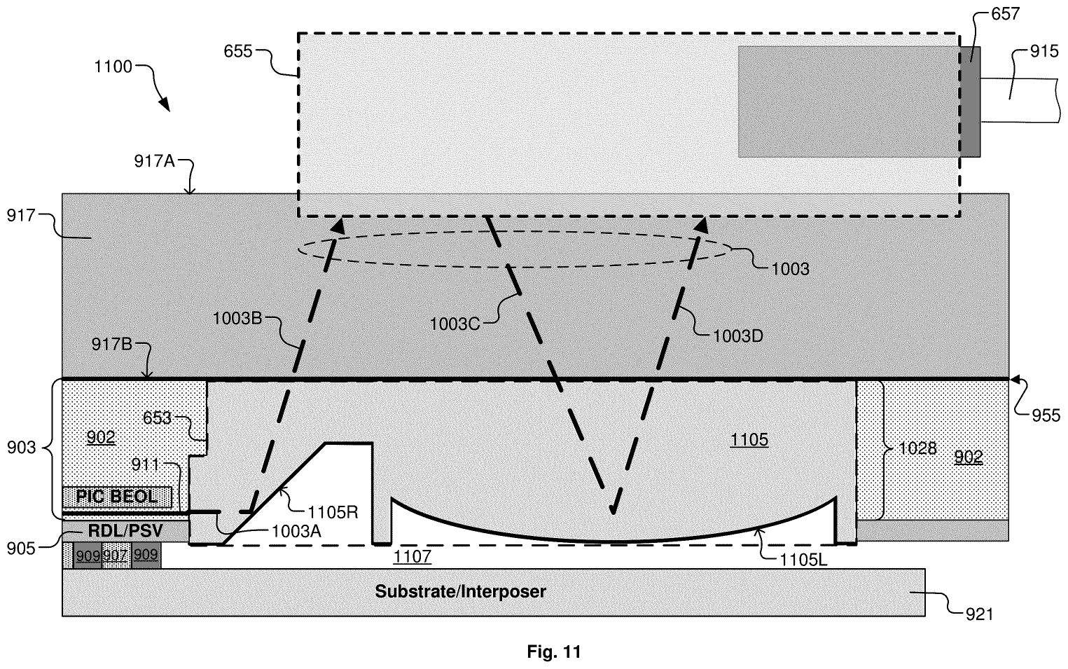

FIG. 11 shows a vertical cross-section through a photonic system 1100, in accordance with some embodiments. It should be understood that the various components of FIG. 11 are shown schematically at sizes that are not to scale relative to one another in order to facilitate illustration of the various components. The photonic system 1100 of FIG. 11 is a variation of the photonic system 1100 of FIG. 10A. Specifically, in the photonic system 1100 of FIG. 11, the optical reflector structure 1005 of the photonic system 1001 of FIG. 10A is replaced by an optical reflector structure 1105 that implements both an angular reflecting surface 1105R and a lensing surface 1105L that are spatially separated from each other within the optical reflector structure 1105.

The optical reflector structure 1105 is formed/disposed within the cavity 1028/1028A formed within the PIC die/chip 903. In some embodiments, such as shown in FIG. 11, the cavity 1028 is formed to extend vertically through the full thickness of the oxide stack 902 of the PIC die/chip 903, such that the optical reflector structure 1105 interfaces with the support material 917. In some embodiments, the shallow cavity 1028A is formed to extend vertically through less than the full thickness of the oxide stack 902 of the PIC die/chip 903, such as shown in FIG. 10B, with the portion 1029 of the oxide stack 902 of the PIC die/chip 903 present between the optical reflector structure 1105 and the support material 917. The angular reflecting surface 1105R of the optical reflector structure 1105 is configured to direct the first portion 1003A of the light beam 1003 emanating from the waveguide(s) 911 into the second portion 1003B of the light beam 1003 that passes through the body of the optical reflector structure 1105 and through the support material 917 to the optical coupling interface 655 for the optical fiber(s) 915. The optical coupling interface 655 for the optical fiber(s) 915 is configured to reflect the second portion 1003B of the light beam 1003 into a third portion 1003C of the light beam 1003, such that the third portion 1003C of the light beam 1003 travels back through the support material 917 and through the body of the optical reflector structure 1105 to the lensing surface 1105L of the optical reflector structure 1105. The lensing surface 1105L of the optical reflector structure 1105 is configured to reflect the third portion 1003C of the light beam 1003 into a fourth portion 1003D of the light beam 1003, such that the fourth portion 1003D of the light beam 1003 travels back through the body of the optical reflector structure 1105 and through the support material 917 to the optical coupling interface 655 for conveyance into the optical fiber(s) 915. In some embodiments, the anti-reflective coating 955 is disposed between the support material 917 and the optical reflector structure 1105 to facilitate optical conveyance of the light beam 1003 into the support material 917 from the optical reflector structure 1105. In some embodiments, the lensing surface 1105L of the optical reflector structure 1105 is configured to focus the fourth portion 1003D of the light beam 1003 that is reflected back toward the support material 917. In some embodiments, the lensing surface 1105L of the optical reflector structure 1105 is configured to collimate the fourth portion 1003D of the light beam 1003 that is reflected back toward the support material 917. In some embodiments, the lensing surface 1105L of the optical reflector structure 1105 is configured to both focus and collimate the fourth portion 1003D of the light beam 1003 that is reflected back toward the support material 917.

In some embodiments, each of the angular reflecting surface 1105R and the lensing surface 1105L is a boundary between the optical reflector structure 1105 and an open space 1107. In some embodiments, the mold material 909 is disposed between the angular reflecting surface 1105R and/or the lensing surface 1105L of the optical reflector structure 1105 and the substrate/interposer 921. The angular reflecting surface 1105R and the lensing surface 1105L of the optical reflector structure 1105 are collectively configured to work with the optical coupling interface 655 for the optical fiber(s) 915 to provide for conveyance of the light beam 1003 from the PIC die/chip 903 to the optical fiber(s) 915 located on the opposite side of the support material 917 from where the PIC die/chip 903 is located, and vice-versa.

In some embodiments, the optical reflector structure 1105 is formed by a transparent resin or epoxy disposed within the cavity 1028/1028A formed in the oxide stack 902 of the PIC die/chip 903. In various embodiments, the optical reflector structure 1105 is formed using one or more semiconductor fabrication processes, such as imprint lithography, etching, and/or grayscale lithography, among others. It should be understood that the direction of travel of the light beam 1003 can also be reversed, such that the light beam 1003 travels from the optical fiber 915, through the optical coupling interface 655, through the support material 917 and the optical reflector structure 1105 in multiple passes, and reflects off of the angled reflecting surface 1105R of the optical reflector structure 1105 toward the optical waveguide 911 or associated optical port/facet of the PIC die/chip 903.

In some embodiments, a mirror structure is disposed on one or both of the angular reflecting surface 1105R and the lensing surface 1105L of the optical reflector structure 1105. In some embodiments, the mirror structure is disposed on substantially all of an exposed surface of the optical reflector structure 1105 at the side of the PIC die/chip 903 that is located opposite from the support material 917. In some embodiments, the mirror structure is formed as a metal film. In some embodiments, the mirror structure is formed as a thin film stack. In some embodiments, the mirror structure is formed by coating one or more optically reflective materials onto the optical reflector structure 1105. In some embodiments, with the mirror structure is disposed on one or both of the angular reflecting surface 1105R and the lensing surface 1105L of the optical reflector structure 1105, the region between the optical reflector structure 1105 and the substrate/interposer 921 (or at least a portion thereof) is filled with the mold material 909, which serves to assist with mechanical stabilization of the PIC die/chip 903 on the substrate/interposer 921.

In various embodiments, a photonic system (e.g., 601, 901, 1001, 1021, 1031, 1041, 1051, 1100) includes the support material 917 having a first surface 917A (top surface) and a second surface 917B (bottom surface). The second surface 917B of the support material 917 is opposite from the first surface 917A of the support material 917 relative to an overall thickness of the support material 917. The optical coupling interface 655 for the optical fiber 915 is disposed on the first surface 917A of the support material 917. The PIC die/chip 903 is disposed on the second surface 917B of the support material 917. An optical reflector structure (e.g., 653, 951, 1005, 1025, 1035, 1043, 1055, 1105) is disposed within the PIC die/chip 903. The optical reflector structure is configured to receive the light beam 1003 from the optical waveguide 911 within the PIC die/chip 903 and turn the light beam 1003 toward the second surface 917B of the support material 917 and toward the optical coupling interface 655 for the optical fiber 915 disposed on the first surface 917A of the support material 917, such that the light beam 1003 travels from the optical waveguide 911 within the PCI die/chip 903 through the optical reflector structure in a first direction, and through the optical reflector structure in a second direction, and through the overall thickness of the support material 917 to reach the optical coupling interface 655 for the optical fiber 915.

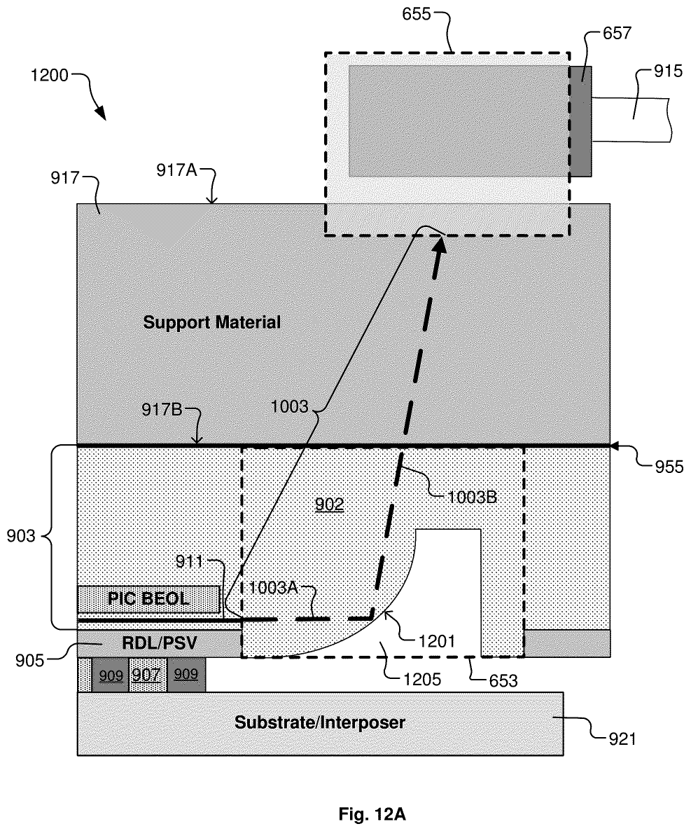

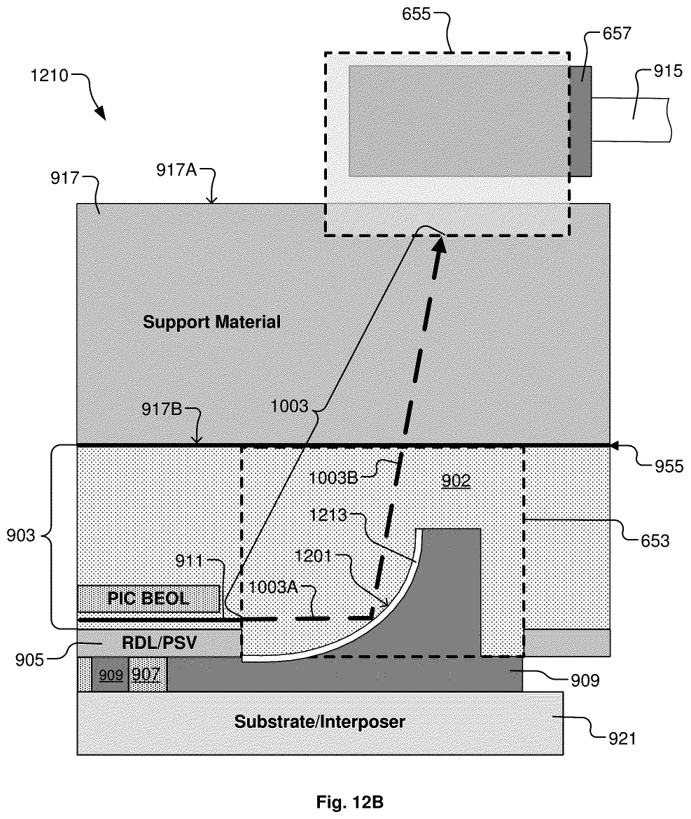

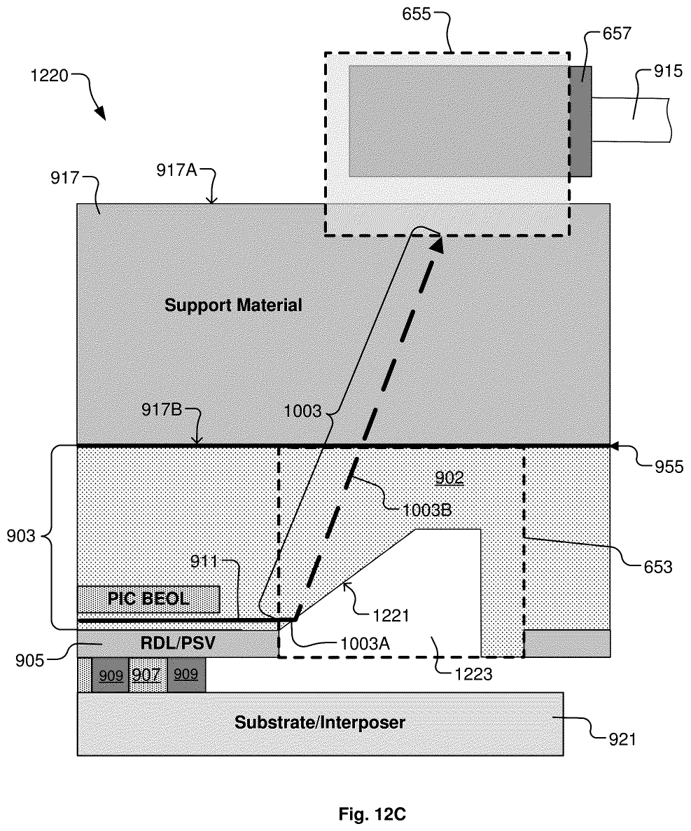

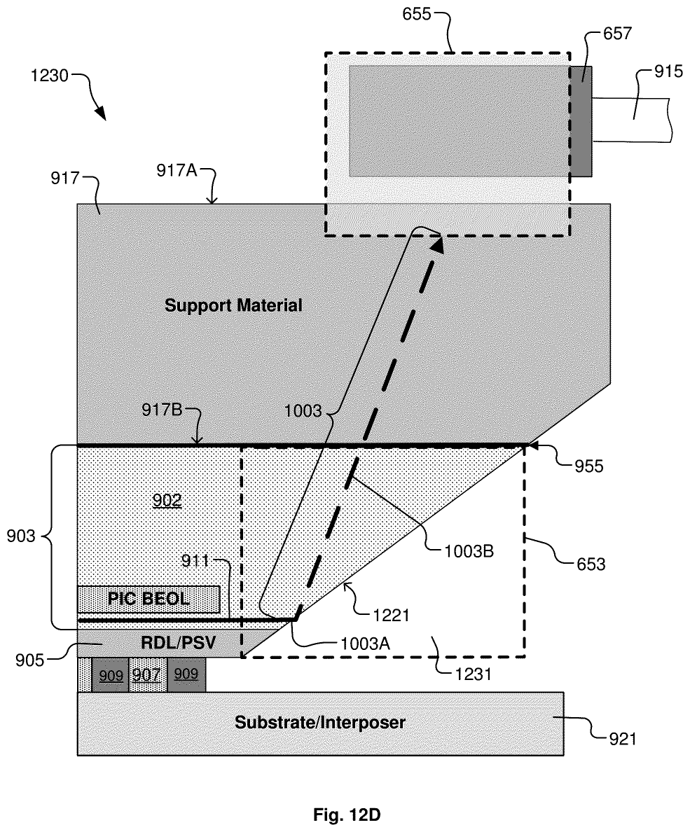

FIG. 12A shows a vertical cross-section through a photonic system 1200, in accordance with some embodiments. It should be understood that the various components of FIG. 12A are shown schematically at sizes that are not to scale relative to one another in order to facilitate illustration of the various components. The photonic system 1200 includes the PIC die/chip 903, the support material 917, the optical coupling interface 655 for the optical fiber 915, the anti-reflective coating 955, the substrate/interposer 921, the C4 bumps 907, and the mold material 909, as described with regard to FIG. 9. The photonic system 1200 also includes the optical coupling interface 653 formed within the PIC die/chip 903. More specifically, in the PIC die/chip 903, the optical coupling interface 653 is formed directly within the oxide stack 902 of the PIC die/chip 903. The optical coupling interface 653 is formed from the oxide stack 902 material of the PIC die/chip 903. In the photonic system 1200, the optical coupling interface 653 the oxide stack 902 material of the PIC die/chip 903 is formed to have a curved reflecting surface 1201.

The first portion 1003A of the light beam 1003 is projected from the optical waveguide 911 through a portion of the optical stack material of the PIC die/chip 903 within the optical coupling interface 653 and onto the curved reflecting surface 1201 of the optical stack material of the PIC die/chip 903 within the optical coupling interface 653. The curved reflecting surface 1201 functions to reflect the first portion 1003A of the light beam 1003 back through the optical stack material of the PIC die/chip 903 within the optical coupling interface 653 as the second portion 1003B of the light beam 1003 that travels toward the support material 917. Also, the curved reflecting surface 1201 functions to collimate the second portion 1003B of the light beam 1003 as it is reflected back through the optical stack material of the PIC die/chip 903 within the optical coupling interface 653 toward the support material 917. In this manner, the curved reflecting surface 1201 provides combined optical reflection and optical collimation of the light beam 1003, which alleviates the need for disposing micro-lenses in association with the optical waveguides 911 and/or associated optical ports/facets of the PIC die/chip 903 in order to correct for optical divergence of the light beam 1003. In some embodiments, a low optical index medium or a transparent medium is present within a region 1205 outside and next to the oxide stack 902 of the PIC die/chip 903 to provide for total internal reflection of the light beam 1003 off of the curved reflecting surface 1201. In some embodiments, the curved reflecting surface 1201 is a boundary between the exposed oxide stack 902 material of the PIC die/chip 903 and an open space within the region 1205. In various embodiments, the curved reflecting surface 1201 is formed using one or more semiconductor fabrication processes, such as imprint lithography, etching, and/or grayscale lithography, among others.

The second portion 1003B of the light beam 1003 travels through the optical stack material of the PIC die/chip 903 toward the support material 917 and through the support material 917 to the optical coupling interface 655 for the optical fiber(s) 915. The optical coupling interface 655 is configured to direct the light beam 1003 into the optical fiber(s) 915. In some embodiments, the anti-reflective coating 955 is disposed between the support material 917 and the PIC die/chip 903 to facilitate optical conveyance of the second portion 1003B of the light beam 1003 from the oxide stack 902 material of the PIC die/chip 903 into the support material 917.

It should be understood that the direction of travel of the light beam 1003 can also be reversed, such that the light beam 1003 travels from the optical fiber 915, through the optical coupling interface 655, through the support material 917, through the oxide stack 902 material of the PIC die/chip 903, and reflects off of the curved reflecting surface 1201 toward the optical waveguide 911 or associated optical port/facet of the PIC die/chip 903. In some implementations, the curved reflecting surface 1201 functions to direct light output from the PIC die/chip 903 into another optical path through the oxide stack 902 material of the PIC die/chip 903 and support material 917 to enable conveyance of the light to the optical fiber 915 located on the opposite side of the support material 917 from where the PIC die/chip 903 is located. In some implementations, the curved reflecting surface 1201 functions to direct incoming light toward the waveguide(s) 911 or associated ports/facets of the PIC die/chip 903, where the incoming light is conveyed from the optical fiber(s) 915 through the support material 917 and through the oxide stack 902 material of the PIC die/chip 903 to the curved reflecting surface 1201.

FIG. 12B shows a vertical cross-section through a photonic system 1210, in accordance with some embodiments. It should be understood that the various components of FIG. 12B are shown schematically at sizes that are not to scale relative to one another in order to facilitate illustration of the various components. The photonic system 1210 of FIG. 12B is a variation of the photonic system 1200 of FIG. 12A. Specifically, in the photonic system 1210 of FIG. 12B, the optical coupling interface 653 of PIC die/chip 903 includes a mirror structure 1213 disposed on the curved reflecting surface 1201. In some embodiments, the mirror structure 1213 is disposed on substantially all of an exposed surface of the oxide stack 902 material of the PIC die/chip 903 within the optical coupling interface 653 of the PIC die/chip 903. In some embodiments, the mirror structure 1213 is formed as a metal film. In some embodiments, the mirror structure 1213 is formed as a thin film stack. In some embodiments, the mirror structure 1213 is formed by coating one or more optically reflective materials onto the exposed surface of the oxide stack 902 material of the PIC die/chip 903 within the optical coupling interface 653 of the PIC die/chip 903. In some embodiments, with the mirror structure 1213 disposed on the curved reflecting surface 1201 of the oxide stack 902 material of the PIC die/chip 903, the region between the optical coupling interface 653 of the PIC die/chip 903 and the substrate/interposer 921 (or at least a portion thereof) is filled with the mold material 909, which serves to assist with mechanical stabilization of the PIC die/chip 903 on the substrate/interposer 921.

FIG. 12C shows a vertical cross-section through a photonic system 1220, in accordance with some embodiments. It should be understood that the various components of FIG. 12C are shown schematically at sizes that are not to scale relative to one another in order to facilitate illustration of the various components. The photonic system 1220 of FIG. 12C is a variation of the photonic system 1200 of FIG. 12A. Specifically, in the photonic system 1220 of FIG. 12C, the optical coupling interface 653 of PIC die/chip 903 includes an angular reflecting surface 1221 formed within the oxide stack 902 material of the PIC die/chip 903, rather than the curved reflecting surface 1201 as implemented within the photonic system 1200 of FIG. 12A. The angular reflecting surface 1221 functions to reflect the first portion 1003A of the light beam 1003 back through the optical stack material of the PIC die/chip 903 within the optical coupling interface 653 as the second portion 1003B of the light beam 1003 that travels toward the support material 917 and toward the optical coupling interface 655 of the optical fiber(s) 915. In some embodiments, the angular reflecting surface 1221 is formed, at least in part, by performing an angle etch process on the oxide stack 902 material of the PIC die/chip 903. In some embodiments, the angular reflecting surface 1221 is formed, at least in part, by performing a grayscale lithography process on the oxide stack 902 of the PIC die/chip 903.

In some embodiments, a low optical index medium or a transparent medium is present within a region 1223 outside and next to the oxide stack 902 of the PIC die/chip 903 to provide for total internal reflection of the light beam 1003 off of the angular reflecting surface 1221. In some embodiments, the angular reflecting surface 1221 is a boundary between the oxide stack 902 material of the PIC die/chip 903 and an open space within the region 1223. In some embodiments, the angular reflecting surface 1221 is configured to function as a mirror to direct light from the PIC die/chip 903 into another optical path through the support material 917 to enable conveyance of the light to the optical fiber 915 located on the opposite side of the support material 917 from where the PIC die/chip 903 is located. It should be understood that the direction of travel of the light beam 1003 can also be reversed, such that the light beam 1003 travels from the optical fiber 915, through the optical coupling interface 655, through the support material 917, through the oxide stack 902 material of the PIC die/chip 903, and reflects off of the angular reflecting surface 1221 toward the optical waveguide(s) 911 or associated optical ports/facets of the PIC die/chip 903.

In some embodiments, a mirror structure is disposed on the angular reflecting surface 1221 of the oxide stack 902 material of the PIC die/chip 903. In some embodiments, the mirror structure is disposed on substantially all of an exposed surface of the oxide stack 902 material of the PIC die/chip 903 within the optical coupling interface 653 of the PIC die/chip 903 that is located opposite from the support material 917. In some embodiments, the mirror structure is formed as a metal film. In some embodiments, the mirror structure is formed as a thin film stack. In some embodiments, the mirror structure is formed by coating one or more optically reflective materials onto the angular reflecting surface 1221. In some embodiments, with the mirror structure is disposed on the angular reflecting surface 1221 of the oxide stack 902 material of the PIC die/chip 903, the region between the mirror structure and the substrate/interposer 921 (or at least a portion thereof) is filled with the mold material 909, which serves to assist with mechanical stabilization of the PIC die/chip 903 on the substrate/interposer 921.

FIG. 12D shows a vertical cross-section through a photonic system 1230, in accordance with some embodiments. It should be understood that the various components of FIG. 12D are shown schematically at sizes that are not to scale relative to one another in order to facilitate illustration of the various components. The photonic system 1230 of FIG. 12D is a variation of the photonic system 1220 of FIG. 12C. Specifically, in the photonic system 1230 of FIG. 12D, the angular reflecting surface 1221 of the optical coupling interface 653 of PIC die/chip 903 is formed to extend contiguously through both the oxide material stack of the PIC die/chip 903 and the support material 917. In some embodiments, the angular reflecting surface 1221 within the oxide stack 902 of the PIC die/chip 903 is formed by inducing a crack along a crystal plane in the support material 917, such that the crack propagates through the oxide stack 902 of the PIC die/chip 903. In some embodiments, a low optical index medium or a transparent medium is present within a region 1231 outside and next to the oxide stack 902 of the PIC die/chip 903 to provide for total internal reflection of the light beam 1003 off of the angular reflecting surface 1221. In some embodiments, the angular reflecting surface 1221 is a boundary between the oxide stack 902 material of the PIC die/chip 903 and an open space within the region 1231.

In various embodiments, a photonic system (e.g., 1200, 1210, 1220, 1230) includes the support material 917 having a first surface 917A (top surface) and a second surface 917B (bottom surface). The second surface 917B of the support material 917 is opposite from the first surface 917A of the support material 917 relative to an overall thickness of the support material 917. The optical coupling interface 655 for the optical fiber 915 is disposed on the first surface 917A of the support material 917. The PIC die/chip 903 is disposed on the second surface 917B of the support material 917. The PIC die/chip 903 includes the oxide stack 902 that extends vertically through the PIC die/chip 903 to the second surface 917B of the support material 917. A portion of the oxide stack 902 is configured as an optical reflector structure 653 that includes a reflecting surface (e.g., 1201, 1213, 1221) configured to direct the light beam 1003 conveyed from the optical waveguide 911 within the PIC die/chip 903 from a first direction of travel to a second direction of travel directed toward the second surface 917B of the support material 917 and toward the optical coupling interface 655 for the optical fiber 915 disposed on the first surface 917A of the support material 917, such that the light beam 1003 travels from the optical waveguide 911 within the PIC die/chip 903 through the optical reflector structure and through the overall thickness of the support material 917 to reach the optical coupling interface 655 for the optical fiber 915.

In some embodiments, the optical coupling interface 653 for the PIC die/chip 903 is formed within the support material 917 to which the PIC die/chip 903 is attached. In these embodiments, the optical functionality of the optical coupling interface 653 for the PIC die/chip 903 is implemented within the support material 917 to which the PIC die/chip 903 is attached. For example, in some embodiments, in a heterogeneously integrated photonic system, the EIC chip 919 is attached to the PIC die/chip 903, and the PIC die/chip 903 is attached to the support material 917, e.g., silicon, and the optical coupling interface 653 for the PIC die/chip 903 is formed within a portion of the support material 917. In some embodiments, the support material 917 is configured to provide mechanical support for the PIC die/chip 903 and/or the EIC chip 919. In some embodiments, the EIC chip 919 is thinned to provide for attachment of PIC die/chip 903 to the support material 917, with the EIC chip 919 disposed between the PIC die/chip 903 and the support material 917. Additionally, in some embodiments, in a monolithically integrated photonic system in which the PIC die/chip 903 is attached to the support material 917, a portion of the support material 917 is positioned and configured to provide the optical coupling interface 653 for the PIC die/chip 903.

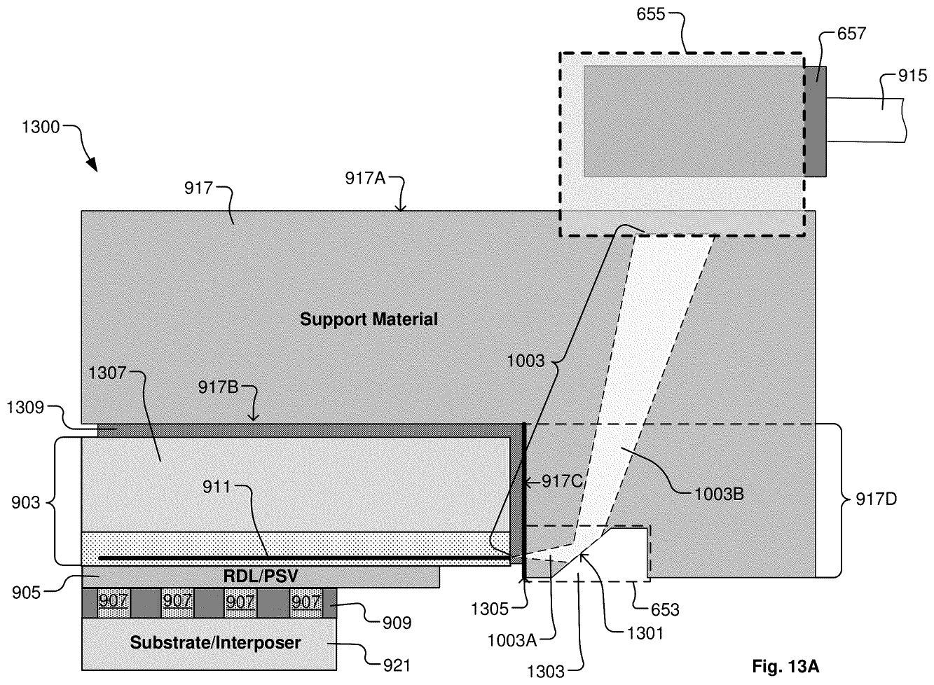

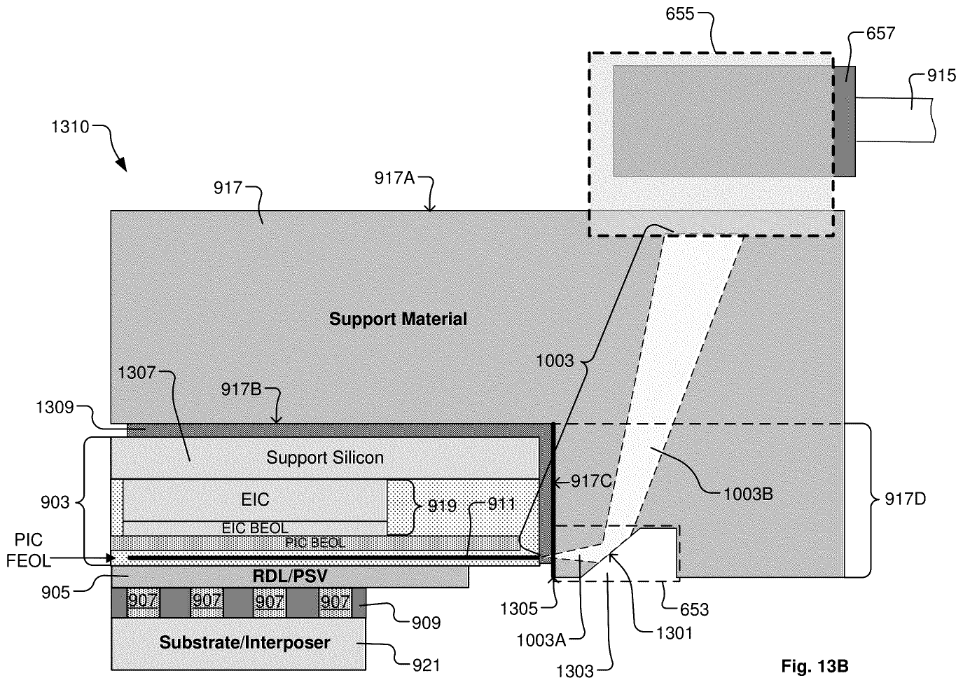

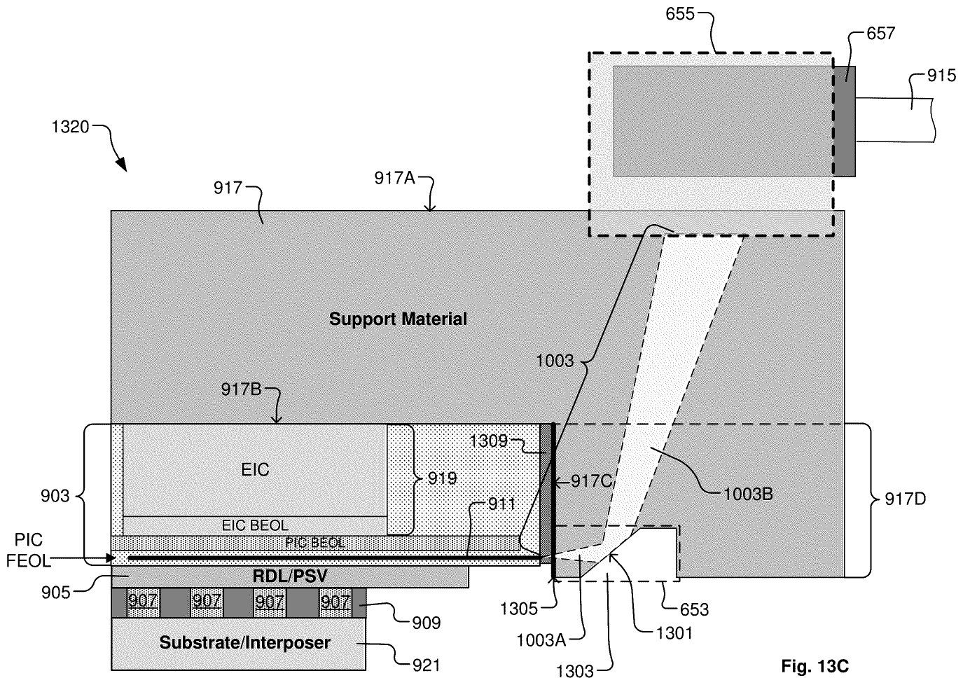

FIG. 13A shows a vertical cross-section through a photonic system 1300, in accordance with some embodiments. It should be understood that the various components of FIG. 13A are shown schematically at sizes that are not to scale relative to one another in order to facilitate illustration of the various components. The photonic system 1300 includes the PIC die/chip 903 that includes the one or more waveguide(s) 911 configured to convey light and/or receive light at vertical side surface of the PIC die/chip 903. In some embodiments, the PIC die/chip 903 is attached physically and electrically to the RDL 905. In some embodiments, the RDL 905 is attached physically and electrically to the substrate/interposer 921 through the C4 bumps 907. In some embodiments, the PIC die/chip 903 includes a layer of support silicon 1307. The PIC die/chip 903 is attached to the support material 917. In some embodiments, an adhesive material 1309, e.g., epoxy, is used to attach the PIC die/chip 903 to the support material 917. In some embodiments, the adhesive material 1309 has an optical index that substantially matches the optical index of the cores of the waveguide(s) 911 within the PIC die/chip 903.

The support material 917 includes a horizontal surface 917B and a vertical surface 917C that extends vertically from the horizontal surface 917B. In some embodiments, the vertical surface 917C is substantially perpendicular to the horizontal surface 917B. The support material 917 includes a side portion 917D that forms the vertical surface 917C and that extends vertically past the side of the PIC die/chip 903. The PIC die/chip 903 is disposed next to both the horizontal surface 917B and the vertical surface 917C of the support material 917. The adhesive material 1309 is disposed between the PIC die/chip 903 and each of the horizontal surface 917B and the vertical surface 917C of the support material 917. In some embodiments, a substantially uniform separation distance exists between the side of the PIC die/chip 903 and the vertical surface 917C of the side portion 917D of the support material 917. The optical coupling interface 655 for the optical fiber(s) 915 is disposed on the surface 917A of the support material 917 opposite from the horizontal surface 917B of the support material 917 on which the PIC die/chip 903 is disposed. In some embodiments, the support material 917 is a substrate layer or a carrier wafer on which the PIC die/chip 903 is disposed and supported. In some embodiments, the support material 917 is formed of silicon.

In the photonic system 1300, the optical coupling interface 653 for the PIC die/chip 903 is formed within the side portion 917D of the support material 917. The waveguide(s) 911 within the PIC die/chip 903 are optically connected to the one or more optical fiber(s) 915 through the optical coupling interface 653 for the PIC die/chip 903 that is formed within the support material 917 and through the optical coupling interface 655 on the surface 917A of the support material 917. In this manner, light (optical signals) is conveyed from the waveguide(s) 911 into the optical fiber(s) 915 and/or from the optical fiber(s) 915 into the waveguide(s) 911.

The optical coupling interface 653 includes an angular reflecting surface 1301 formed within the support material 917. The angular reflecting surface 1301 is configured and positioned to receive the first portion 1003A of the light beam 1003 (optical signals) conveyed out of the optical waveguide(s) 911 and/or associated optical port(s)/facet(s) of the PIC die/chip 903. In some embodiments, the first portion 1003A of the light beam 1003 (optical signals) is conveyed out of the optical waveguide(s) 911 and/or associated optical port(s)/facet(s) of the PIC die/chip 903 in a substantially horizontal direction (in a direction that is substantially parallel with the horizontal surface 917B of the support material 917, and that is substantially perpendicular to the vertical surface 917C of the support material 917). The angular reflecting surface 1301 is configured to reflect the first portion 1003A of the light beam 1003 into the second portion 1003B of the light beam 1003, such that the second portion 1003B of the light beam 1003 travels through the support material 917 toward the optical coupling interface 655 for the optical fiber(s) 915 to enable conveyance of the light beam 1003 into to the optical fiber(s) 915. In some embodiments, an anti-reflective coating 1305 is disposed on the vertical surface 917C of the support material 917 between the optical waveguide(s) 911 of the PIC die/chip 903 and the support material 917 to facilitate optical conveyance of the first portion 1003A of the light beam 1003 into the support material 917.

The first portion 1003A of the light beam 1003 is projected from the optical waveguide(s) 911 and/or associated optical port(s)/facet(s) of the PIC die/chip 903 through the gap between the PIC die/chip 903 and the support material 917, and through a portion of the support material 917 to reach the angular reflecting surface 1301. The angular reflecting surface 1301 functions as a mirror to reflect the first portion 1003A of the light beam 1003 back through the body of the support material 917 as the second portion 1003B of the light beam 1003 that travels toward the optical coupling interface 655. In some embodiments, the angular reflective surface 1301 is a boundary between the support material 917 and a region 1303 outside of the support material 917. In some embodiments, a low optical index medium or a transparent medium is present within the region 1303 outside and next to the angular reflecting surface 1301 to provide for total internal reflection of the light beam 1003 off of the angular reflecting surface 1301. In some embodiments, the angular reflecting surface 1301 is a boundary between the support material 917 and an open space within the region 1303.

It should be understood that the direction of travel of the light beam 1003 can also be reversed, such that the light beam 1003 travels from the optical fiber 915, through the optical coupling interface 655, through the support material 917 to the angular reflecting surface 1301, and reflects off of the angular reflecting surface 1301 toward the optical waveguide 911 or associated optical port/facet of the PIC die/chip 903. It should be noted that the combination of the optical coupling interface 653 within the support material 917 and the optical coupling interface 655 on the surface 917A of the support material 917 opposite from surface 917B of the support material 917 on which the PIC die/chip 903 is disposed provides for implementation of the heterogeneously integrated photonic system 901 without having a KOZ within the PIC die/chip 903 or a cut-out region within the substrate/interposer 921.

FIG. 13B shows a vertical cross-section through a photonic system 1310, in accordance with some embodiments. It should be understood that the various components of FIG. 13B are shown schematically at sizes that are not to scale relative to one another in order to facilitate illustration of the various components. The photonic system 1310 of FIG. 13B is a variation of the photonic system 1300 of FIG. 13A. Specifically, in the photonic system 1310 of FIG. 13B, the EIC chip 919 is physically and electrically attached to the PIC die/chip 903. The layer of support silicon 1307 extends over both the EIC chip 919 and the PIC die/chip 903. In some embodiments, the EIC chip 919 is thinned to accommodate the layer of support silicon 1307, while maintaining optical alignment of the optical waveguide(s) 911 with the angular reflecting surface 1301. In comparison with the photonic system 1300 of FIG. 13A, the photonic system 1310 of FIG. 13B demonstrates how implementation of the optical coupling interface 653 within the support material 917 provides for use of a same support material 917 configuration with different PIC die/chip 903 and/or EIC chip 919 configurations.

FIG. 13C shows a vertical cross-section through a photonic system 1320, in accordance with some embodiments. It should be understood that the various components of FIG. 13C are shown schematically at sizes that are not to scale relative to one another in order to facilitate illustration of the various components. The photonic system 1320 of FIG. 13C is a variation of the photonic system 1310 of FIG. 13B. Specifically, in the photonic system 1320 of FIG. 13C, the layer of support silicon 1307 is not present. Also, in some embodiments, the EIC chip 919 is not thinned to accommodate the support silicon 1307. Also, in some embodiments, the EIC chip 919 and the PIC die/chip 903 are positioned in contact with the horizontal surface 917B of the support material 917, with the optically matched adhesive material 1309 remaining between the side of the PIC die/chip 903 and the vertical surface 917C of the support material 917. In comparison with the photonic system 1300 of FIG. 13A and the photonic system 1310 of FIG. 13B, the photonic system 1320 of FIG. 13C again demonstrates how implementation of the optical coupling interface 653 within the support material 917 provides for use of a same support material 917 configuration with different PIC die/chip 903 and/or EIC chip 919 configurations.

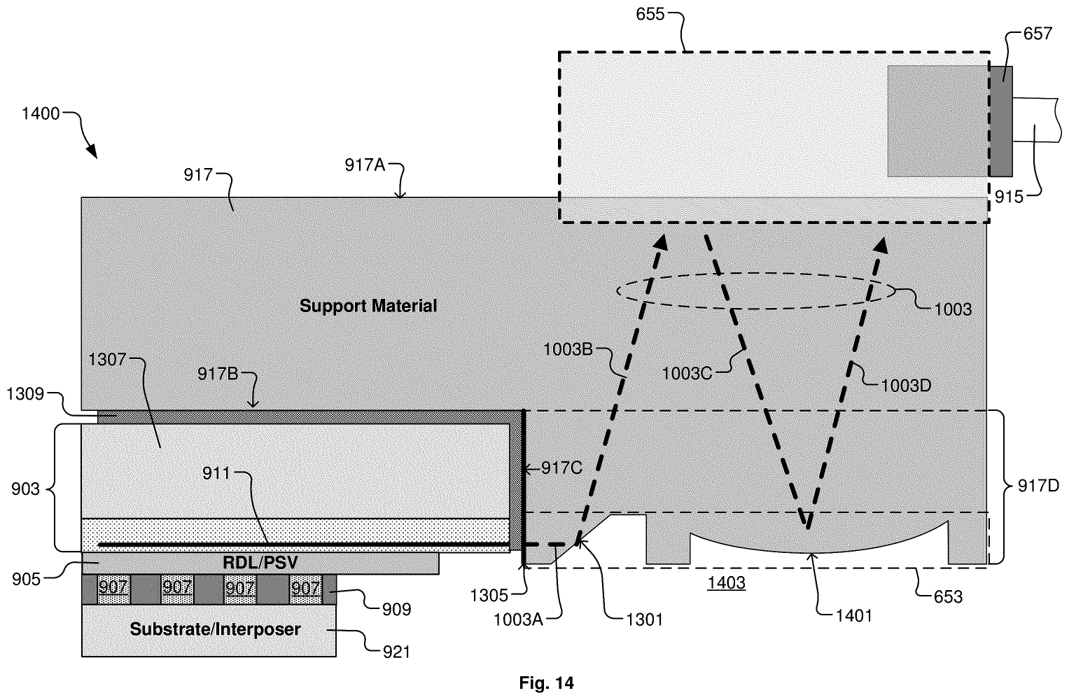

FIG. 14 shows a vertical cross-section through a photonic system 1400, in accordance with some embodiments. It should be understood that the various components of FIG. 14 are shown schematically at sizes that are not to scale relative to one another in order to facilitate illustration of the various components. The photonic system 1400 of FIG. 14 is a variation of the photonic system 1300 of FIG. 13A. Specifically, in the photonic system 1400 of FIG. 14, the optical coupling interface 653 within the support material 917 includes both the angular reflecting surface 1301 and a lensing surface 1401 that are spatially separated from each other within the optical coupling interface 653.

The angular reflecting surface 1301 is configured to direct the first portion 1003A of the light beam 1003 emanating from the waveguide(s) 911 into the second portion 1003B of the light beam 1003 that passes through the body of the support material 917 to the optical coupling interface 655 for the optical fiber(s) 915. The optical coupling interface 655 for the optical fiber(s) 915 is configured to reflect the second portion 1003B of the light beam 1003 into the third portion 1003C of the light beam 1003, such that the third portion 1003C of the light beam 1003 travels back through the support material 917 to the lensing surface 1401 of the optical coupling interface 653. The lensing surface 1401 is configured to reflect the third portion 1003C of the light beam 1003 into the fourth portion 1003D of the light beam 1003, such that the fourth portion 1003D of the light beam 1003 travels back through the body of the support material 917 to the optical coupling interface 655 for conveyance into the optical fiber(s) 915. In some embodiments, the lensing surface 1401 is configured to focus the fourth portion 1003D of the light beam 1003 that is reflected back toward the optical coupling interface 655. In some embodiments, the lensing surface 1401 is configured to collimate the fourth portion 1003D of the light beam 1003 that is reflected back toward the optical coupling interface 655. In some embodiments, the lensing surface 1401 is configured to both focus and collimate the fourth portion 1003D of the light beam 1003 that is reflected back toward the optical coupling interface 655. In some embodiments, each of the angular reflecting surface 1301 and the lensing surface 1401 is a boundary between the support material 917 and an open space 1403. The angular reflecting surface 1301 and the lensing surface 1401 are collectively configured to work with the optical coupling interface 655 for the optical fiber(s) 915 to provide for conveyance of the light beam 1003 from the PIC die/chip 903 to the optical fiber(s) 915 located on the opposite side of the support material 917 from where the PIC die/chip 903 is located, and vice-versa.

In various embodiments, the angular reflecting surface 1301 and the lensing surface 1401 are formed within the support material 917 using one or more semiconductor fabrication processes, such as imprint lithography, etching, and/or grayscale lithography, among others. It should be understood that the direction of travel of the light beam 1003 can also be reversed, such that the light beam 1003 travels from the optical fiber 915, through the optical coupling interface 655, through the support material 917 in multiple passes, and reflects off of the angled reflecting surface 1301 toward the optical waveguide 911 or associated optical port/facet of the PIC die/chip 903. In some embodiments, one or more mirror structure(s) are disposed on one or both of the angular reflecting surface 1301 and the lensing surface 1401 of the support material 917. In some embodiments, the mirror structure(s) are disposed on substantially all of an exposed surface of the support material 917 within the optical coupling interface 653 for the PIC die/chip 903. In some embodiments, the mirror structure(s) are formed as a metal film. In some embodiments, the mirror structure(s) are formed as a thin film stack. In some embodiments, the mirror structure(s) are formed by coating one or more optically reflective materials onto the exposed surface of the support material 917.

In various embodiments, a photonic system (e.g., 1300, 1310, 1320, 1400) includes the PIC die/chip 903 that includes the optical waveguide 911 that is optically connected to an optical port/facet at a side of the PIC die/chip 903. The photonic system also includes the support material 917. The PIC die/chip 903 is disposed on the surface 917B of the support material 917. The support material 917 is configured to wrap around a side of the PIC die/chip 903 where the optical port is located. A portion of the support material 917 is configured as the optical reflector structure 653 that includes a reflecting surface (e.g., 1301, 1401) configured to direct the light beam 1003 conveyed from the optical port of the PIC die/chip 903 from a first direction of travel to a second direction of travel through the support material 917 toward the surface 917A of the support material 917. The optical coupling interface 655 for the optical fiber 915 is disposed on the surface 917A of the support material 917. The optical coupling interface 655 is configured to receive the light beam 1003 traveling in the second direction through the support material 917.

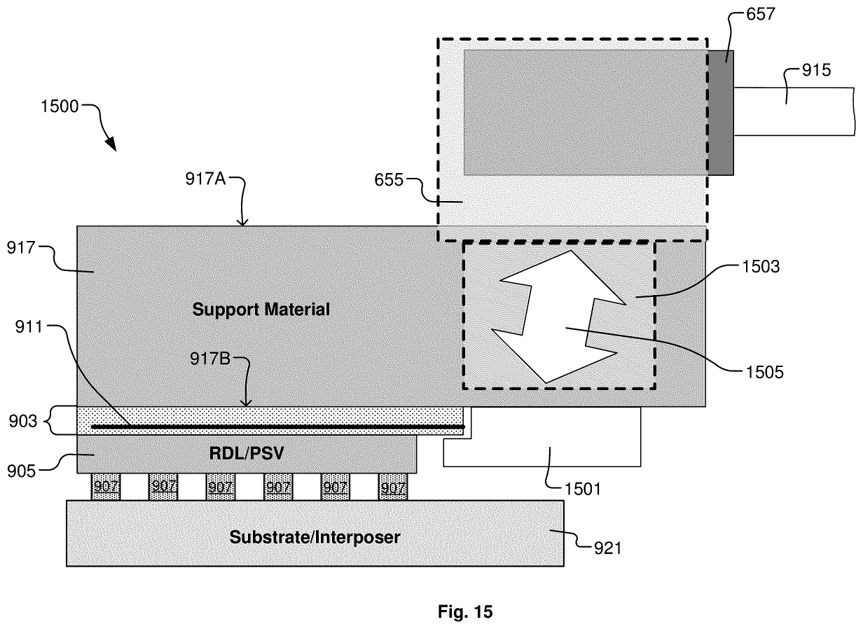

FIG. 15 shows a vertical cross-section through a photonic system 1500, in accordance with some embodiments. It should be understood that the various components of FIG. 15 are shown schematically at sizes that are not to scale relative to one another in order to facilitate illustration of the various components. The photonic system 1500 includes the PIC die/chip 903 disposed on the support material 917. In some embodiments, the BEOL portion of the PIC die/chip 903 is positioned next to the support material 917. In some embodiments, the FEOL portion of the PIC die/chip 903 that includes waveguide(s) 911 and photonic devices is located below the BEOL portion of the PIC die/chip 903. The FEOL portion of the PIC die/chip 903 is positioned on top of an electrical connectivity interface, such as the RDL 905, and/or an interposer, and/or a substrate, and/or another electrical fanout device. In some embodiments, the C4 bumps 907 are used to physically and electrically connect the RDL 905 to another electronic device/chip, such as the substrate/interposer 921. In some embodiments, the PIC die/chip 903 includes exposed electrical connections to which the RDL 905 is electrically and physically connected. The waveguide(s) 911 are connected to convey light (optical signals) to and/or from the PIC die/chip 903. In some embodiments, along with the waveguide(s) 911, various photonic devices and/or electro-optic devices are also implemented within the FEOL portion of the PIC die/chip 903.

In the photonic system 1500, an optical coupling interface component 1501 for the PIC die/chip 903 is provided at an edge of the PIC die/chip 903 where the one or more waveguide(s) 911 and/or associated optical port(s)/facet(s) of the PIC die/chip 903 are located for optical connection. In some embodiments, the optical coupling interface component 1501 for the PIC die/chip 903 is a physically independent component that is attached to the PIC die/chip 903 and/or support material 917. In some embodiments, the optical coupling interface component 1501 for the PIC die/chip 903 is formed separate from the PIC die/chip 903 and the support material 917. In the photonic system 1500, instead of the optical coupling interface component 1501 being defined/formed within the PIC die/chip 903 and/or support material 917, the optical coupling interface component 1501 is physically attached to the PIC die/chip 903 and/or support material 917, such as by an adhesive or other attachment mechanism.

The optical coupling interface 655 for one or more optical fiber(s) 915 is provided on the surface 917A of the support material 917 that is opposite from a surface 917B of the support material 917 to which the PIC die/chip 903 is attached. In some embodiments, the mechanical connector 657 is disposed within the optical coupling interface 655 to facilitate attachment and optical alignment of the optical fiber(s) 915 within the optical coupling interface 655.

Light (optical signals) that is conveyed through the waveguide(s) 911 and out from the PIC die/chip 903 is diverted upward by the optical coupling interface component 1501 for the PIC die/chip 903, through an optical path region 1503 that extends through the support material 917. In some embodiments, the optical coupling interface component 1501 for the PIC die/chip 903 is implemented, at least in part, by optical elements disposed in the FEOL of the PIC die/chip 903. The upwardly diverted light beam follows an optical path that extends from the optical coupling interface component 1501 for the PIC die/chip 903 through the support material 917 (e.g., wafer handle, support silicon, carrier wafer, among other support configurations) to the optical coupling interface 655 for the optical fiber(s) 915. The optical coupling interface 655 for the optical fiber(s) 915 is configured to direct the light from the PIC die/chip 903 into the optical fiber(s) 915. In various embodiments, the optical coupling interface 655 includes optical components for turning/diverting, and/or focusing a light beam in order to facilitate optical coupling of the light from the PIC die/chip 903 into the optical fiber(s) 915. In some embodiments, the optical fiber(s) 915 form an optical fiber array, such as a fiber array unit (FAU). In some embodiments, collimation optics are implemented within the optical fiber(s) and/or in conjunction with the optical fiber(s) 915.

Also, it should be understood that light (optical signals) travel from the optical fiber(s) 915 to the waveguide(s) 911 within PIC die/chip 903 by way of the optical coupling interface 655 for the optical fiber(s) 915 and the optical coupling interface component 1501 for the PIC die/chip 903. In this manner, the light (optical signals) that travels from the optical fiber(s) 915 to the waveguide(s) 911 within PIC die/chip 903 travels through the optical path region 1503 that extends through the support material 917. Therefore, it should be understood that the optical coupling interface 655 for the optical fiber(s) 915 and the optical coupling interface component 1501 for the PIC die/chip 903 provide for bi-directional conveyance of light (optical signals) through the optical path region 1503 that extends through the support material 917, as indicated by arrow 1505.

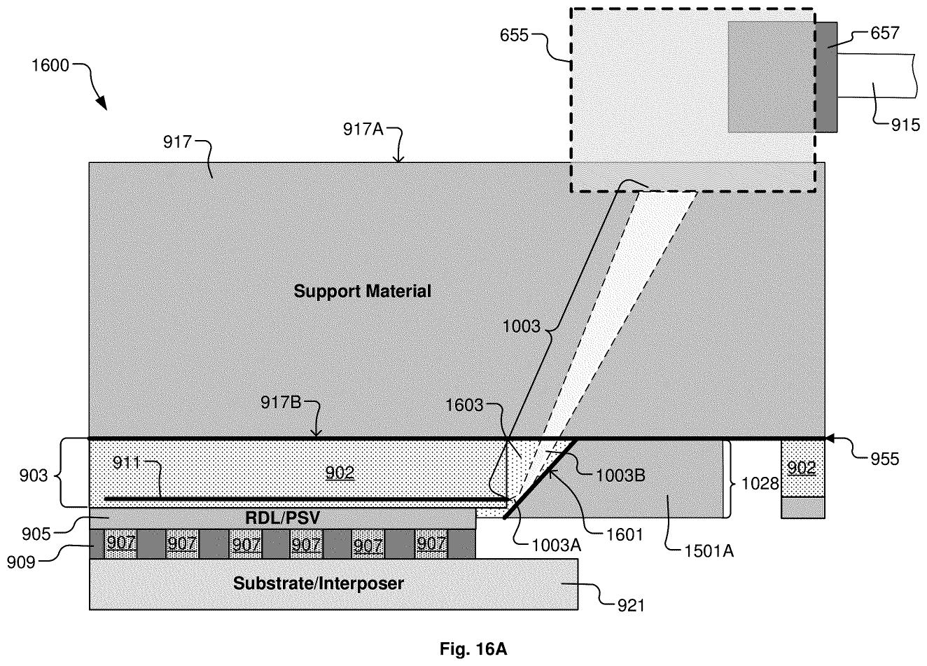

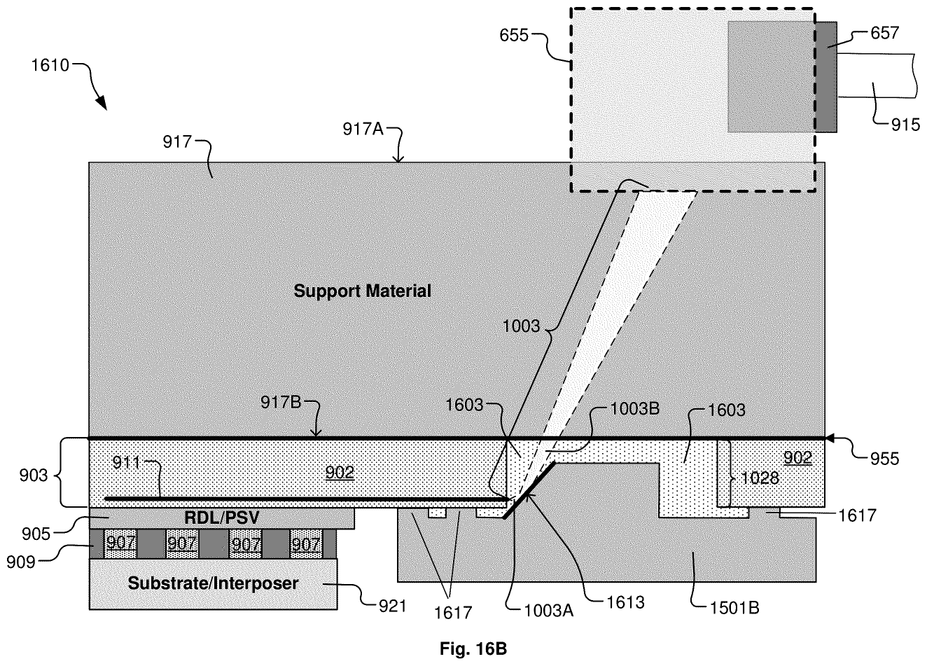

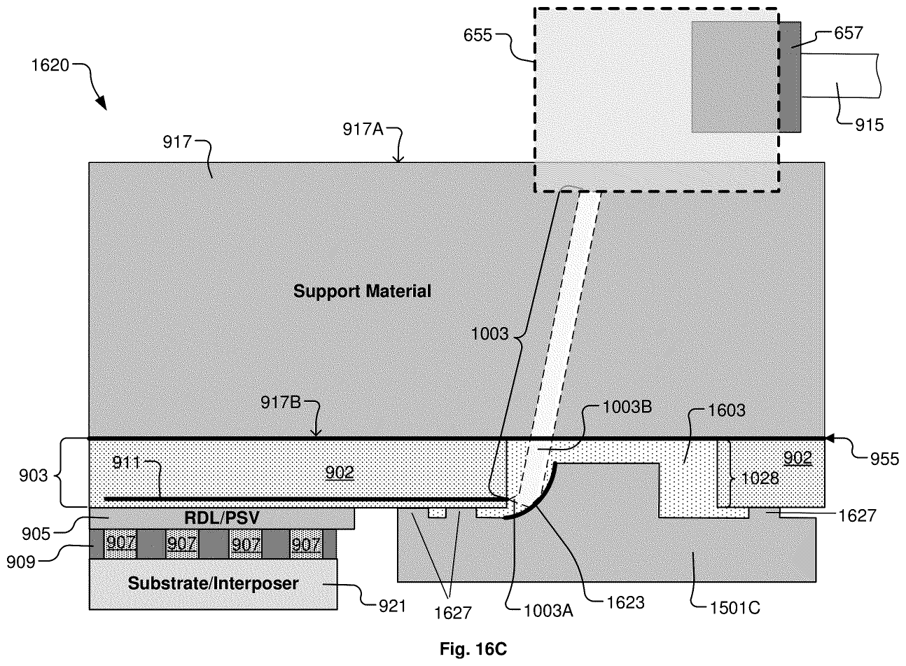

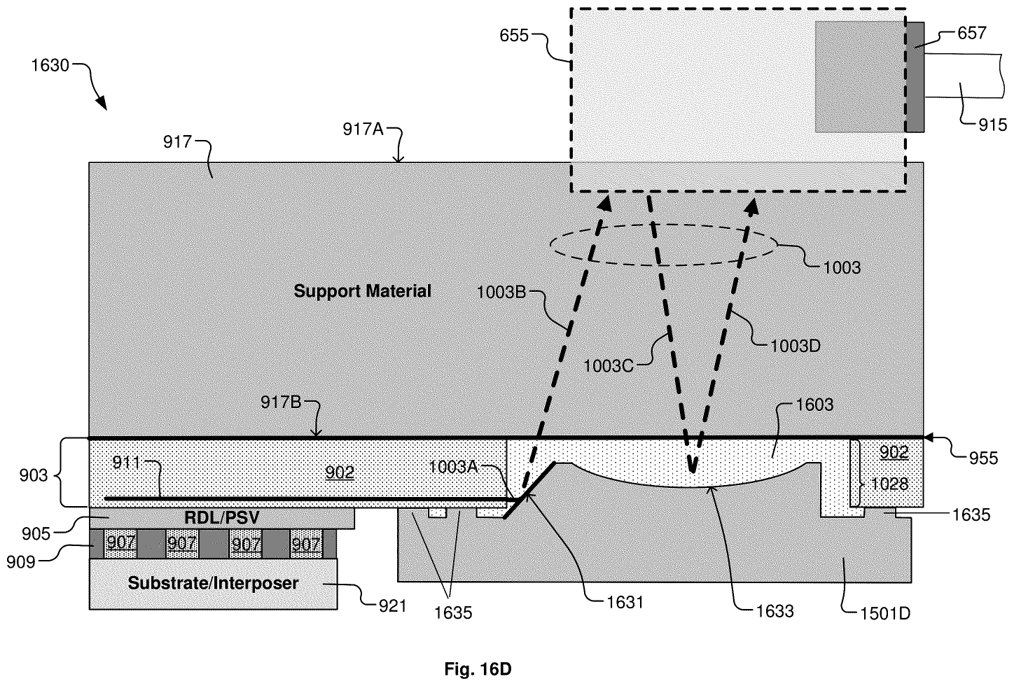

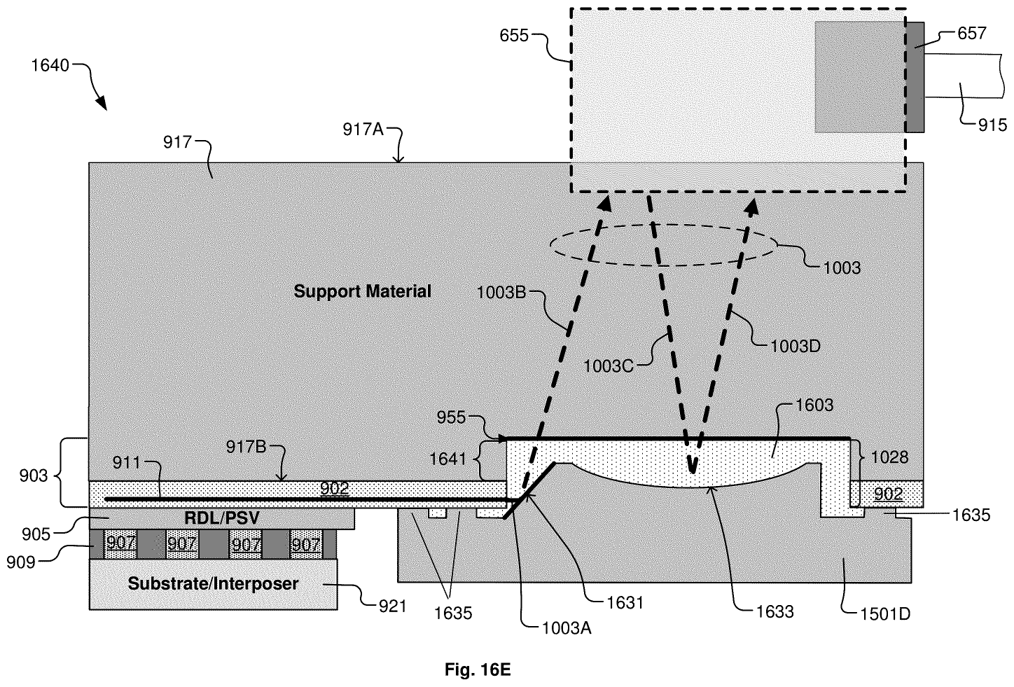

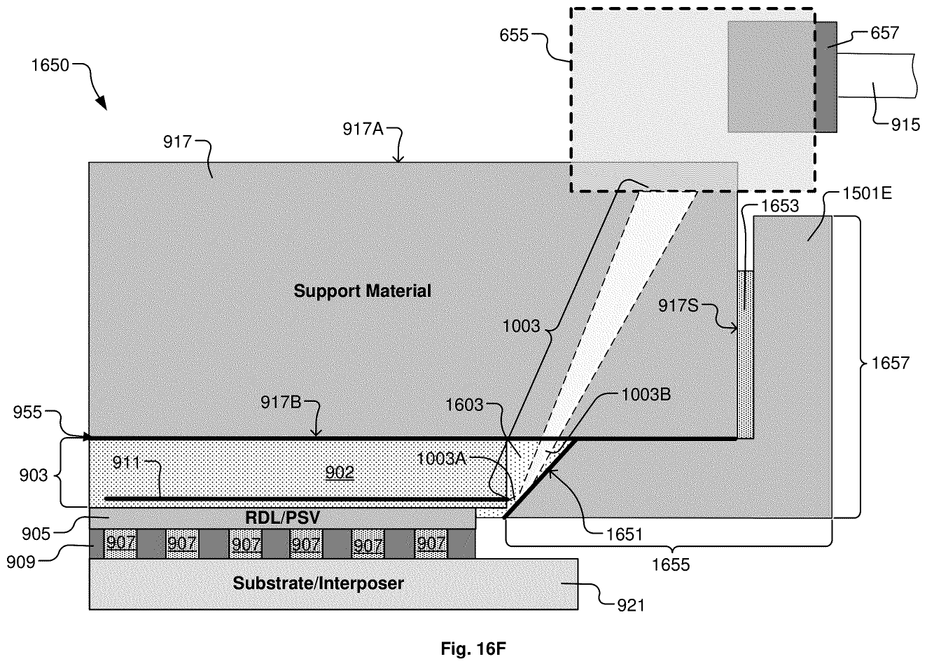

FIG. 16A shows a vertical cross-section through a photonic system 1600, in accordance with some embodiments. It should be understood that the various components of FIG. 16A are shown schematically at sizes that are not to scale relative to one another in order to facilitate illustration of the various components. The photonic system 1600 is an example embodiment of the photonic system 1500 of FIG. 15. The photonic system 1600 includes the PIC die/chip 903, the support material 917, the optical coupling interface 655 for the optical fiber 915, the RDL 905, the C4 bumps 907, the mold material 909, and the substrate/interposer 921, as described with regard to FIG. 9. An optical coupling interface component 1501A is attached to the PIC die/chip 903 and to the support material 917. The optical coupling interface component 1501A is formed separate from each of the PIC die/chip 903 and the support material 917. In some embodiments, the optical coupling interface component 1501A is attached to the PIC die/chip 903 and the support material 917 by an adhesive 1603. In some embodiments, the adhesive 1603 is an optical index-matching material configured to prevent optical reflections and excess optical loss of the light beam 1003. In some embodiments, the adhesive 1603 has an optical index that substantially matches an optical index of the core(s) of the waveguide(s) 911 within the PIC die/chip 903. In some embodiments, a portion of the PIC die/chip 903 is removed to accommodate attachment of the optical coupling interface component 1501A to the PIC die/chip 903 and/or support material 917. For example, in some embodiments, the cavity 1028/1028A is formed within, or even completely through, the PIC die/chip 903 to accommodate attachment of the optical coupling interface component 1501A to the PIC die/chip 903 and/or support material 917.

The optical coupling interface component 1501A includes an optical reflector structure 1601 configured to direct the first portion 1003A of the light beam 1003 emanating from the waveguide(s) 911 into the second portion 1003B of the light beam 1003 that passes through the support material 917 to the optical coupling interface 655 for the optical fiber(s) 915 to enable conveyance of the light beam 1003 into to the optical fiber(s) 915. It should be understood that the direction of travel of the light beam 1003 can also be reversed, such that the light beam 1003 travels from the optical fiber 915, through the optical coupling interface 655, through the support material 917, and reflects off of the optical reflector structure 1601 toward the optical waveguide 911 or associated optical port/facet of the PIC die/chip 903. In some embodiments, the anti-reflective coating 955 is disposed between the support material 917 and optical reflector structure 1601 to facilitate optical conveyance of the light beam 1003 from the optical reflector structure 1601 into the support material 917, and vice-versa.

The optical reflector structure 1601 has a planar shape that is positioned at an angle relative to the direction of travel of the first portion 1003A of the light beam 1003. The angular position of the optical reflector structure 1601 is set so that the second portion 1003B of the light beam 1003 is directed toward a target location on the optical coupling interface 655 for the optical fiber(s) 915. In some embodiments, the optical reflector structure 1601 is configured to function as a mirror to direct light from the PIC die/chip 903 into another optical path through the support material 917 to enable conveyance of the light to the optical fiber 915 located on the opposite side of the support material 917 from where the PIC die/chip 903 is located. In some embodiments, the optical reflector structure 1601 is formed as a metal film. In some embodiments, the optical reflector structure 1601 is formed as a thin film stack. In some embodiments, the optical reflector structure 1601 is formed by coating one or more optically reflective materials onto the optical coupling interface component 1501A.

FIG. 16B shows a vertical cross-section through a photonic system 1610, in accordance with some embodiments. It should be understood that the various components of FIG. 16B are shown schematically at sizes that are not to scale relative to one another in order to facilitate illustration of the various components. The photonic system 1610 is an example embodiment of the photonic system 1500 of FIG. 15. The photonic system 1610 includes the PIC die/chip 903, the support material 917, the optical coupling interface 655 for the optical fiber 915, the RDL 905, the C4 bumps 907, the mold material 909, and the substrate/interposer 921, as described with regard to FIG. 9. An optical coupling interface component 1501B is attached to the PIC die/chip 903. The optical coupling interface component 1501B is formed separate from each of the PIC die/chip 903 and the support material 917. In some embodiments, the optical coupling interface component 1501B is attached to the PIC die/chip 903 by the adhesive 1603. In some embodiments, the adhesive 1603 is an optical index-matching material configured to prevent optical reflections and excess optical loss of the light beam 1003. In some embodiments, the adhesive 1603 has an optical index that substantially matches an optical index of the core(s) of the waveguide(s) 911 within the PIC die/chip 903.

A portion of the PIC die/chip 903 is removed to accommodate attachment of the optical coupling interface component 1501B to the PIC die/chip 903. For example, in some embodiments, the cavity 1028/1028A is formed within, or even completely through, the PIC die/chip 903 to accommodate attachment of the optical coupling interface component 1501B to the PIC die/chip 903. In some embodiments, the optical coupling interface component 1501B is inserted into the cavity 1028/1028A formed within the PIC die/chip 903. In some embodiments, such as shown in the photonic system 1610, the optical coupling interface component 1501B is configured to extend into the cavity 1028/1028A formed within the PIC die/chip 903 by less than a full depth of the cavity 1028/1028A, such that the adhesive 1603 is disposed between the optical coupling interface component 1501B and the support material 917. In some embodiments, the optical coupling interface component 1501B includes a number of leg structures 1617 that are positioned to contact the PIC die/chip 903. In some embodiments, the adhesive 1603 is disposed between and around the leg structures 1617. In some embodiments, the leg structures 1617 are present on each side of the cavity 1028/1028A. It should be understood that by having the optical coupling interface component 1501B extend part way into the cavity 1028/1028A, the vertical positioning of the optical coupling interface component 1501B relative to the PIC die/chip 903 is controlled exclusively by the leg structures 1617.

The optical coupling interface component 1501B includes an optical reflector structure 1613 configured to direct the first portion 1003A of the light beam 1003 emanating from the waveguide(s) 911 into the second portion 1003B of the light beam 1003 that passes through the support material 917 to the optical coupling interface 655 for the optical fiber(s) 915 to enable conveyance of the light beam 1003 into to the optical fiber(s) 915. It should be understood that the direction of travel of the light beam 1003 can also be reversed, such that the light beam 1003 travels from the optical fiber 915, through the optical coupling interface 655, through the support material 917, and reflects off of the optical reflector structure 1613 toward the optical waveguide 911 or associated optical port/facet of the PIC die/chip 903. In some embodiments, the anti-reflective coating 955 is disposed between the support material 917 and optical reflector structure 1613 to facilitate optical conveyance of the light beam 1003 from the optical reflector structure 1613 into the support material 917, and vice-versa.

The optical reflector structure 1613 has a planar shape that is positioned at an angle relative to the direction of travel of the first portion 1003A of the light beam 1003. The angular position of the optical reflector structure 1613 is set so that the second portion 1003B of the light beam 1003 is directed toward a target location on the optical coupling interface 655 for the optical fiber(s) 915. In some embodiments, the optical reflector structure 1613 is configured to function as a mirror to direct light from the PIC die/chip 903 into another optical path through the support material 917 to enable conveyance of the light to the optical fiber 915 located on the opposite side of the support material 917 from where the PIC die/chip 903 is located. In some embodiments, the optical reflector structure 1613 is formed as a metal film. In some embodiments, the optical reflector structure 1613 is formed as a thin film stack. In some embodiments, the optical reflector structure 1613 is formed by coating one or more optically reflective materials onto the optical coupling interface component 1501B.

FIG. 16C shows a vertical cross-section through a photonic system 1620, in accordance with some embodiments. It should be understood that the various components of FIG. 16C are shown schematically at sizes that are not to scale relative to one another in order to facilitate illustration of the various components. The photonic system 1620 is an example embodiment of the photonic system 1500 of FIG. 15. The photonic system 1620 includes the PIC die/chip 903, the support material 917, the optical coupling interface 655 for the optical fiber 915, the RDL 905, the C4 bumps 907, the mold material 909, and the substrate/interposer 921, as described with regard to FIG. 9. An optical coupling interface component 1501C is attached to the PIC die/chip 903. The optical coupling interface component 1501C is formed separate from each of the PIC die/chip 903 and the support material 917. In some embodiments, the optical coupling interface component 1501C is attached to the PIC die/chip 903 by the optical index-matched adhesive 1603.

A portion of the PIC die/chip 903 is removed to accommodate attachment of the optical coupling interface component 1501C to the PIC die/chip 903. For example, in some embodiments, the cavity 1028/1028A is formed within, or even completely through, the PIC die/chip 903 to accommodate attachment of the optical coupling interface component 1501C to the PIC die/chip 903. In some embodiments, the optical coupling interface component 1501C is inserted into the cavity 1028/1028A formed within the PIC die/chip 903. In some embodiments, such as shown in the photonic system 1620, the optical coupling interface component 1501C is configured to extend into the cavity 1028/1028A formed within the PIC die/chip 903 by less than a full depth of the cavity 1028/1028A, such that the adhesive 1603 is disposed between the optical coupling interface component 1501C and the support material 917. In some embodiments, the optical coupling interface component 1501C includes a number of leg structures 1627 that are positioned to contact the PIC die/chip 903. In some embodiments, the adhesive 1603 is disposed between and around the leg structures 1627. In some embodiments, the leg structures 1627 are present on each side of the cavity 1028/1028A. It should be understood that by having the optical coupling interface component 1501C extend part way into the cavity 1028/1028A, the vertical positioning of the optical coupling interface component 1501C relative to the PIC die/chip 903 is controlled exclusively by the leg structures 1627.

The optical coupling interface component 1501C includes an optical reflector structure 1623 configured to direct the first portion 1003A of the light beam 1003 emanating from the waveguide(s) 911 into the second portion 1003B of the light beam 1003 that passes through the support material 917 to the optical coupling interface 655 for the optical fiber(s) 915 to enable conveyance of the light beam 1003 into to the optical fiber(s) 915. It should be understood that the direction of travel of the light beam 1003 can also be reversed, such that the light beam 1003 travels from the optical fiber 915, through the optical coupling interface 655, through the support material 917, and reflects off of the optical reflector structure 1623 toward the optical waveguide 911 or associated optical port/facet of the PIC die/chip 903. In some embodiments, the anti-reflective coating 955 is disposed between the support material 917 and optical reflector structure 1623 to facilitate optical conveyance of the light beam 1003 from the optical reflector structure 1623 into the support material 917, and vice-versa.

The optical reflector structure 1623 has a curved shape that is configured to both reflect and collimate the first portion 1003A of the light beam 1003 into the second portion 1003B of the light beam 1003. The curved shape of the optical reflector structure 1623 is oriented so that the second portion 1003B of the light beam 1003 is directed toward a target location on the optical coupling interface 655 for the optical fiber(s) 915. In some embodiments, the optical reflector structure 1623 is configured to function as a mirror to direct light from the PIC die/chip 903 into another optical path through the support material 917 to enable conveyance of the light to the optical fiber 915 located on the opposite side of the support material 917 from where the PIC die/chip 903 is located. In some embodiments, the optical reflector structure 1623 is formed as a metal film. In some embodiments, the optical reflector structure 1623 is formed as a thin film stack. In some embodiments, the optical reflector structure 1623 is formed by coating one or more optically reflective materials onto the optical coupling interface component 1501C.

FIG. 16D shows a vertical cross-section through a photonic system 1630, in accordance with some embodiments. It should be understood that the various components of FIG. 16D are shown schematically at sizes that are not to scale relative to one another in order to facilitate illustration of the various components. The photonic system 1630 is an example embodiment of the photonic system 1500 of FIG. 15. The photonic system 1630 includes the PIC die/chip 903, the support material 917, the optical coupling interface 655 for the optical fiber 915, the RDL 905, the C4 bumps 907, the mold material 909, and the substrate/interposer 921, as described with regard to FIG. 9. An optical coupling interface component 1501D is attached to the PIC die/chip 903. The optical coupling interface component 1501D is formed separate from each of the PIC die/chip 903 and the support material 917. In some embodiments, the optical coupling interface component 1501D is attached to the PIC die/chip 903 by the adhesive 1603. In some embodiments, the adhesive 1603 is an optical index-matching material configured to prevent optical reflections and excess optical loss of the light beam 1003. In some embodiments, the adhesive 1603 has an optical index that substantially matches an optical index of the core(s) of the waveguide(s) 911 within the PIC die/chip 903.

A portion of the PIC die/chip 903 is removed to accommodate attachment of the optical coupling interface component 1501D to the PIC die/chip 903. For example, in some embodiments, the cavity 1028/1028A is formed within, or even completely through, the PIC die/chip 903 to accommodate attachment of the optical coupling interface component 1501D to the PIC die/chip 903. In some embodiments, the optical coupling interface component 1501D is inserted into the cavity 1028/1028A formed within the PIC die/chip 903. In some embodiments, such as shown in the photonic system 1630, the optical coupling interface component 1501D is configured to extend into the cavity 1028/1028A formed within the PIC die/chip 903 by less than a full depth of the cavity 1028/1028A, such that the adhesive 1603 is disposed between the optical coupling interface component 1501D and the support material 917. In some embodiments, the optical coupling interface component 1501D includes a number of leg structures 1635 that are positioned to contact the PIC die/chip 903. In some embodiments, the adhesive 1603 is disposed between and around the leg structures 1635. In some embodiments, the leg structures 1635 are present on each side of the cavity 1028/1028A. It should be understood that by having the optical coupling interface component 1501D extend part way into the cavity 1028/1028A, the vertical positioning of the optical coupling interface component 1501D relative to the PIC die/chip 903 is controlled exclusively by the leg structures 1635.

The optical coupling interface component 1501D includes both an optical reflector structure 1631 and an optical lensing structure 1633. The optical reflector structure 1631 and the optical lensing structure 1633 are spatially separated from each other within the optical coupling interface component 1501D. The optical reflector structure 1631 is configured to direct the first portion 1003A of the light beam 1003 emanating from the waveguide(s) 911 into the second portion 1003B of the light beam 1003 that passes through the support material 917 to the optical coupling interface 655 for the optical fiber(s) 915. The optical coupling interface 655 for the optical fiber(s) 915 is configured to reflect the second portion 1003B of the light beam 1003 into the third portion 1003C of the light beam 1003, such that the third portion 1003C of the light beam 1003 travels back through the support material 917 to the optical lensing structure 1633 of the optical coupling interface component 1501D. The optical lensing structure 1633 is configured to reflect the third portion 1003C of the light beam 1003 into the fourth portion 1003D of the light beam 1003, such that the fourth portion 1003D of the light beam 1003 travels back through the body of the support material 917 to the optical coupling interface 655 for conveyance into the optical fiber(s) 915. In some embodiments, the optical lensing structure 1633 is configured to focus the fourth portion 1003D of the light beam 1003 that is reflected back toward the optical coupling interface 655. In some embodiments, the optical lensing structure 1633 is configured to collimate the fourth portion 1003D of the light beam 1003 that is reflected back toward the optical coupling interface 655. In some embodiments, the optical lensing structure 1633 is configured to both focus and collimate the fourth portion 1003D of the light beam 1003 that is reflected back toward the optical coupling interface 655.

The optical reflector structure 1631 and the optical lensing structure 1633 are collectively configured to work with the optical coupling interface 655 for the optical fiber(s) 915 to provide for conveyance of the light beam 1003 from the PIC die/chip 903 to the optical fiber(s) 915 located on the opposite side of the support material 917 from where the PIC die/chip 903 is located, and vice-versa. It should be understood that the direction of travel of the light beam 1003 can also be reversed, such that the light beam 1003 travels from the optical fiber 915, through the optical coupling interface 655, through the support material 917, and reflects off of the optical lensing structure 1633 back through the support material 917 to the optical coupling interface 655, and reflects off of the optical coupling interface 655 back through the support material 917 to the optical reflector structure 1631, and reflects off the optical reflector structure 1631 toward the optical waveguide 911 or associated optical port/facet of the PIC die/chip 903. In some embodiments, the anti-reflective coating 955 is disposed between the support material 917 and the optical coupling interface component 1501D to facilitate optical conveyance of the light beam 1003 from the optical coupling interface component 1501D into the support material 917, and vice-versa.

The optical reflector structure 1631 has a planar shape that is positioned at an angle relative to the direction of travel of the first portion 1003A of the light beam 1003. The angular position of the optical reflector structure 1631 is set so that the second portion 1003B of the light beam 1003 is directed toward a first target location on the optical coupling interface 655 for the optical fiber(s) 915. Similarly, the optical lensing structure 1633 has a curved shape that is configured and positioned to redirect the third portion 1003C of the light beam into the fourth portion 1003D of the light beam, such that the fourth portion 1003D of the light beam 1003 is directed toward a second target location on the optical coupling interface 655 for the optical fiber(s) 915.

In some embodiments, the optical reflector structure 1631 and/or the optical lensing structure 1633 is configured to function as a mirror to direct light from the PIC die/chip 903 into another optical path through the support material 917 to enable conveyance of the light to the optical fiber 915 located on the opposite side of the support material 917 from where the PIC die/chip 903 is located. In some embodiments, the optical reflector structure 1631 and/or the optical lensing structure 1633 is formed as a metal film. In some embodiments, the optical reflector structure 1631 and/or the optical lensing structure 1633 is formed as a thin film stack. In some embodiments, the optical reflector structure 1631 and/or the optical lensing structure 1633 is formed by coating one or more optically reflective materials onto the optical coupling interface component 1501D.

FIG. 16E shows a vertical cross-section through a photonic system 1640, in accordance with some embodiments. It should be understood that the various components of FIG. 16E are shown schematically at sizes that are not to scale relative to one another in order to facilitate illustration of the various components. The photonic system 1640 of FIG. 16E is a variation of the photonic system 1630 of FIG. 16D. In the photonic system 1630 of FIG. 16D, the cavity 1028 within which the optical coupling interface component 1501D is disposed extends through the full thickness of the PIC die/chip 903, but stops at the support material 917. However, in the photonic system 1640 of FIG. 16E the cavity 1028 within which the optical coupling interface component 1501D is disposed extends through the full thickness of the PIC die/chip 903 and through a portion 1641 of the support material 917. In some embodiments, the portion 1641 of the support material 917 through which the cavity 1028 extends is less than a full thickness of the support material 917. Also, in some embodiments, in the photonic system 1640, the optical coupling interface component 1501D is sized to extend vertically through the entire vertical thickness of the PIC die/chip 903 and into at least a portion of the cavity 1028 formed within the support material 917. The anti-reflective coating 955 is disposed on the surface of the support material 917 within the cavity 1028 within which the optical coupling interface component 1501D is disposed. In the photonic system 1640, the light beam 1003 travels along the same multiple pass route between the optical coupling interface component 1501D and the optical coupling interface 655 for the optical fiber(s) 915 as described with regard to the photonic system 1630 of FIG. 16D.

FIG. 16F shows a vertical cross-section through a photonic system 1650, in accordance with some embodiments. It should be understood that the various components of FIG. 16F are shown schematically at sizes that are not to scale relative to one another in order to facilitate illustration of the various components. The photonic system 1650 is an example embodiment of the photonic system 1500 of FIG. 15. The photonic system 1650 includes the PIC die/chip 903, the support material 917, the optical coupling interface 655 for the optical fiber 915, the RDL 905, the C4 bumps 907, the mold material 909, and the substrate/interposer 921, as described with regard to FIG. 9. An optical coupling interface component 1501E is attached to the PIC die/chip 903 and to the support material 917. The optical coupling interface component 1501E is formed separate from each of the PIC die/chip 903 and the support material 917. The optical coupling interface component 1501E is configured to wrap around a peripheral edge of the support material 917, such that the optical coupling interface component 1501E includes a horizontal portion 1655 and a vertical portion 1657. The horizontal portion 1655 of the optical coupling interface component 1501E is positioned next to the surface 917B of the support material 917 on which the PIC die/chip 903 is disposed. The vertical portion 1657 of the optical coupling interface component 1501E is positioned next to a vertical side surface 917S of the support material 917. In this manner, it should be understood that the optical coupling interface component 1501E is positioned at both a side of the PIC die/chip 903 and a side of the support material 917. Therefore, in the photonic system 1650 it is not necessary to form the cavity 1028/1028A within either the PIC die/chip 903 or the support material 917 to accommodate placement of the optical coupling interface component 1501E, which simplifies overall fabrication of the photonic system 1650. In some embodiments, one or more attachment guide structures, e.g., bonded legs, rib structures, channels/grooves, bumps, etc., are provided on the support material 917 to facilitate proper positioning and alignment of the optical coupling interface component 1501E relative to the PIC die/chip 903. In some embodiments, the optical coupling interface component 1501E is attached to the support material 917 by an adhesive 1653. In some embodiments, the adhesive 1653 is a structural adhesive. Also, in some embodiments, the optical coupling interface component 1501E is attached to the PIC die/chip 903 by the optical index-matching adhesive 1603.

The optical coupling interface component 1501E includes an optical reflector structure 1651 configured to direct the first portion 1003A of the light beam 1003 emanating from the waveguide(s) 911 into the second portion 1003B of the light beam 1003 that passes through the support material 917 to the optical coupling interface 655 for the optical fiber(s) 915 to enable conveyance of the light beam 1003 into to the optical fiber(s) 915. It should be understood that the direction of travel of the light beam 1003 can also be reversed, such that the light beam 1003 travels from the optical fiber 915, through the optical coupling interface 655, through the support material 917, and reflects off of the optical reflector structure 1651 toward the optical waveguide 911 or associated optical port/facet of the PIC die/chip 903. In some embodiments, the anti-reflective coating 955 is disposed between the support material 917 and optical reflector structure 1651 to facilitate optical conveyance of the light beam 1003 from the optical reflector structure 1651 into the support material 917, and vice-versa.

The optical reflector structure 1651 has a planar shape that is positioned at an angle relative to the direction of travel of the first portion 1003A of the light beam 1003. The angular position of the optical reflector structure 1651 is set so that the second portion 1003B of the light beam 1003 is directed toward a target location on the optical coupling interface 655 for the optical fiber(s) 915. In some embodiments, the optical reflector structure 1651 is configured to function as a mirror to direct light from the PIC die/chip 903 into another optical path through the support material 917 to enable conveyance of the light to the optical fiber 915 located on the opposite side of the support material 917 from where the PIC die/chip 903 is located. In some embodiments, the optical reflector structure 1651 is formed as a metal film. In some embodiments, the optical reflector structure 1651 is formed as a thin film stack. In some embodiments, the optical reflector structure 1651 is formed by coating one or more optically reflective materials onto the optical coupling interface component 1501E.

In various embodiments, a photonic system (e.g., 1500, 1600, 1610, 1620, 1630, 1640, 1650) includes the support material 917 having a first surface 917A (top surface) and a second surface 917B (bottom surface). The second surface 917B of the support material 917 is opposite from the first surface 917A of the support material 917 relative to an overall thickness of the support material 917. The PIC die/chip 903 is disposed on the second surface 917B of the support material 917. An opening is formed through the PIC die/chip 903. An optical reflector structure (e.g., 1501, 1501A, 1501B, 1501C, 1501D, 1501E) is disposed within the opening. The optical reflector structure is configured to receive the light beam 1003 traveling in a first direction from the optical waveguide 911 within the PIC die/chip 903, and turn the light beam 1003 into a second direction toward the optical coupling interface 655 for the optical fiber 915 disposed on the first surface 917A of the support material 917, such that the light beam 1003 travels in the first direction from the optical waveguide 911 within the PIC die/chip 903 to the optical reflector structure and in the second direction from the optical reflector structure through the overall thickness of the support material 917 to the optical coupling interface 655 for the optical fiber 915.

In the various embodiments discussed above, at least part of the optical path of the light beam 1003 that goes from the PIC die/chip 903 to the optical coupling interface 655 for the optical fiber 915 extends through the support material 917 for the PIC die/chip 903. In some cases, having the optical path of the light beam 1003 extend through the support material 917 presents challenges due to optical reflections and optical loss at the various interfaces between the support material 917 and one or more other optical components and/or materials. To address these challenges, in some embodiments, an opening is formed through an entire vertical thickness of the support material 917 and the PIC die/chip 903 to provide a more uniform optical path for the light beam 1003 from the PIC die/chip 903 to the optical coupling interface 655 for the optical fiber 915, where the optical path does not pass through the support material 917. In some embodiments, a hole is etched through both the support material 917 and through the PIC die/chip 903 to create an opening between the optical waveguide(s) 911 or associated optical port(s)/facet(s) within the PIC die/chip 903 and the optical coupling interface 655 for the optical fiber(s) 915. In some embodiments, an integrally formed optical coupling interface is formed within the hole to direct the light beam 1003, as needed, from the optical waveguide(s) 911 or associated optical port(s)/facet(s) within the PIC die/chip 903 to the optical coupling interface 655 for the optical fiber(s) 915, and vice-versa. In some embodiments, an externally formed optical coupling interface is attached over and within the hole to direct the light beam 1003, as needed, from the optical waveguide(s) 911 or associated optical port(s)/facet(s) within the PIC die/chip 903 to the optical coupling interface 655 for the optical fiber(s) 915, and vice-versa.

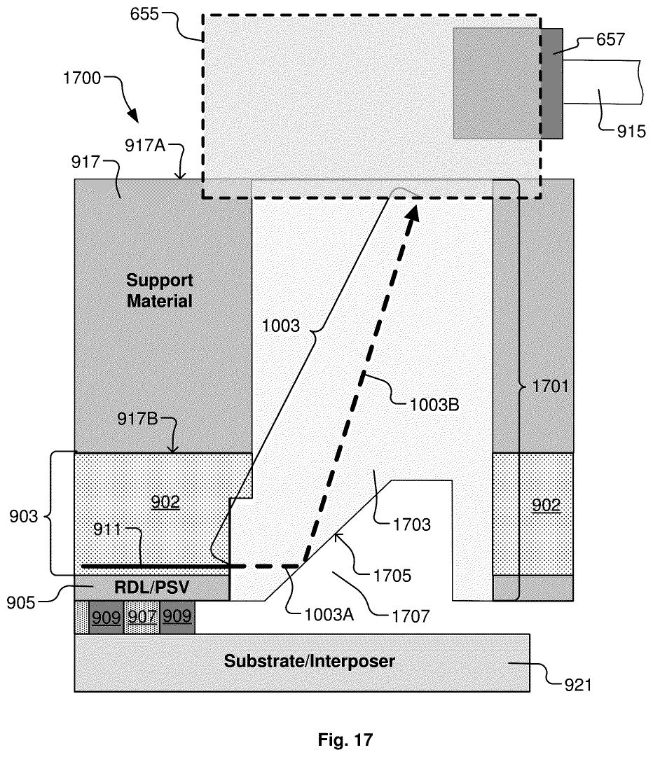

FIG. 17 shows a vertical cross-section through a photonic system 1700, in accordance with some embodiments. It should be understood that the various components of FIG. 17 are shown schematically at sizes that are not to scale relative to one another in order to facilitate illustration of the various components. The photonic system 1700 includes the PIC die/chip 903, the support material 917, the optical coupling interface 655 for the optical fiber 915, the RDL 905, the C4 bumps 907, the substrate/interposer 921, and the mold material 909, as described with regard to FIG. 9. The photonic system 1700 includes an opening 1701 formed through an entire vertical thickness of both the PIC die/chip 903 and the support material 917. In various embodiments, the opening 1701 is formed by one or more semiconductor fabrication and/or packaging processes, such one or more of dry etching, wet etching, plasma-based processing, cutting, drilling, grinding, among other processes. Also, in some embodiments, a lithographic-based process is used to form the opening 1701.

The photonic system 1700 also includes an optical coupling component 1703 integrally formed within the opening 1701. The optical coupling component 1703 includes an optical reflector structure 1705 configured to direct the first portion 1003A of the light beam 1003 emanating from the waveguide(s) 911 of the PIC die/chip 903 into the second portion 1003B of the light beam 1003 that passes through a body of the optical coupling component 1703 to the optical coupling interface 655 for the optical fiber(s) 915 to enable conveyance of the light beam 1003 into to the optical fiber(s) 915. In some embodiments, the optical reflector structure 1705 has a planar shape that is positioned at an angle relative to the direction of travel of the first portion 1003A of the light beam 1003. The angular position of the optical reflector structure 1705 is set so that the second portion 1003B of the light beam 1003 is directed toward a target location on the optical coupling interface 655 for the optical fiber(s) 915. In some embodiments, the optical reflector structure 1705 is configured to function as a mirror to direct light from the PIC die/chip 903 into another optical path to enable conveyance of the light to the optical fiber 915 located on the opposite side of the support material 917 from where the PIC die/chip 903 is located. In some embodiments, the optical reflector structure 1705 is a surface of the optical coupling component 1703 that is exposed to an open space 1707, such that internal optical reflection occurs from the surface of the optical coupling component 1703. In some embodiments, the optical reflector structure 1705 is formed as a metal film. In some embodiments, the optical reflector structure 1705 is formed as a thin film stack. In some embodiments, the optical reflector structure 1705 is formed by coating one or more optically reflective materials onto the optical coupling component 1703. In some embodiments, the optical coupling component 1703 is formed by a transparent resin or epoxy disposed within the opening 1701. In some embodiments, the optical coupling component 1703 is formed using imprint lithography, etching, and/or grayscale lithography, among others. It should be understood that the direction of travel of the light beam 1003 can also be reversed, such that the light beam 1003 travels from the optical fiber 915, through the optical coupling interface 655, through the optical coupling component 1703, and reflects off of the optical reflector structure 1705 toward the optical waveguide 911 or associated optical port/facet of the PIC die/chip 903.

It should be understood that the various configurations of the integrally formed optical coupling interface components for the PIC die/chip 903 as disclosed herein are implementable within photonic systems that have the opening 1701 formed through the entire combined vertical thickness of both the PIC die/chip 903 and the support material 917. Also, it should be understood that the various configurations of the externally formed and attached optical coupling interface components for the PIC die/chip 903 as disclosed herein are implementable within photonic systems that have the opening 1701 formed through the entire combined vertical thickness of both the PIC die/chip 903 and the support material 917.

FIG. 18A shows a vertical cross-section through a photonic system 1800, in accordance with some embodiments. It should be understood that the various components of FIG. 18A are shown schematically at sizes that are not to scale relative to one another in order to facilitate illustration of the various components. The photonic system 1800 includes the PIC die/chip 903, the support material 917, the optical coupling interface 655 for the optical fiber 915, the RDL 905, the C4 bumps 907, the substrate/interposer 921, and the mold material 909, as described with regard to FIG. 9. The photonic system 1800 includes an opening 1801 formed through an entire vertical thickness of both the PIC die/chip 903 and the support material 917. In various embodiments, the opening 1801 is formed by one or more semiconductor fabrication and/or packaging processes, such one or more of dry etching, wet etching, plasma-based processing, cutting, drilling, grinding, among other processes. Also, in some embodiments, a lithographic-based process is used to form the opening 1801.

The photonic system 1800 includes the optical coupling interface component 1501B as described with regard to the photonic system 1610 of FIG. 16B. The optical coupling interface component 1501B is attached to the PIC die/chip 903. The optical coupling interface component 1501B is formed separate from each of the PIC die/chip 903 and the support material 917. The vertical positioning of the optical coupling interface component 1501B relative to the PIC die/chip 903 is controlled by the leg structures 1617. In some embodiments, the optical coupling interface component 1501B is attached to the PIC die/chip 903 by an adhesive. In some embodiments, with the optical coupling interface component 1501B attached to the PIC die/chip 903, a region 1803 within the opening 1801 above the optical coupling interface component 1501B is left open, e.g., empty, air-filled. In some embodiments, with the optical coupling interface component 1501B attached to the PIC die/chip 903, the region 1803 within the opening 1801 above the optical coupling interface component 1501B is filled with a material that provides for optical transmission of the light beam 1003 between the PIC die/chip 903 and the optical coupling interface component 1501B, and that provides for optical transmission of the light beam 1003 between the optical coupling interface component 1501B and the optical coupling interface 655 for the optical fiber 915. In some embodiments, the region 1803 is filled with an optical index-matching adhesive through which the light beam 1003 can travel without disturbance, where the optical index-matching adhesive secures the optical coupling interface component 1501B to the PIC die/chip 903.

The optical reflector structure 1613 of the optical coupling interface component 1501B directs the first portion 1003A of the light beam 1003 emanating from the waveguide(s) 911 into the second portion 1003B of the light beam 1003 that passes through the region 1803 to the optical coupling interface 655 for the optical fiber(s) 915 to enable conveyance of the light beam 1003 into to the optical fiber(s) 915. The angular position of the optical reflector structure 1613 is set so that the second portion 1003B of the light beam 1003 is directed toward a target location on the optical coupling interface 655 for the optical fiber(s) 915. It should be understood that the direction of travel of the light beam 1003 can also be reversed, such that the light beam 1003 travels from the optical fiber 915, through the optical coupling interface 655, through the region 1803, and reflects off of the optical reflector structure 1613 toward the optical waveguide 911 or associated optical port/facet of the PIC die/chip 903.

FIG. 18B shows a vertical cross-section through a photonic system 1810, in accordance with some embodiments. It should be understood that the various components of FIG. 18B are shown schematically at sizes that are not to scale relative to one another in order to facilitate illustration of the various components. The photonic system 1810 includes the PIC die/chip 903, the support material 917, the optical coupling interface 655 for the optical fiber 915, the RDL 905, the C4 bumps 907, the substrate/interposer 921, and the mold material 909, as described with regard to FIG. 9. The photonic system 1810 includes an opening 1811 formed through an entire vertical thickness of both the PIC die/chip 903 and the support material 917. In various embodiments, the opening 1811 is formed by one or more semiconductor fabrication and/or packaging processes, such one or more of dry etching, wet etching, plasma-based processing, cutting, drilling, grinding, among other processes. Also, in some embodiments, a lithographic-based process is used to form the opening 1811.

The photonic system 1810 includes the optical coupling interface component 1501D as described with regard to the photonic system 1630 of FIG. 16D. The optical coupling interface component 1501D is attached to the PIC die/chip 903. The optical coupling interface component 1501D is formed separate from each of the PIC die/chip 903 and the support material 917. The vertical positioning of the optical coupling interface component 1501D relative to the PIC die/chip 903 is controlled by the leg structures 1635. In some embodiments, the optical coupling interface component 1501D is attached to the PIC die/chip 903 by an adhesive. In some embodiments, with the optical coupling interface component 1501D attached to the PIC die/chip 903, a region 1813 within the opening 1811 above the optical coupling interface component 1501D is left open, e.g., empty, air-filled. In some embodiments, with the optical coupling interface component 1501D attached to the PIC die/chip 903, the region 1813 within the opening 1811 above the optical coupling interface component 1501D is filled with a material that provides for optical transmission of the light beam 1003 between the PIC die/chip 903 and the optical coupling interface component 1501D, and that provides for optical transmission of the light beam 1003 between the optical coupling interface component 1501D and the optical coupling interface 655 for the optical fiber 915. In some embodiments, the region 1813 is filled with an optical index-matching adhesive through which the light beam 1003 can travel without disturbance, where the optical index-matching adhesive secures the optical coupling interface component 1501D to the PIC die/chip 903.

The optical coupling interface component 1501D includes both the optical reflector structure 1631 and the optical lensing structure 1633. The optical reflector structure 1631 is configured to direct the first portion 1003A of the light beam 1003 emanating from the waveguide(s) 911 into the second portion 1003B of the light beam 1003 that passes through the region 1813 to the optical coupling interface 655 for the optical fiber(s) 915. The optical coupling interface 655 for the optical fiber(s) 915 is configured to reflect the second portion 1003B of the light beam 1003 into the third portion 1003C of the light beam 1003, such that the third portion 1003C of the light beam 1003 travels back through the region 1813 to the optical lensing structure 1633 of the optical coupling interface component 1501D. The optical lensing structure 1633 is configured to reflect the third portion 1003C of the light beam 1003 into the fourth portion 1003D of the light beam 1003, such that the fourth portion 1003D of the light beam 1003 travels back through the region 1813 to the optical coupling interface 655 for conveyance into the optical fiber(s) 915. In some embodiments, the optical lensing structure 1633 is configured to focus the fourth portion 1003D of the light beam 1003 that is reflected back toward the optical coupling interface 655. In some embodiments, the optical lensing structure 1633 is configured to collimate the fourth portion 1003D of the light beam 1003 that is reflected back toward the optical coupling interface 655. In some embodiments, the optical lensing structure 1633 is configured to both focus and collimate the fourth portion 1003D of the light beam 1003 that is reflected back toward the optical coupling interface 655.

The optical reflector structure 1631 and the optical lensing structure 1633 are collectively configured to work with the optical coupling interface 655 for the optical fiber(s) 915 to provide for conveyance of the light beam 1003 from the PIC die/chip 903 to the optical fiber(s) 915 located on the opposite side of the support material 917 from where the PIC die/chip 903 is located, and vice-versa. It should be understood that the direction of travel of the light beam 1003 can also be reversed, such that the light beam 1003 travels from the optical fiber 915, through the optical coupling interface 655, through the region 1813, and reflects off of the optical lensing structure 1633 back through the region 1813 to the optical coupling interface 655, and reflects off of the optical coupling interface 655 back through the region 1813 to the optical reflector structure 1631, and reflects off the optical reflector structure 1631 toward the optical waveguide 911 or associated optical port/facet of the PIC die/chip 903.

In various embodiments, a photonic system (e.g., 1700, 1800, 1810) includes the support material 917 having a first surface 917A (top surface) and a second surface 917B (bottom surface). The second surface 917B of the support material 917 is opposite from the first surface 917A of the support material 917 relative to an overall thickness of the support material 917. The optical coupling interface 655 for the optical fiber 915 is disposed on the surface 917A of the support material 917. The PIC die/chip 903 is disposed on the surface 917B of the support material 917. An opening (e.g., 1701, 1801, 1811) is formed through both the support material 917 and the PIC die/chip 903. The optical coupling interface 655 for the optical fiber 915 is disposed over the opening on the surface 917A of the support material 917. An optical reflector structure is disposed within the opening. The optical reflector structure is configured to receive the light beam 1003 traveling in a first direction from the optical waveguide 911 within the PIC die/chip 903 and turn the light beam 1003 into a second direction toward the optical coupling interface 655 for the optical fiber 915 disposed on the surface 917A of the support material 917, such that the light beam 1003 travels through the opening to reach the optical coupling interface 655 for the optical fiber 915.

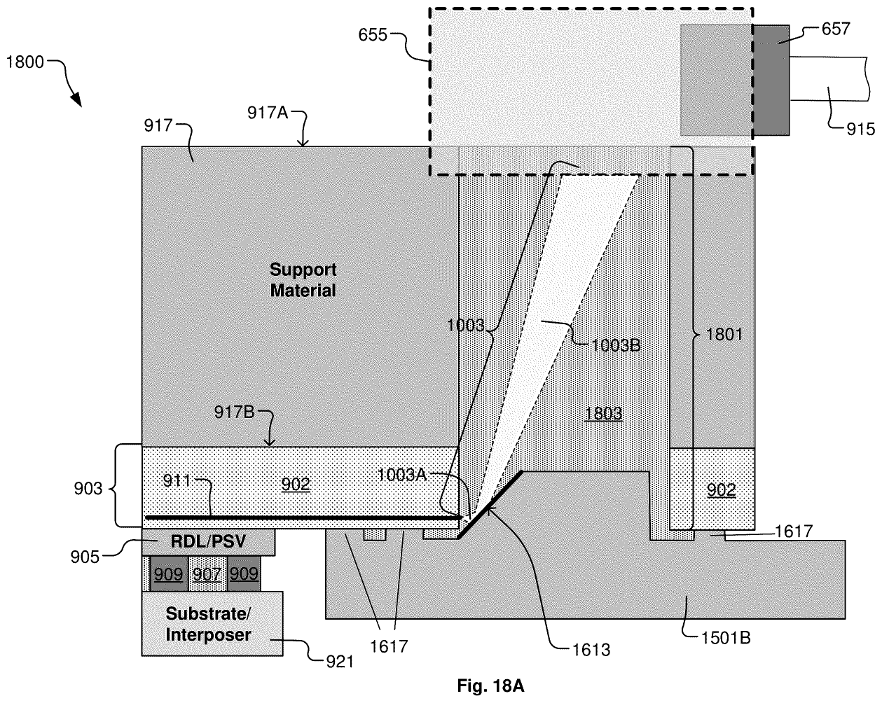

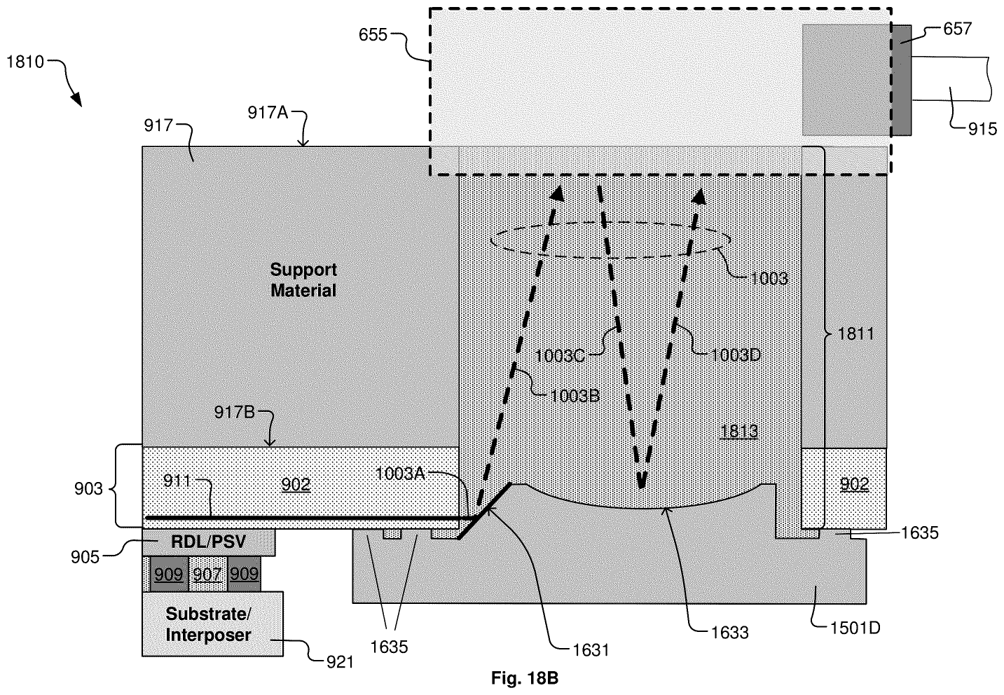

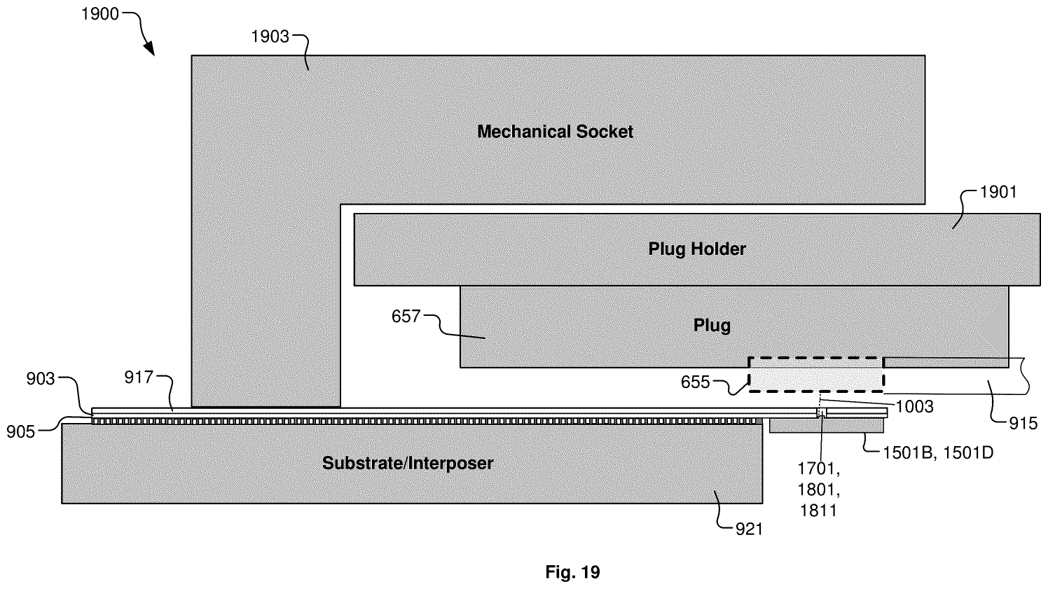

FIG. 19 shows a vertical cross-section through a photonic system 1900, in accordance with some embodiments. The photonic system 1900 generally represents the various components of each of the photonic systems 1700, 1800, and 1810 of FIGS. 17, 18A, and 18B, respectively, at respective sizes that are closer to actual scale with respect to each other, in accordance with some embodiments. The optical fiber(s) 915 and the optical coupling interface 655 for the optical fiber(s) 915 are attached to a plug holder 1901 that is inserted into a mechanical socket 1903. The mechanical socket 1903 and plug holder 1901 are collectively configured to hold the optical coupling interface 655 for the optical fiber(s) 915 at a prescribed position and orientation over the opening 1701, 1801, 1811 formed through both the support material 917 and the PIC die/chip 903.

Many photonic systems have multiple optical coupling waveguide channels or associated optical ports/facets. In various embodiments, the openings that are etched through the backside of support material 917 and the PIC die/chip 903 for the optical path(s) between the optical coupling interface 653 for the PIC die/chip 903 and the optical coupling interface 655 for the optical fiber(s) 915, such as the openings 1701, 1801, 1811 shown in FIGS. 17, 18A, and 18B, respectively, by way of example, are formed as either separate openings for separate optical coupling waveguide channels or associated optical ports/facets, or as one or more larger opening(s) that each encompass multiple (or even all) optical coupling waveguide channels or associated optical ports/facets.

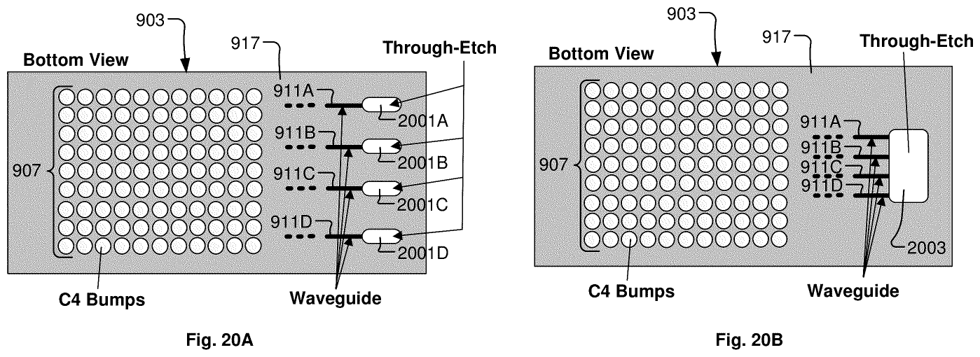

FIG. 20A shows a bottom view of the PIC die/chip 903 to demonstrate formation of separate openings through the PIC die/chip 903 for separate waveguide channels or associated optical ports/facets within the PIC die/chip 903, respectively, in accordance with some embodiments. As shown in FIG. 20A, separate openings 2001A, 2001B, 2001C, 2001D are formed through the PIC die/chip 903 and support material 917 for the separate optical coupling waveguide channels or associated optical ports/facets 911A, 911B, 911C, 911D, respectively. Each of the openings 2001A, 2001B, 2001C, 2001D provides the optical path through which the light beam 1003 travels between the PIC die/chip 903 and the optical coupling interface 655 for the optical fiber(s) 915. It should be understood that each of the openings 2001A, 2001B, 2001C, 2001D represents the openings 1701, 1801, 1811 shown in FIGS. 17, 18A, and 18B. It should be understood that the formation of separate openings through the PIC die/chip 903 and/or through the support material 917 for separate waveguide channels or associated optical ports/facets within the PIC die/chip 903, as illustrated by the example of FIG. 20A, can be equally applied to any of the photonic systems disclosed herein.

FIG. 20B shows a bottom view of the PIC die/chip 903 to demonstrate formation of a larger opening 2003 through the PIC die/chip 903 for multiple waveguide channels or associated optical ports/facets 911A, 911B, 911C, 911D within the PIC die/chip 903, respectively, in accordance with some embodiments. As shown in FIG. 20B, the single larger opening 2003 is formed to encompass multiple optical coupling waveguide channels or associated optical ports/facets 911A, 911B, 911C, 911D to provide corresponding optical paths through which respective light beams 1003 travel between the PIC die/chip 903 and respective optical coupling interfaces 655 for respective optical fibers 915. It should be understood that the formation of a larger opening through the PIC die/chip 903 and/or through the support material 917 for multiple waveguide channels or associated optical ports/facets within the PIC die/chip 903, as illustrated by the example of FIG. 20B, can be equally applied to any of the photonic systems disclosed herein.

In various embodiments, the optical coupling interface 655 for the optical fiber(s) 915 can be implemented in many different ways. In some embodiments, the optical fiber coupling interface 655 includes an optical lens formed on the support material 917 for the PIC die/chip 903. In some embodiments, the light beam 1003 at the optical coupling interface 653, 1501 for the PIC die/chip 903 has an MFD within a range extending from about 3 micrometers to about 15 micrometers. In these embodiments, the light beam 1003 will diverge (spread) as the light beam 1003 travels through the support material 917 for the PIC die/chip 903 to the optical coupling interface 655 for the optical fiber(s) 915. Therefore, the light beam 1003 will be larger at the exterior surface of the support material 917. In some embodiments, an optical lens is implemented at the optical coupling interface 655 for the optical fiber(s) 915 to refocus and/or collimate the light beam 1003 that reaches the exterior surface of the support material 917.

FIG. 21A shows a vertical cross-section through a photonic system 2100, in accordance with some embodiments. It should be understood that the various components of FIG. 21A are shown schematically at sizes that are not to scale relative to one another in order to facilitate illustration of the various components. The photonic system 2100 includes the PIC die/chip 903, the support material 917, the optical coupling interface 653, 1501 for the PIC die/chip 903, the optical coupling interface 655 for the optical fiber 915, the RDL 905, the C4 bumps 907, the substrate/interposer 921, and the mold material 909, as described with regard to FIG. 9. The light beam 1003 is reflected by the optical coupling interface 653, 1501 for the PIC die/chip 903 through the support material 917 to the optical coupling interface 655 for the optical fibers 915. In the photonic system 2100, the optical fibers 915 are connected within a fiber array unit (FAU) 2101 that includes reflecting optics, lensing optics, and/or collimating optics as needed to direct the light beam 1003 from the support material 917 into the optical fibers 915, and vice-versa. In the example of FIG. 21A, the light beam 1003 diverges as it travels from the optical coupling interface 653, 1501 through the support material 917 to the optical coupling interface 655 for the optical fibers 915.

FIG. 21B shows a vertical cross-section through a photonic system 2110, in accordance with some embodiments. It should be understood that the various components of FIG. 21B are shown schematically at sizes that are not to scale relative to one another in order to facilitate illustration of the various components. The photonic system 2110 includes the PIC die/chip 903, the support material 917, the optical coupling interface 653, 1501 for the PIC die/chip 903, the optical coupling interface 655 for the optical fiber 915, the RDL 905, the C4 bumps 907, the substrate/interposer 921, and the mold material 909, as described with regard to FIG. 9. The light beam 1003 is reflected by the optical coupling interface 653, 1501 for the PIC die/chip 903 through the support material 917 to the optical coupling interface 655 for the optical fibers 915. In the photonic system 2110, the optical fibers 915 are connected within an FAU 2111 that includes reflecting optics, lensing optics, and/or collimating optics as needed to direct the light beam 1003 from the support material 917 into the optical fibers 915, and vice-versa. Additionally, in the photonic system 2110, a micro-lens 2113 is formed within the support material 917 at the exterior surface of the support material 917 to provide focusing and/or collimation of the light beam 1003 as it exits the support material 917 traveling toward the optical coupling interface 655 for the optical fibers 915. It should be understood that the micro-lens 2113 is shown by way of example. In various embodiments, essentially any configuration of lensing optical structure and/or collimating optical structure and/or reflecting optical structure can be formed within the support material 917 at the exterior surface of the support material 917 to provide one or more of redirecting, focusing, and collimation of the light beam 1003 as it exits the support material 917 traveling toward the optical coupling interface 655 for the optical fibers 915. In the example of FIG. 21B, the light beam 1003 diverges as it travels from the optical coupling interface 653, 1501 through the support material 917 until reaching the micro-lens 2113. The micro-lens 2113 functions to collimate the light beam 1003 as it exits from the support material 917 and travels to the optical coupling interface 655 for the optical fibers 915.

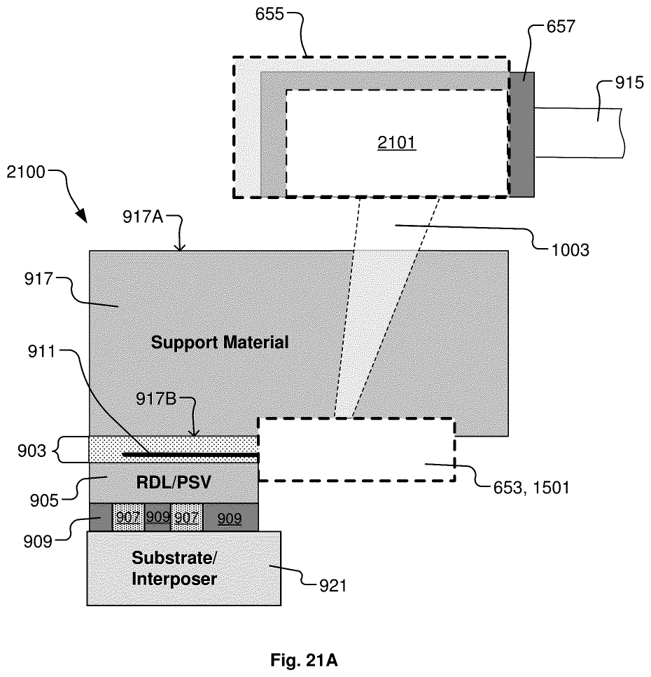

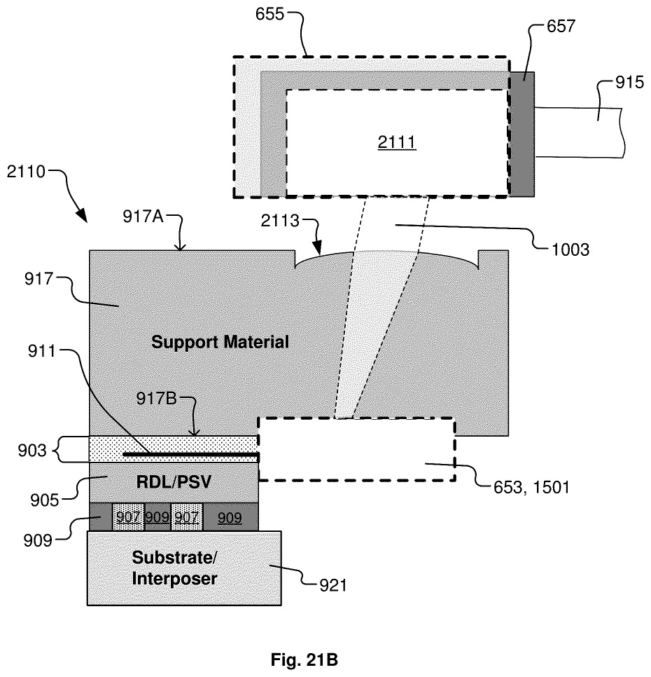

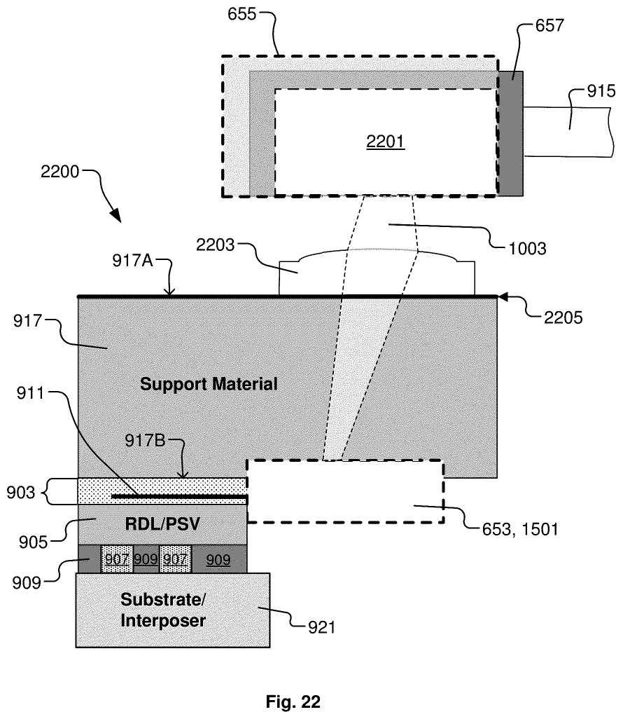

FIG. 22 shows a vertical cross-section through a photonic system 2200, in accordance with some embodiments. It should be understood that the various components of FIG. 22 are shown schematically at sizes that are not to scale relative to one another in order to facilitate illustration of the various components. The photonic system 2200 includes the PIC die/chip 903, the support material 917, the optical coupling interface 653, 1501 for the PIC die/chip 903, the optical coupling interface 655 for the optical fiber 915, the RDL 905, the C4 bumps 907, the substrate/interposer 921, and the mold material 909, as described with regard to FIG. 9. The light beam 1003 is reflected by the optical coupling interface 653, 1501 for the PIC die/chip 903 through the support material 917 to the optical coupling interface 655 for the optical fibers 915. In the photonic system 2200, the optical fibers 915 are connected within an FAU 2201 that includes reflecting optics, lensing optics, and/or collimating optics as needed to direct the light beam 1003 from the support material 917 into the optical fibers 915, and vice-versa. Additionally, in the photonic system 2200, rather than integrating lensing optics and/or collimation optics and/or reflecting optics within the support material 917 itself, an external optical component 2203 is attached to the support material 917 to provide the necessary optical lensing and/or optical collimation and/or redirection of the light beam 1003 as it travels from the support material 917 to the optical coupling interface 655 for the optical fibers 915. In some embodiments, an anti-reflective coating 2205 is disposed on the exterior surface of the support material 917, between the support material 917 and the external optical component 2203, to reduce optical reflections and/or optical losses of the light beam 1003. Also, as previously discussed, in some embodiments, the anti-reflective coating 955 is disposed between the optical coupling interface 653, 1501 for the PIC die/chip 903 and the support material 917 to facilitate optical conveyance of the light beam 1003 into the support material 917. In the example of FIG. 22, the light beam 1003 diverges as it travels from the optical coupling interface 653, 1501 through the support material 917 until reaching the external optical component 2203. The external optical component 2203 functions to focus the light beam 1003 as it travels to the optical coupling interface 655 for the optical fibers 915. It should be understood that the external optical component 2203 is shown by way of example. In various embodiments, the external optical component 2203 can be configured to provide essentially any type of optical lensing, optical collimation, and/or optical redirection of the light beam 1003, as needed, to provide for proper conveyance of the light beam 1003 into the optical coupling interface 655 for the optical fibers 915.

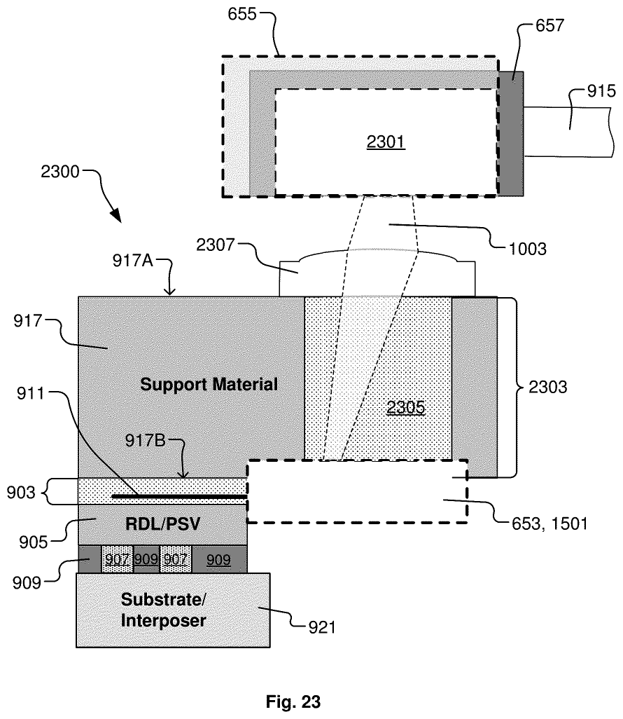

FIG. 23 shows a vertical cross-section through a photonic system 2300, in accordance with some embodiments. It should be understood that the various components of FIG. 23 are shown schematically at sizes that are not to scale relative to one another in order to facilitate illustration of the various components. The photonic system 2300 includes the PIC die/chip 903, the support material 917, the optical coupling interface 653, 1501 for the PIC die/chip 903, the optical coupling interface 655 for the optical fiber 915, the RDL 905, the C4 bumps 907, the substrate/interposer 921, and the mold material 909, as described with regard to FIG. 9. In the photonic system 2300, an opening 2303 is formed through the entire vertical thickness of the support material 917, with the optical path of the light beam 1003 being directed through the opening 2303 by the optical coupling interface 653, 1501 for the PIC die/chip 903. In the photonic system 2300, the optical fibers 915 are connected within an FAU 2301 that includes reflecting optics, lensing optics, and/or collimating optics as needed to direct the light beam 1003 received from the opening 2303 into the optical fibers 915, and vice-versa. It should be understood that the opening 2303 provides for conveyance of the light beam 1003 between the PIC die/chip 903 and the optical coupling interface 655 for the optical fiber 915 without having the light beam 1003 cross an interface of the support material 917. Also, it should be appreciated that because the light beam 1003 does not cross an interface of the support material 917 in the photonic system 2300, it is not necessary to dispose the anti-reflective coating on the support material 917 in the photonic system 2300. In some embodiments, a region 2305 within the opening is left empty, e.g., filled with air. In some embodiments, the region 2305 within the opening 2303 is filled with a material that is transparent to the light beam 1003. In some embodiments, an external optical component 2307 is attached to the support material 917 over the opening 2303 to provide the necessary optical lensing and/or optical collimation and/or redirection of the light beam 1003 as it travels from the PIC die/chip 903 to the optical coupling interface 655 for the optical fibers 915. In some embodiments, one or more optical component(s) are positioned within the opening 2303 to provide at least some of the necessary optical lensing and/or optical collimation and/or redirection of the light beam 1003 as it travels from the PIC die/chip 903 to the optical coupling interface 655 for the optical fibers 915. In the example of FIG. 23, the light beam 1003 diverges as it travels from the optical coupling interface 653, 1501 through the opening 2303 until reaching the external optical component 2307. The external optical component 2307 functions to focus the light beam 1003 as it travels to the optical coupling interface 655 for the optical fibers 915. It should be understood that the external optical component 2307 is shown by way of example. In various embodiments, the external optical component 2307 can be configured to provide essentially any type of optical lensing, optical collimation, and/or optical redirection of the light beam 1003, as needed, to provide for proper conveyance of the light beam 1003 into the optical coupling interface 655 for the optical fibers 915. Also, in some embodiments, the external optical component 2307 is configured to function as a cover for the opening 2303 to prevent intrusion of undesirable material into the region 2305 within the opening 2303, where the undesirable material may adversely affect propagation of the light beam 1003.

FIG. 24A shows a vertical cross-section through a photonic system 2400, in accordance with some embodiments. The photonic system 2400 includes the PIC die/chip 903, the support material 917, the optical coupling interface 653, 1501 for the PIC die/chip 903, the optical coupling interface 655 for the optical fiber 915, the RDL 905, the C4 bumps 907, the substrate/interposer 921, and the mold material 909, as described with regard to FIG. 9. FIG. 24B shows a top view of the photonic system 2400, in accordance with some embodiments. It should be understood that the various components of FIGS. 24A and 24B are shown schematically at sizes that are not to scale relative to one another in order to facilitate illustration of the various components. In the photonic system 2400, a mechanical socket 2401 and a plug 2403 are collectively implemented at the exterior surface of the support material 917 to receive and securely hold the optical coupling interface 655 and the optical fibers 915 is a fixed spatial relationship with respect to the PIC die/chip 903 and the support material 917. Because the optical coupling interface 655 for the optical fiber 915 is located at the exterior surface of the support material 917 for the PIC die/chip 903 and away from the optical coupling interface 653, 1501 for the PIC die/chip 903, there is sufficient space for implementing the larger mechanical socket 2401 and plug 2403 assembly to enable pluggable optic packaging solutions. Also, it should be understood and appreciated that implementation of the larger mechanical socket 2401 and plug 2403 assembly at the exterior surface of the support material 917 for the PIC die/chip 903 avoids physical interference between the mechanical socket 2401 and structures underlying the support material 917 within the PIC die/chip 903 packaging configuration, such as the RDL 905, the C4 bumps 907, and/or the substrate/interposer 921. Also, in some embodiments, the optical fiber 915 or corresponding FAU is disposed/connected within a mechanical enclosure located exterior to the support material 917 for the PIC die/chip 903, which avoids having the optical fiber or FAU directly bonded onto the oxide stack 902 of the PIC die/chip 903.

In some embodiments, the plug 2403 that plugs into the mechanical socket 2401 is configured to include the optical coupling interface 655 for the optical fiber 915. For example, in some embodiments, the plug 2403 includes one or more optical component(s) to provide for efficient optical coupling of the optical fiber 915 with the optical path of the light beam 1003 conveyed from the PIC die/chip 903. In various embodiments, the optical coupling interface 655 implemented within the plug 2403 includes one or more lens(es) and/or one or more mirror(s) to focus and/or collimate the light beam 1003 to achieve optimal conveyance of the light beam 1003 into the optical fiber 915.

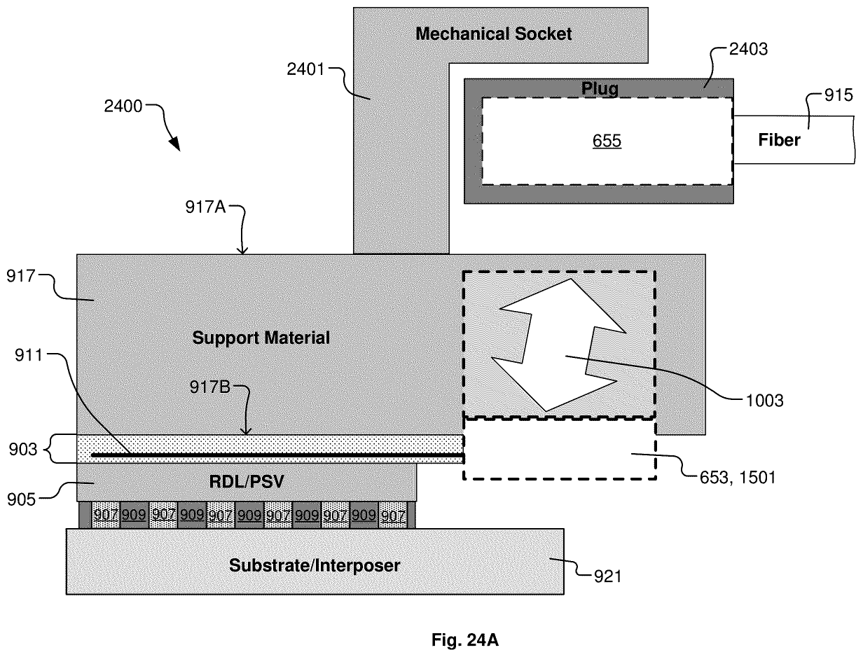

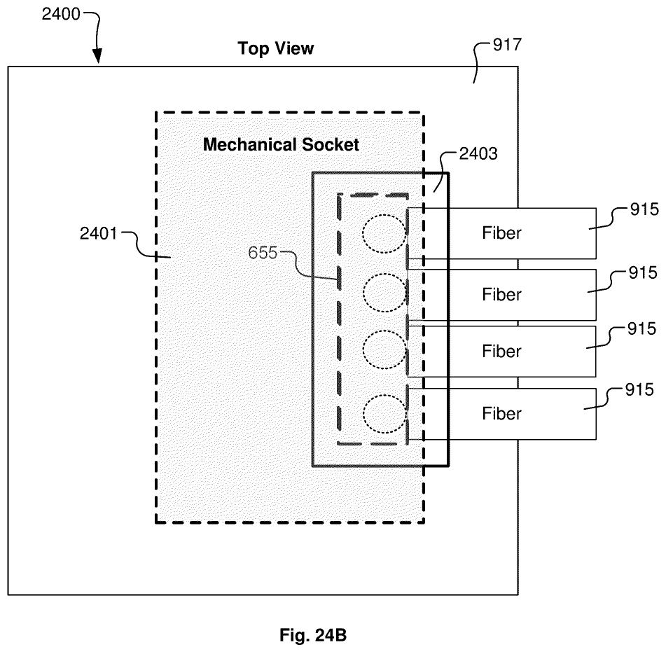

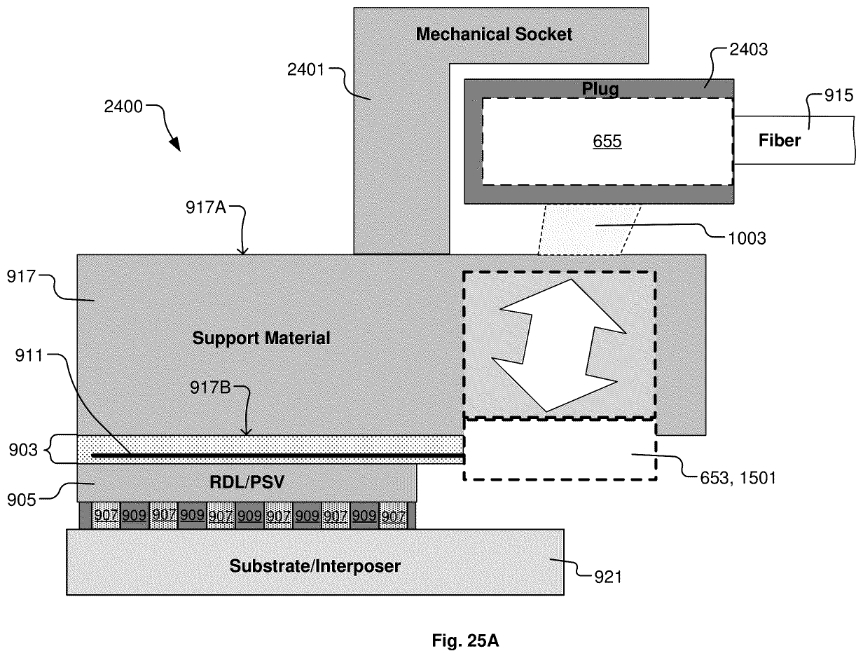

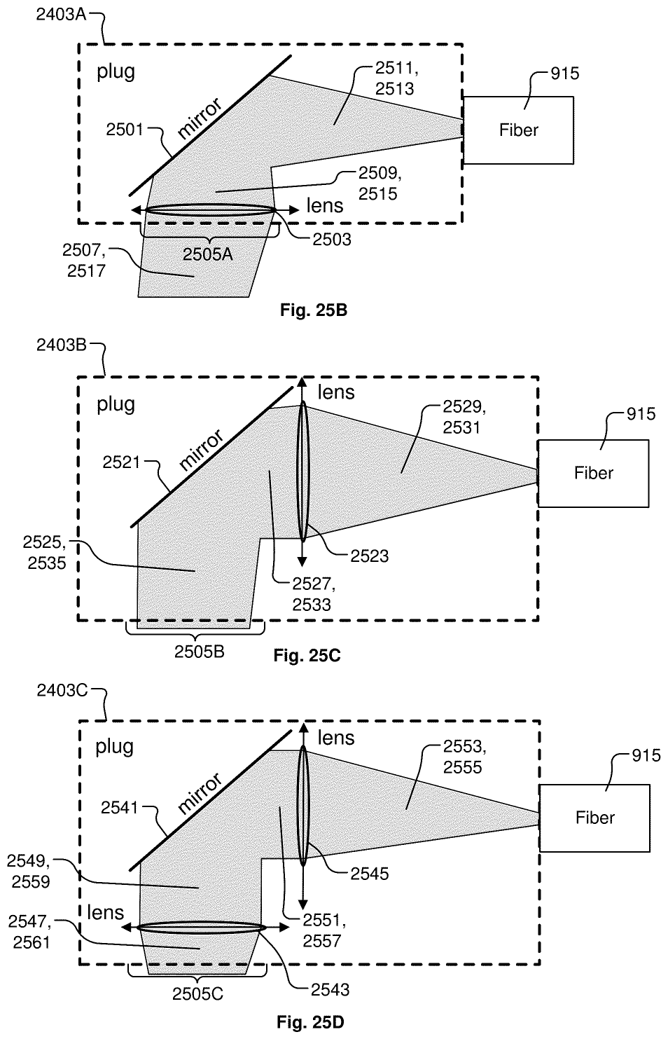

FIG. 25A shows the vertical cross-section through the photonic system 2400, with the light beam 1003 having a diverging shape as it enters the optical coupling interface 655 for the optical fiber 915, in accordance with some embodiments. The optical coupling interface 655 for the optical fiber 915 is implemented within the plug 2403 and includes one or more mirror(s) and/or one or more lens(es).

FIG. 25B shows a vertical cross-section of a plug 2403A that can be implemented as the plug 2403 of FIG. 25A, in accordance with some embodiments. The plug 2403A includes a mirror structure 2501 and a lens structure 2503. The lens structure 2503 is positioned between an optical port 2505A of the plug 2403A and the mirror structure 2501. The optical port 2505A of the plug 2403A is positioned to receive a diverging portion 2507 of the light beam 1003 from the PIC die/chip 903. As the diverging portion 2507 of the light beam 1003 enters through the optical port 2505A of the plug 2403A, the diverging portion 2507 of the light beam 1003 travels through the lens structure 2503. The lens structure 2503 is configured to focus the diverging portion 2507 of the light beam 1003 into a converging portion 2509 of the light beam 1003 and direct the converging portion 2509 of the light beam 1003 toward the mirror structure 2501. The mirror structure 2501 is configured and oriented to reflect the converging portion 2509 of the light beam 1003 into a converging portion 2511 of the light beam 1003 that is directed into the core of the optical fiber 915.

Also, with the light beam 1003 traveling in the opposite direction, i.e., from the optical fiber 915 to the PIC die/chip 903, a diverging portion 2513 of the light beam 1003 travels from the core of the optical fiber 915 to the mirror structure 2501. The mirror structure 2501 is configured and oriented to reflect the diverging portion 2513 of the light beam 1003 into a diverging portion 2515 of the light beam 1003 that is directed into the lens structure 2503. The lens structure 2503 is configured to focus the diverging portion 2515 of the light beam 1003 into a converging portion 2517 of the light beam 1003 that is output from the optical port 2505A of the plug 2403A toward the optical coupling interface 653, 1501 for the PIC die/chip 903.

FIG. 25C shows a vertical cross-section of a plug 2403B that can be implemented as the plug 2403 of FIG. 25A, in accordance with some embodiments. The plug 2403B includes a mirror structure 2521 and a lens structure 2523. An optical port 2505B of the plug 2403B is positioned to receive a diverging portion 2525 of the light beam 1003 from the PIC die/chip 903. As the diverging portion 2525 of the light beam 1003 enters through the optical port 2505B of the plug 2403A, the diverging portion 2525 of the light beam 1003 travels to the mirror structure 2521. The mirror structure 2521 is configured and oriented to reflect the diverging portion 2525 of the light beam 1003 into a diverging portion 2527 of the light beam 1003 that is directed through the lens structure 2523. The lens structure 2523 is positioned between the mirror structure 2521 and the optical fiber 915. The lens structure 2523 is configured to focus the diverging portion 2527 of the light beam 1003 into a converging portion 2529 of the light beam 1003 and direct the converging portion 2529 of the light beam 1003 toward the core of the optical fiber 915.

Also, with the light beam 1003 traveling in the opposite direction, i.e., from the optical fiber 915 to the PIC die/chip 903, a diverging portion 2531 of the light beam 1003 travels from the core of the optical fiber 915 to the lens structure 2523. The lens structure 2523 is configured to focus the diverging portion 2531 of the light beam 1003 into a converging portion 2533 of the light beam 1003 that is directed to the mirror structure 2521. The mirror structure 2521 is configured and oriented to reflect the converging portion 2533 of the light beam 1003 into a converging portion 2535 of the light beam 1003 that is directed through the optical port 2505B of the plug 2403B toward the optical coupling interface 653, 1501 for the PIC die/chip 903.

FIG. 25D shows a vertical cross-section of a plug 2403C that can be implemented as the plug 2403 of FIG. 25A, in accordance with some embodiments. The plug 2403C includes a mirror structure 2541, a first lens structure 2543, and a second lens structure 2545. The first lens structure 2543 is positioned between an optical port 2505C of the plug 2403A and the mirror structure 2541. The optical port 2505C of the plug 2403C is positioned to receive a diverging portion 2547 of the light beam 1003 from the PIC die/chip 903. As the diverging portion 2547 of the light beam 1003 enters through the optical port 2505C of the plug 2403A, the diverging portion 2547 of the light beam 1003 travels through the first lens structure 2543. The first lens structure 2543 is configured to focus the diverging portion 2547 of the light beam 1003 into a collimated portion 2549 of the light beam 1003 and direct the collimated portion 2549 of the light beam 1003 toward the mirror structure 2541. The mirror structure 2541 is configured and oriented to reflect the collimated portion 2549 of the light beam 1003 into a collimated portion 2551 of the light beam 1003 that is directed through the second lens structure 2545. The second lens structure 2545 is positioned between the mirror structure 2541 and the optical fiber 915. The second lens structure 2545 is configured to focus the collimated portion 2551 of the light beam 1003 into a converging portion 2553 of the light beam 1003 and direct the converging portion 2553 of the light beam 1003 toward the core of the optical fiber 915.

Also, with the light beam 1003 traveling in the opposite direction, i.e., from the optical fiber 915 to the PIC die/chip 903, a diverging portion 2555 of the light beam 1003 travels from the core of the optical fiber 915 to the second lens structure 2545. The second lens structure 2545 is configured to focus the diverging portion 2555 of the light beam 1003 into a collimated portion 2557 of the light beam 1003 that is directed to the mirror structure 2541. The mirror structure 2541 is configured and oriented to reflect the collimated portion 2557 of the light beam 1003 into a collimated portion 2559 of the light beam 1003 that is directed through the first lens structure 2543. The first lens structure 2543 is configured to focus the collimated portion 2559 of the light beam 1003 into a converging portion 2561 of the light beam 1003 that is output from the optical port 2505C of the plug 2403C toward the optical coupling interface 653, 1501 for the PIC die/chip 903.

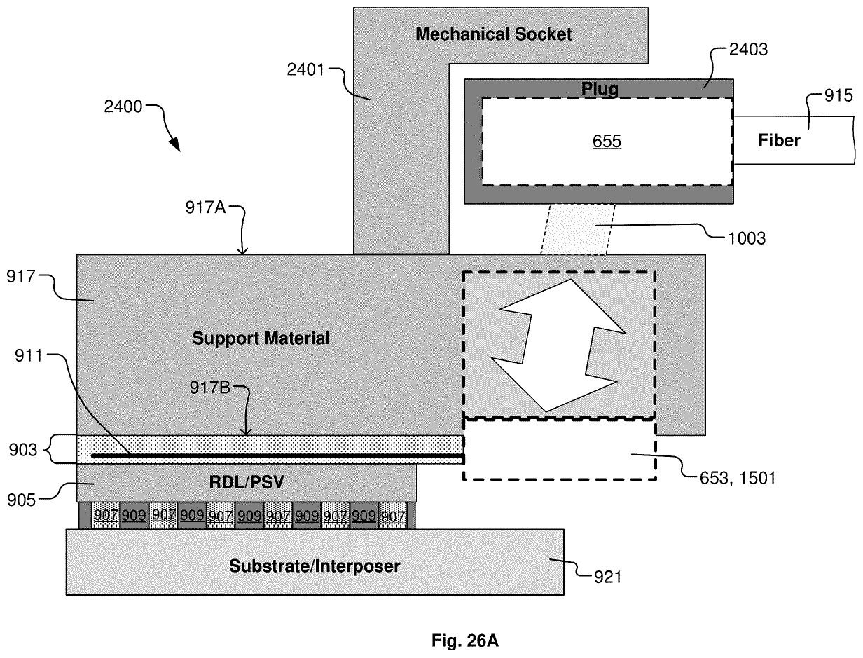

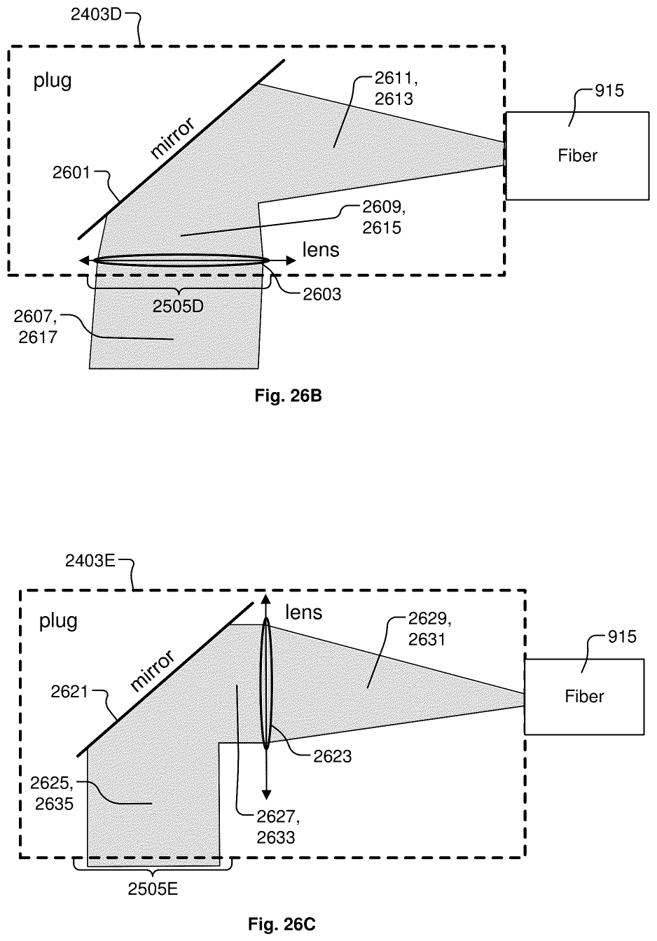

FIG. 26A shows the vertical cross-section through the photonic system 2400, with the light beam 1003 having a collimated shape as it enters the optical coupling interface 655 for the optical fiber 915, in accordance with some embodiments. The optical coupling interface 655 for the optical fiber 915 is implemented within the plug 2403 and includes one or more mirror(s) and/or one or more lens(es).

FIG. 26B shows a vertical cross-section of a plug 2403D that can be implemented as the plug 2403 of FIG. 26A to work with the light beam 1003 having the collimated shape as it enters the optical coupling interface 655 for the optical fiber 915, in accordance with some embodiments. The plug 2403D includes a mirror structure 2601 and a lens structure 2603. The lens structure 2603 is positioned between an optical port 2505D of the plug 2403D and the mirror structure 2601. The optical port 2505D of the plug 2403D is positioned to receive a collimated portion 2607 of the light beam 1003 from the PIC die/chip 903. As the collimated portion 2607 of the light beam 1003 enters through the optical port 2505D of the plug 2403D, the collimated portion 2607 of the light beam 1003 travels through the lens structure 2603. The lens structure 2603 is configured to focus the collimated portion 2607 of the light beam 1003 into a converging portion 2609 of the light beam 1003 and direct the converging portion 2609 of the light beam 1003 toward the mirror structure 2601. The mirror structure 2601 is configured and oriented to reflect the converging portion 2609 of the light beam 1003 into a converging portion 2611 of the light beam 1003 that is directed into the core of the optical fiber 915.

Also, with the light beam 1003 traveling in the opposite direction, i.e., from the optical fiber 915 to the PIC die/chip 903, a diverging portion 2613 of the light beam 1003 travels from the core of the optical fiber 915 to the mirror structure 2601. The mirror structure 2601 is configured and oriented to reflect the diverging portion 2613 of the light beam 1003 into a diverging portion 2615 of the light beam 1003 that is directed into the lens structure 2603. The lens structure 2603 is configured to focus the diverging portion 2615 of the light beam 1003 into a collimated portion 2617 of the light beam 1003 that is output from the optical port 2505D of the plug 2403D toward the optical coupling interface 653, 1501 for the PIC die/chip 903.

FIG. 26C shows a vertical cross-section of a plug 2403E that can be implemented as the plug 2403 of FIG. 26A to work with the light beam 1003 having the collimated shape as it enters the optical coupling interface 655 for the optical fiber 915, in accordance with some embodiments. The plug 2403E includes a mirror structure 2621 and a lens structure 2623. An optical port 2505E of the plug 2403E is positioned to receive a collimated portion 2625 of the light beam 1003 from the PIC die/chip 903. As the collimated portion 2625 of the light beam 1003 enters through the optical port 2505E of the plug 2403E, the collimated portion 2625 of the light beam 1003 travels to the mirror structure 2621. The mirror structure 2621 is configured and oriented to reflect the collimated portion 2625 of the light beam 1003 into a collimated portion 2627 of the light beam 1003 that is directed through the lens structure 2623. The lens structure 2623 is positioned between the mirror structure 2621 and the optical fiber 915. The lens structure 2623 is configured to focus the collimated portion 2627 of the light beam 1003 into a converging portion 2629 of the light beam 1003 and direct the converging portion 2629 of the light beam 1003 toward the core of the optical fiber 915.

Also, with the light beam 1003 traveling in the opposite direction, i.e., from the optical fiber 915 to the PIC die/chip 903, a diverging portion 2631 of the light beam 1003 travels from the core of the optical fiber 915 to the lens structure 2623. The lens structure 2623 is configured to focus the diverging portion 2631 of the light beam 1003 into a collimated portion 2633 of the light beam 1003 that is directed to the mirror structure 2621. The mirror structure 2621 is configured and oriented to reflect the collimated portion 2633 of the light beam 1003 into a collimated portion 2635 of the light beam 1003 that is directed through the optical port 2505E of the plug 2403E toward the optical coupling interface 653, 1501 for the PIC die/chip 903.

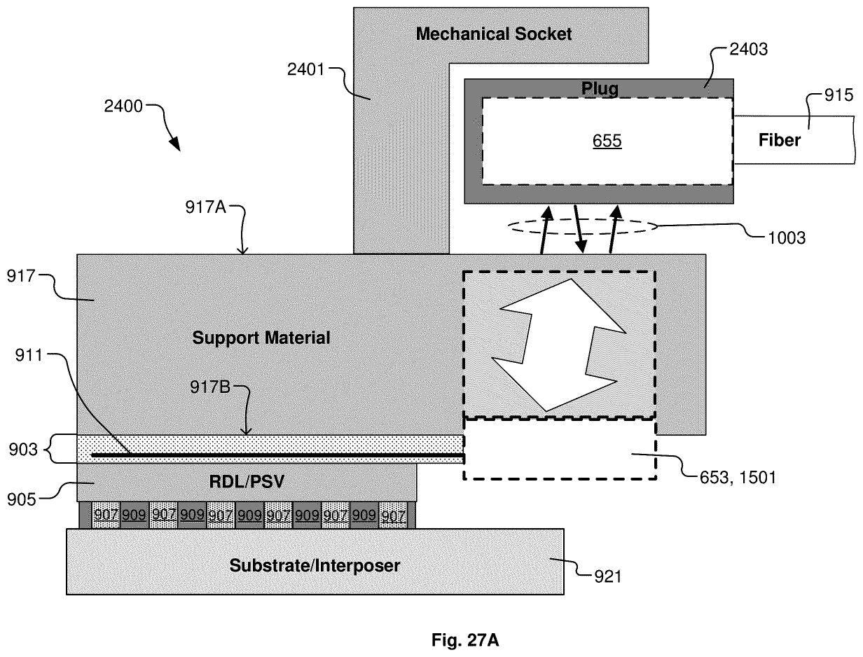

FIG. 27A shows the vertical cross-section through the photonic system 2400, with the light beam 1003 making multiple passes between the optical coupling interface 653, 1501 for the PIC die/chip 903 and the optical coupling interface 655 for the optical fiber 915, in accordance with some embodiments. The optical coupling interface 655 for the optical fiber 915 is implemented within the plug 2403 and includes one or more mirror(s) and/or one or more lens(es) configured to direct the multiple passes of the light beam 1003 between the optical coupling interface 653, 1501 for the PIC die/chip 903 and the optical coupling interface 655 for the optical fiber 915.

FIG. 27B shows a vertical cross-section of a plug 2403F that can be implemented as the plug 2403 of FIG. 27A to direct the multiple passes of the light beam 1003 between the optical coupling interface 653, 1501 for the PIC die/chip 903 and the optical coupling interface 655 for the optical fiber 915, in accordance with some embodiments. The plug 2403F includes a parabolic mirror structure 2701 and a planar mirror structure 2703. The plug 2403F includes a first optical port 2713, a second optical port 2715, and a third optical port 2717. In some embodiments, the first optical port 2713, the second optical port 2715, and the third optical port 2717 are physically separated from each other within the plug 2403F by an intervening non-optical-port portion of the plug 2403F. In some embodiments, two or more of the first optical port 2713, the second optical port 2715, and the third optical port 2717 are collectively formed as respective portions of a single large optical port. A first portion 2705 of the light beam 1003 enters through the first optical port 2713 and is incident upon the parabolic mirror structure 2701. The parabolic mirror structure 2701 reflects the first portion 2705 of the light beam 1003 into a second portion 2707 of the light beam 1003 that is directed toward and out of the second optical port 2715. The second portion 2707 of the light beam 1003 travels to the optical coupling interface 653, 1501 for the PIC die/chip 903, which reflects the second portion 2707 of the light beam 1003 into a third portion 2709 of the light beam 1003 that is directed toward the third optical port 2717 of the plug 2403F. The third portion 2709 of the light beam 1003 enters through the third optical port 2717 and is incident upon the planar mirror structure 2703. The planar mirror structure 2703 reflects the third portion 2709 of the light beam 1003 into a fourth portion 2711 of the light beam 1003 that is directed into the core of the optical fiber 915.

FIG. 27C shows the light beam 1003 traveling in the opposite direction through the plug 2403F, i.e., from the optical fiber 915 to the PIC die/chip 903, in accordance with some embodiments. A first portion 2721 of the light beam 1003 enters the plug 2403F from the optical fiber 915. The first portion 2721 of the light beam 1003 is incident upon the planar mirror structure 2703, which reflects the first portion 2721 of the light beam 1003 into a second portion 2723 of the light beam 1003 that is directed toward the third optical port 2717 of the plug 2403F. The second portion 2723 of the light beam 1003 travels to the optical coupling interface 653, 1501 for the PIC die/chip 903, which reflects the second portion 2723 of the light beam 1003 into a third portion 2725 of the light beam 1003 that is directed toward the second optical port 2715 of the plug 2403F. Upon entering the plug 2403F through the second optical port 2715, the third portion 2725 of the light beam 1003 is incident upon the parabolic mirror structure 2701. The parabolic mirror structure 2701 reflects the third portion 2725 of the light beam 1003 into a fourth portion 2727 of the light beam 1003 that is directed toward and out of the first optical port 2713. The fourth portion 2727 of the light beam 1003 travels to the optical coupling interface 653, 1501 for the PIC die/chip 903, which reflects the fourth portion 2727 of the light beam 1003 into the waveguide 911 or associate optical port/facet of the PIC die/chip 903.

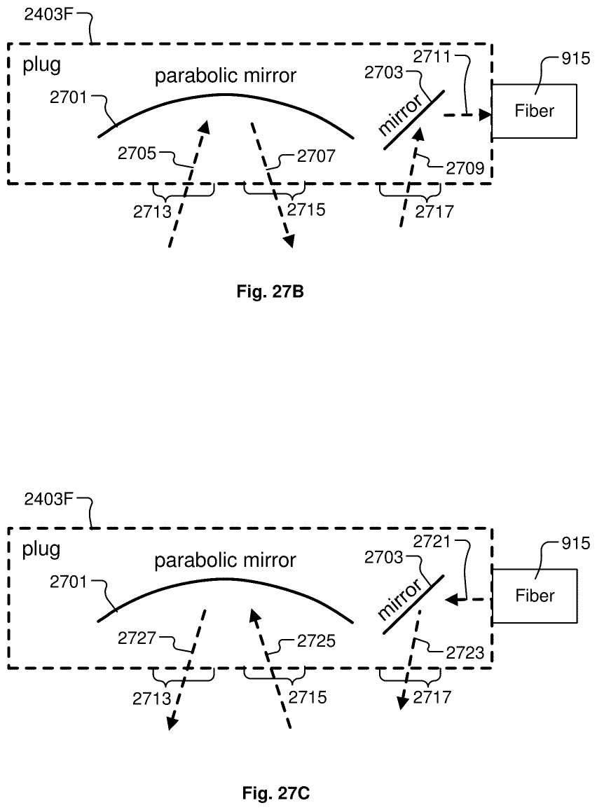

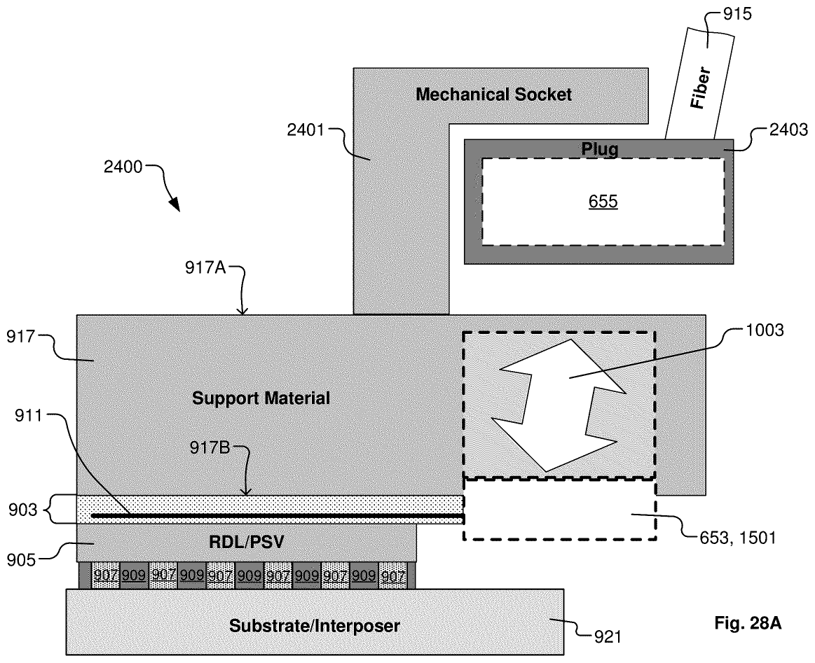

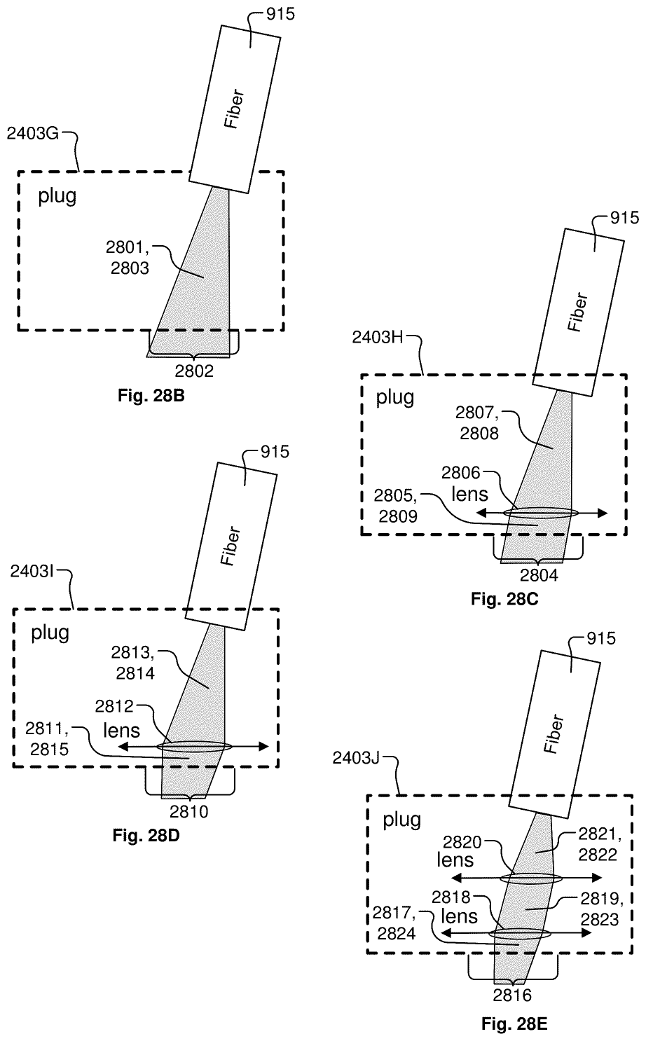

FIG. 28A shows the vertical cross-section through the photonic system 2400, with the plug 2403 configured to have the optical fiber 915 attached to a top surface of the plug 2403, such that a centerline of a core of the optical fiber 915 is oriented toward the surface 917A of the support material 917 underlying the plug 2403, in accordance with some embodiments. In some embodiments, the optical fiber 915 is attached to the plug 2403, such that the centerline of the core of the optical fiber 915 is oriented non-perpendicular to the surface 917A of the support material 917. In some embodiments, the optical fiber 915 is attached to the plug 2403, such that the centerline of the core of the optical fiber 915 is oriented substantially perpendicular to the surface 917A of the support material 917.

FIG. 28B shows a vertical cross-section of a plug 2403G that can be implemented as the plug 2403 of FIG. 28A, in accordance with some embodiments. The optical fiber 915 is attached to the top surface of the plug 2403G such that the centerline of the core of the optical fiber 915 is directed toward the surface 917A of the support material 917 underlying the plug 2403G. The plug 2403G includes an optical port 2802 configured to receive a non-collimated beam of light 2801 (converging beam of light 2801 in this example) from the optical coupling interface 653, 1501 for the PIC die/chip 903. The non-collimated beam of light 2801 passes through the plug 2403G and into the core of the optical fiber 915. Conversely, light conveyed out of the optical fiber 915 is transmitted as a non-collimated beam of light 2803 (diverging beam of light 2803 in this example) through the plug 2403G and out of the optical port 2802 toward the optical coupling interface 653, 1501 for the PIC die/chip 903.

FIG. 28C shows a vertical cross-section of a plug 2403H that can be implemented as the plug 2403 of FIG. 28A, in accordance with some embodiments. The optical fiber 915 is attached to the top surface of the plug 2403H such that the centerline of the core of the optical fiber 915 is directed toward the surface 917A of the support material 917 underlying the plug 2403H. The plug 2403H includes an optical port 2804 configured to receive a collimated beam of light 2805 from the optical coupling interface 653, 1501 for the PIC die/chip 903. The plug 2403H includes a lens structure 2806 through which the collimated beam of light 2805 is directed. The lens structure 2806 is configured to focus the collimated beam of light 2805 into a converging beam of light 2807 and direct the converging beam of light 2807 into the core of the optical fiber 915. Conversely, light is conveyed out of the optical fiber 915 as a diverging beam of light 2808 directed to the lens structure 2806. The lens structure 2806 is configured to collimate the diverging beam of light 2808 into a collimated beam of light 2809 that is directed through the optical port 2804 and toward the optical coupling interface 653, 1501 for the PIC die/chip 903.

FIG. 28D shows a vertical cross-section of a plug 2403I that can be implemented as the plug 2403 of FIG. 28A, in accordance with some embodiments. The optical fiber 915 is attached to the top surface of the plug 2403I such that the centerline of the core of the optical fiber 915 is directed toward the surface 917A of the support material 917 underlying the plug 2403I. The plug 2403I includes an optical port 2810 configured to receive a diverging beam of light 2811 from the optical coupling interface 653, 1501 for the PIC die/chip 903. The plug 2403I includes a lens structure 2812 through which the diverging beam of light 2811 is directed. The lens structure 2812 is configured to focus the diverging beam of light 2811 into a converging beam of light 2813 and direct the converging beam of light 2813 into the core of the optical fiber 915. Conversely, light is conveyed out of the optical fiber 915 as a diverging beam of light 2814 that is directed to the lens structure 2812. The lens structure 2812 is configured to focus the diverging beam of light 2814 into a converging beam of light 2815 that is directed through the optical port 2810 and toward the optical coupling interface 653, 1501 for the PIC die/chip 903.

FIG. 28E shows a vertical cross-section of a plug 2403J that can be implemented as the plug 2403 of FIG. 28A, in accordance with some embodiments. The optical fiber 915 is attached to the top surface of the plug 2403J such that the centerline of the core of the optical fiber 915 is directed toward the surface 917A of the support material 917 underlying the plug 2403J. The plug 2403J includes an optical port 2816 configured to receive a diverging beam of light 2817 from the optical coupling interface 653, 1501 for the PIC die/chip 903. The plug 2403J includes a first lens structure 2818 through which the diverging beam of light 2817 is directed. The lens structure 2818 is configured to collimate the diverging beam of light 2817 into a collimated beam of light 2819 and direct the collimated beam of light 2819 to a second lens structure 2820. The second lens structure 2820 is configured to focus the collimated beam of light 2819 into a converging beam of light 2821 and direct the converging beam of light 2821 into the core of the optical fiber 915. Conversely, light is conveyed out of the optical fiber 915 as a diverging beam of light 2822 that is directed to the second lens structure 2820. The second lens structure 2820 is configured to collimate the diverging beam of light 2822 into a collimated beam of light 2823 and direct the collimated beam of light 2823 to the first lens structure 2818. The first lens structure 2818 is configured to focus the collimated beam of light 2823 into a converging beam of light 2824 and direct the converging beam of light 2824 through the optical port 2816 and toward the optical coupling interface 653, 1501 for the PIC die/chip 903.

It should be understood that the plugs 2403A through 2403J are provided by way of example. In various embodiments, the plug 2403 can be configured to include any combination of optical components as needed to convey the light beam 1003 from the PIC die/chip 903 into the core of the optical fiber 915, and vice-versa. In various embodiments, the plug 2403 can be configured to include any combination of optical components as needed to accommodate any attachment position of the optical fiber 915 to the plug 2403 and any orientation of the optical fiber 915 relative to the plug 2403. In various embodiments, the plug 2403 includes one or more of a mirror structure (planar, parabolic, etc.), a lens structure (focusing, diverging, collimating, etc.), an optical filter component (polarization-based, wavelength-based, etc.), a polarization control component (polarization splitter, polarization combiner, polarization rotator, etc.), an optical splitter component, an optical combiner component, a optical attenuator component (variable optical attenuator, fixed optical attenuator, etc.), an optical waveguide, a photodetector component, a microring optical resonator component, a mode filed diameter control component, an optical spot-size converter, among other optical control structure(s)/component(s).

Generally speaking, in the various embodiments disclosed herein, a light beam is incident upon a micro-lens and/or a mirror at an angle of incidence. This angle of incidence of the light beam is adjustable based on design specifications. In some embodiments, this angle of incidence of the light beam is non-perpendicular to the exterior surface 917A of the support material 917 for the PIC die/chip 903. In some embodiments, this angle of incidence of the light beam is perpendicular to the exterior surface 917A of the support material 917 for the PIC die/chip 903. It should be appreciated that the various photonic system embodiments disclosed herein mitigate or eliminate the need for cut-outs in the substrate and/or interposer of the PIC die/chip 903 packaging system, which provides for streamlining of the PIC die/chip 903 assembly and packaging processes.

Various example embodiments are disclosed herein in which the EIC die/chip 919 and the PIC die/chip 903 are depicted as separated components. However, it should be understood that the various embodiments disclosed herein can be equally implemented as alternative embodiments in which the circuitry of the EIC die/chip 919 is integrated onto the PIC die/chip 903 instead of having the EIC die/chip 919 as a separate component relative to the PIC die/chip 903. In some of these alternative embodiments, the space that the physically separate EIC die/chip 919 would have occupied is replaced by a dummy component. Additionally, in the various embodiments disclosed herein, the support material 917 for the PIC die/chip 903 can be directly connected to the PIC die/chip 903. Also, in the various embodiments disclosed herein, one or more portion(s) of the PIC die/chip 903 wafer remains as part of the PIC die/chip 903, and the electrically conductive C4 bumps are electrically connected to the front-end circuitry of the PIC die/chip 903 using TSV's, as needed.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. A photonic system, comprising:
a support material;
an optical coupling interface for an optical fiber disposed on a first surface of the support material; and
a photonic integrated circuit chip disposed on a second surface of the support material, wherein the second surface of the support material is opposite from the first surface of the support material relative to an overall thickness of the support material, the photonic integrated circuit chip including an oxide stack that extends vertically through the photonic integrated circuit chip to the second surface of the support material, wherein a portion of the oxide stack is configured as an optical reflector structure that includes a reflecting surface configured to direct a light beam conveyed from an optical waveguide within the photonic integrated circuit chip from a first direction of travel to a second direction of travel directed toward the second surface of the support material and toward the optical coupling interface for the optical fiber disposed on the first surface of the support material, such that the light beam travels from the optical waveguide within the photonic integrated circuit chip through the optical reflector structure and through the overall thickness of the support material to reach the optical coupling interface for the optical fiber.

2. The photonic system as recited in claim 1, wherein the reflecting surface is a boundary between the optical reflector structure and an open space.

3. The photonic system as recited in claim 1, wherein the reflecting surface is a mirror structure.

4. The photonic system as recited in claim 1, wherein an optical interface between the optical waveguide within the photonic integrated circuit chip and the optical reflector structure is configured to convey the light beam in the first direction that is substantially parallel to the second surface of the support material.

5. The photonic system as recited in claim 4, wherein the optical interface between the optical waveguide within the photonic integrated circuit chip and the optical reflector structure is configured to cause the light beam to diverge as it travels in the first direction from the photonic integrated circuit chip toward the angular surface of the optical reflector structure.

6. The photonic system as recited in claim 4, wherein a portion of the optical reflector structure extends under the photonic integrated circuit chip to increase a mode field diameter of the optical interface between the optical waveguide within the photonic integrated circuit chip and the optical reflector structure.

7. The photonic system as recited in claim 1, further comprising:
an antireflective coating disposed between the optical reflector structure and the support material to facilitate optical conveyance of the light beam into the support material from the optical reflector structure.

8. The photonic system as recited in claim 1, wherein the reflecting surface is an angular surface configured to reflect the light beam from the first direction into the second direction.

9. The photonic system as recited in claim 8, wherein the angular surface is a cleave of both the photonic integrated circuit chip and the support material.

10. The photonic system as recited in claim 1, wherein the reflecting surface is a curved surface configured to reflect the light beam from the first direction into the second direction.

11. The photonic system as recited in claim 1, wherein the curved surface is configured to collimate the light beam as the light beam is reflected from the first direction into the second direction.

12. The photonic system as recited in claim 1, further comprising:
a mold material disposed against a side of the optical reflector structure that is located opposite from the support material.

13. A photonic system, comprising:
a photonic integrated circuit chip including an optical waveguide that is optically connected to an optical port at a side of the photonic integrated circuit chip;
a support material, the photonic integrated circuit chip disposed on a first surface of the support material, the support material configured to wrap around a side of the photonic integrated circuit chip where the optical port is located, wherein a portion of the support material is configured as an optical reflector structure that includes a reflecting surface configured to direct a light beam conveyed from the optical port of the photonic integrated circuit chip from a first direction of travel to a second direction of travel through the support material toward a second surface of the support material; and
an optical coupling interface for an optical fiber disposed on the second surface of the support material, the optical coupling interface configured to receive the light beam traveling in the second direction through the support material.

14. The photonic system as recited in claim 13, wherein the reflecting surface is a boundary between the support material and an open space.

15. The photonic system as recited in claim 13, wherein the reflecting surface is a mirror structure.

16. The photonic system as recited in claim 13, wherein an optical interface between the optical waveguide within the photonic integrated circuit chip and the optical reflector structure is configured to convey the light beam in the first direction that is substantially parallel to the second surface of the support material.

17. The photonic system as recited in claim 13, further comprising:
an antireflective coating disposed between the optical reflector structure of the support material and the optical port of the photonic integrated circuit chip to facilitate optical conveyance of the light beam into the optical reflector structure of the support material from the optical port.

18. The photonic system as recited in claim 13, wherein the reflecting surface is an angular surface configured to reflect the light beam from the first direction into the second direction.

19. The photonic system as recited in claim 13, wherein the reflecting surface is a curved surface configured to reflect the light beam from the first direction into the second direction.

20. The photonic system as recited in claim 19, wherein the curved surface is configured to collimate the light beam as the light beam is reflected from the first direction into the second direction.
